(19) United States
(12) Patent Application Publication
(10) Pub. No.: US 2003/0146924 A1
(43) Pub. Date: Aug. 7, 2003

(54) Environmental impact data graphical user interface

(76) Inventors: Bjorn Svensson, Molnlycke (SE); Asa Kling, Molndal (SE)

Correspondence Address: BIRCH STEWART KOLASCH & BIRCH, PO BOX 747, FALLS CHURCH, VA, 22040-0747, US

(21) Appl. No.: 10/060,233

(22) Filed: Feb. 1, 2002

(51) Int. Cl. G09G 5/00

(52) U.S. Cl. 345/700; 345/764

(57) ABSTRACT

An environmental impact data graphical user interface for receiving production, use and disposal information regarding products and providing environmental impact information regarding same to manufacturers and consumers. The data graphical user interface employs a method of providing information pertaining to product or product group attributes including receiving a product or product group identifier, and transmitting information pertaining to one or more attributes of the product or product group in response to receiving, wherein one of the attributes relates to environmental impact. The invention also is a method of providing and receiving information pertaining to environmental aspects of a product or product group including transmitting a product or product group identifier from a user interface to a server, receiving the product or product group identifier with the server, and transmitting information pertaining to one or more attributes of the product or product group by the server to the user interface in response to receiving, wherein one of the attributes relates to environmental impact.

### CROSS REFERENCE TO RELATED APPLICATIONS

This application incorporates pending application Ser. No. 09/911,733 having Attorney Docket Number 3613-0102P (“0102P Application” hereinafter), filed on Jul. 25, 2001, and pending application Ser. No. 09/945,626 having Attorney Docket Number 3613-0104P (“0104P Application” hereinafter), filed on Sep. 5, 2001. Both of said applications are hereby incorporated by reference.

### BACKGROUND OF THE INVENTION

1. Field of the Invention

This invention relates to access of environmental data relating to product production and use, and more particularly, to access of environmental data product use via a user interface.

2. Related Art

Conventionally, product environmental impact data is compiled and disseminated with paper-based methods and processes. In particular, data relating to product environmental impact is tracked using sales, usage, consumption, type, etc. of a given type of product. The tracking of the data is compiled with a computer and database analysis software, on which product manufacturer generates reports for review by officers of the manufacturing company.

Significant shortcomings are associated with the methods and processes currently used to report product environmental impact. First, the conventional methods and processes for generating reports relating to product environmental impact create an immense volume of paper that adversely impacts the environment. Second, although many reports are generated for dissemination, cost constraints limit the total number of reports that may be generated. Accordingly, only a select number of individuals are able to review environmental impact information. Furthermore, environmental impact data relating to product use essentially is limited to the manufacturer; consumers are not notified of the environmental impact products have on the environment.

Accordingly, it would be advantageous to create a graphical user interface (GUI) that either a manufacturer or a consumer may access to review environmental impact information that relates to products manufactured or purchased.

### SUMMARY OF THE INVENTION

The invention is an environmental impact data graphical user interface for receiving production, use and disposal information regarding products and providing environmental impact information regarding same to manufacturers and consumers.

In accordance with the above-identified disadvantages of the conventional art, the present invention provides a manufacturer generated GUI which summarizes, in an easy and user friendly format, environmental impact information related to product manufacture, use and disposal.

The present invention provides a manufacturer generated GUI which summarizes environmental impact data related to incontinence products.

The present invention provides a GUI which includes accessible charts illustrating data relating to environmental impact of consumed incontinence products.

The present invention provides a GUI with which the user may select any of a plurality of products, and upon selection of a particular product, displays environmental data relating to the product.

To that end, the invention is a method of providing information pertaining to product or product group attributes including receiving a product or product group identifier, and transmitting information pertaining to one or more attributes of the product or product group in response to said receiving, wherein one of the attributes relates to environmental impact. The invention also is a method of providing and receiving information pertaining to environmental aspects of a product or product group including transmitting a product or product group identifier from a user interface to a server, receiving the product or product group identifier with the server, and transmitting information pertaining to one or more attributes of the product or product group by the server to the user interface in response to said receiving, wherein one of the attributes relates to environmental impact.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, wherein:

FIGS. 1-6 are display views of an environment product declaration of a business-to-consumer GUI;

FIGS. 7-10 are display views of an environment fact sheet of a GUI;

FIGS. 11-36 are display views of environment impact charts of a business-to-consumer GUI;

FIGS. 37-49 are display views of environment impact charts of a facility chart of a business-to-consumer GUI;

FIGS. 50-52 are display views of compiled charts of a facility chart of a business-to-consumer GUI;

FIGS. 53-56 are display views of waste charts of a facility chart of a business-to-consumer GUI;

FIGS. 57-59 are display views of transport charts of a facility chart of a business-to-consumer GUI;

FIGS. 60-76 are display views of environmental data accessible via public GUIs, including a web order site, a product catalogue site and a brand site;

FIG. 60 is a display view of a web order page of a business-to-consumer GUI;

FIG. 61 is a display view of an article data sheet accessible via the page of FIG. 60;

FIG. 62 is a display view of a fact sheet accessible via the page of FIG. 61;

FIG. 63 is a display view of a product declaration accessible via the page of FIG. 60;

FIG. 64 is a display view of an environmental impact chart accessible via the page of FIG. 60;

FIG. 65 is a display view of a fact sheet accessible via the page of FIG. 60;

FIG. 66 is a display view of a brand site accessible via a public GUI;

FIGS. 67-68 are display views of an environmental product declaration accessible via the page of FIG. 66;

FIGS. 69-70 are display views of environmental impact charts accessible via the page of FIG. 66;

FIGS. 71-72 are display views of environmental fact sheets accessible via the page of FIG. 66;

FIG. 73 is a display view of a product catalogue accessible via a public GUI or a products tab of the page of FIG. 66;

FIG. 74 is a display view of a fact sheet accessible via the product catalogue of FIG. 73;

FIG. 75 is a display view of an environmental product declaration accessible via a product catalogue page of a public GUI;

FIG. 76 is a display view of environmental impact charts accessible via the product catalogue of FIG. 73; and

FIGS. 77-83 are display views of simulation charts accessible via a simulation sub-subtab of a facility chart subtab of an environment tab of FIGS. 37-59.

### DETAILED DESCRIPTION OF PREFERRED EMBODIMENTS

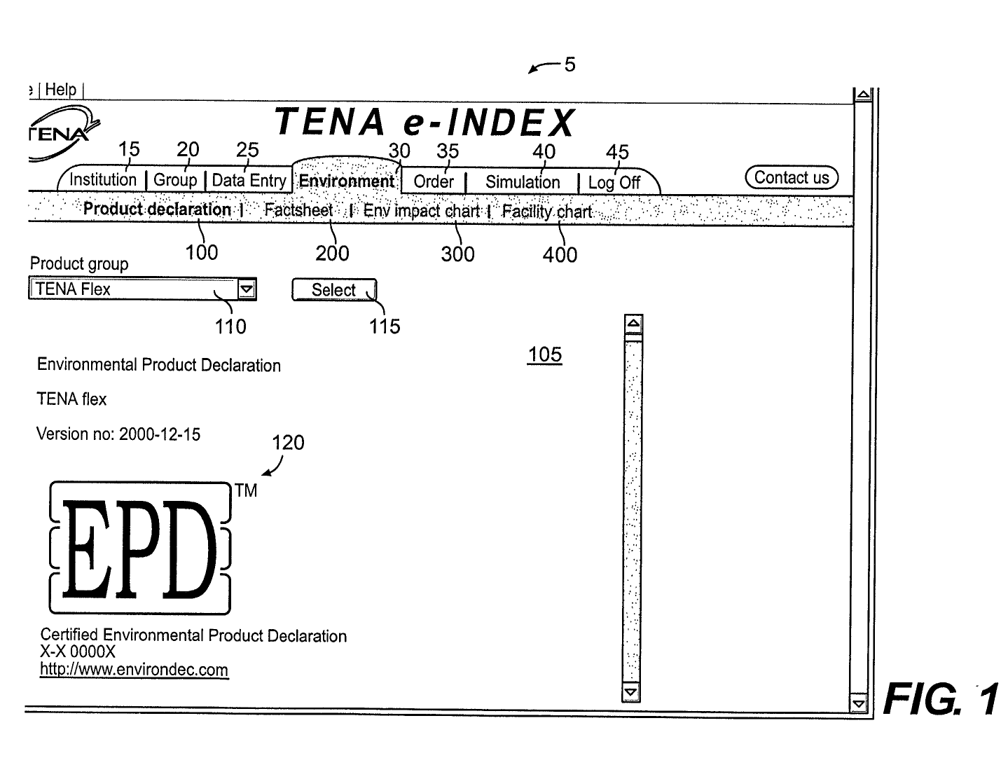

The invention is an environmental impact data graphical user interface (GUI) for receiving production, use and disposal information regarding products and providing environmental impact information regarding same to manufacturers and consumers. Referring to FIG. 1, the GUI, preferably, is in the form of a Web page 5 that presents a plurality of tabs 10 that correspond to various functions, such as data entry and ordering. Each tab 10 includes a plurality of subtabs corresponding to various data views or worksheets.

As shown in FIG. 1, tabs 10 include institution tab 15, group tab 20, data entry tab 25, environment tab 30, order tab 35, simulation tab 40 and log-off tab 45. Institution tab 15, group tab 20 and log-off tab 45 features are described in the 0102P Application, thus are discussed no further herein. Similarly, data entry tab 25, order function tab 35 and simulation tab 40 features are described in the 0104P Application, thus are discussed no further herein. Discussion below focuses on environment tab 30 features.

Environmental tab 30 has four subtabs: product declaration subtab 100, fact sheet subtab 200, environmental impact chart subtab 300, and facility chart subtab 400. Product declaration subtab 100 provides environmental impact information with respect to a product group. Fact sheet 200 provides environmental impact information with respect to a product of a product group. Environmental impact chart 300 provides charts pertinent to a product group. Facility chart subtab 400 provides charts pertaining to institutional product consumption.

As shown on FIG. 1, view 105 of product declaration subtab 100 provides a certificate of authenticity on which users may rely, typically supplied by a web host, to assure users that the data and company statement regarding same are trustworthy.

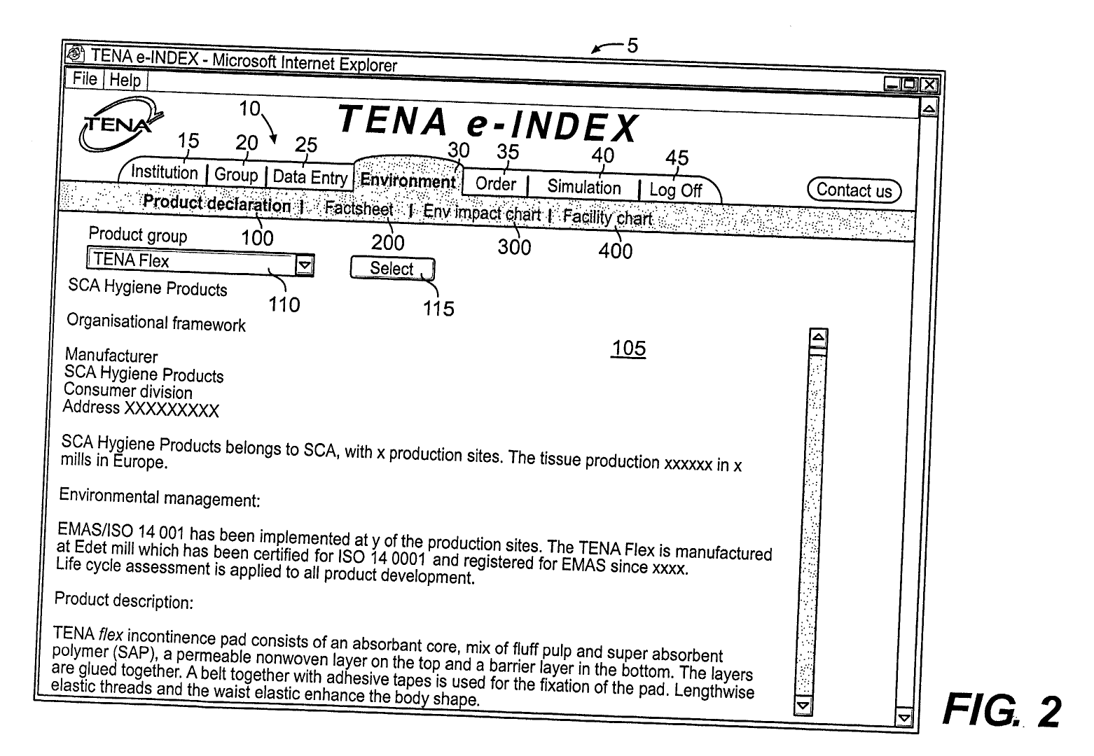

Referring to FIG. 2, product declaration subtab 100 also provides a product group drop box 110 with which a user may select a product group, as is well known in world wide web software design. Once the user enters a product group, the user “clicks on” or selects the select button 115 to transmit the identification of the user's selected product group to a server (not shown) which hosts the website for processing and return of information related to the selected product group.

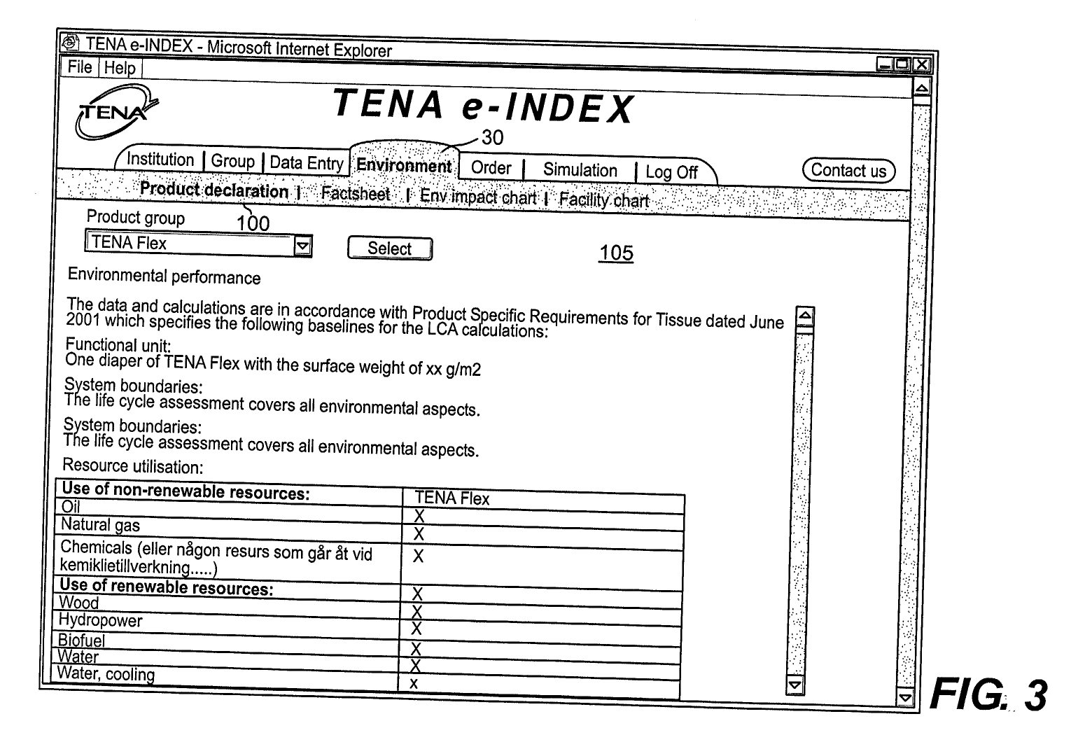

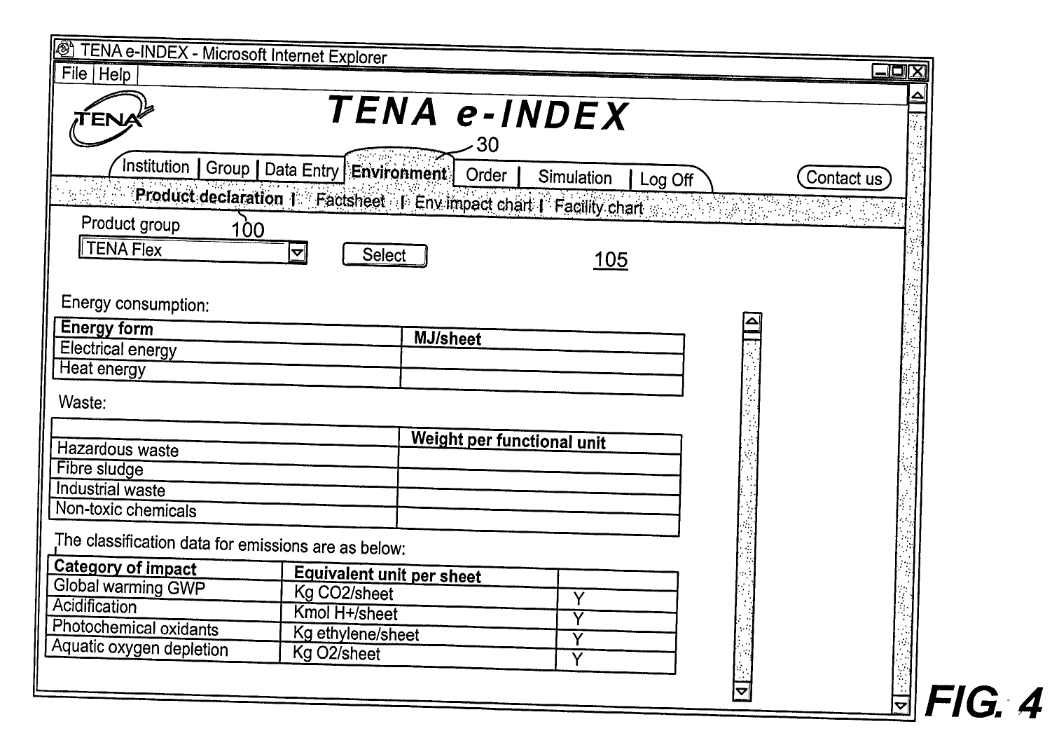

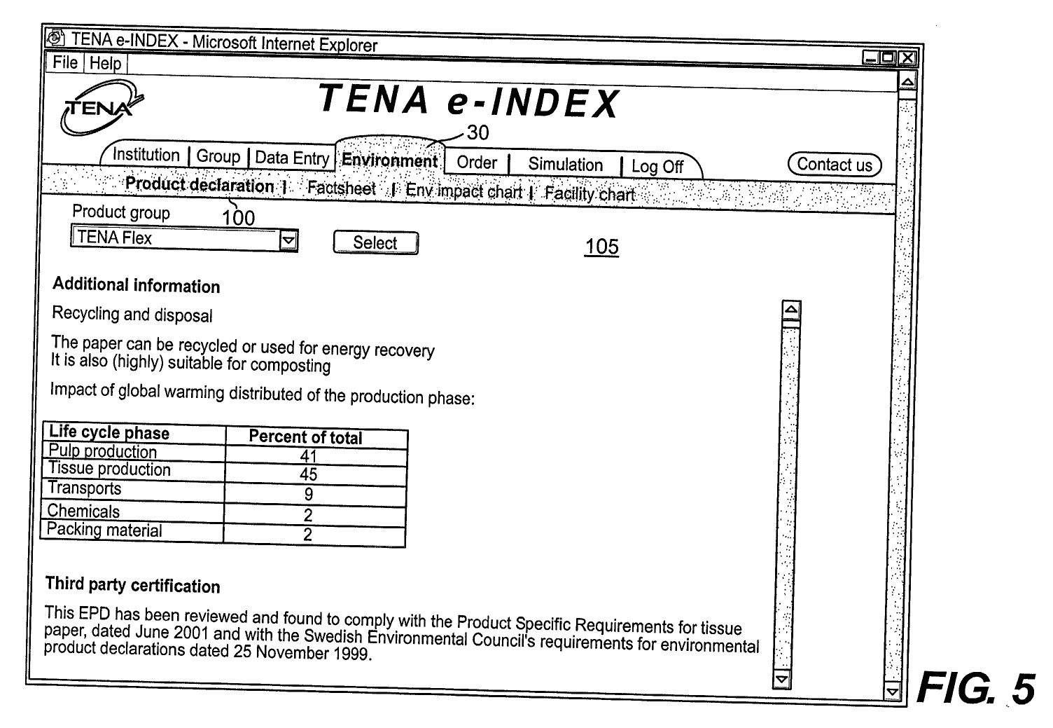

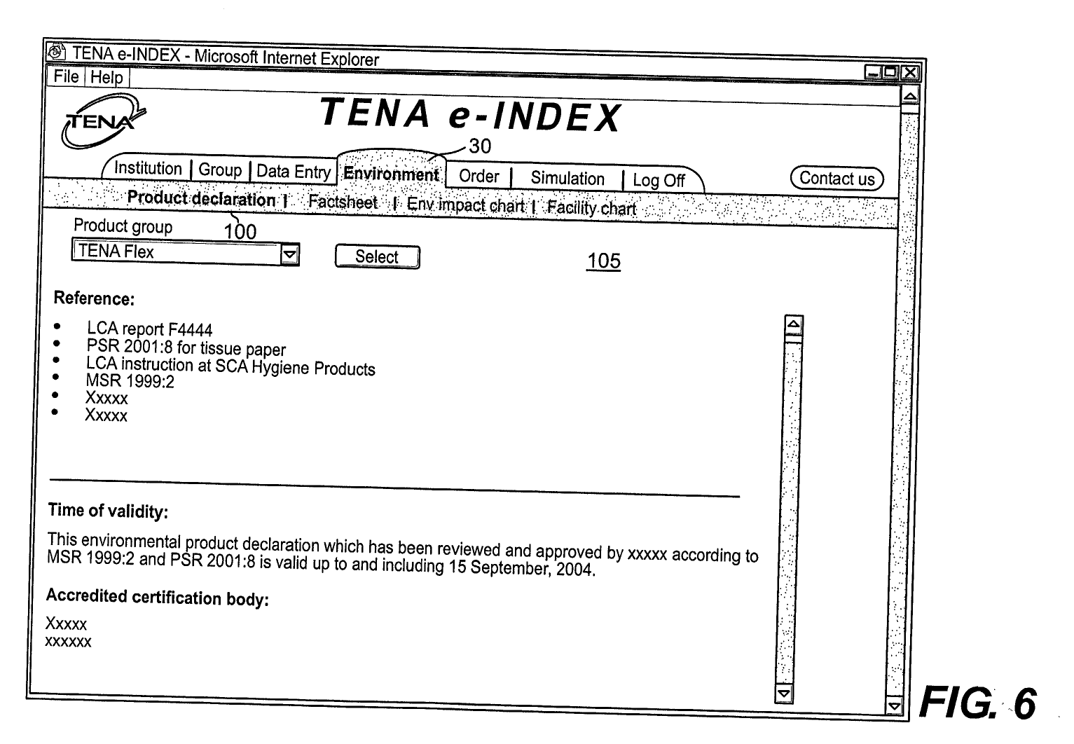

As shown, an incontinence product group “TENA Flex” is selected in drop down menu 110. The information returned by the server may address, for example: organizational framework, as shown on FIG. 2; environmental performance, as shown on FIG. 3; energy consumption, waste and classification data for emissions, as shown on FIG. 4; additional information and certification, as shown on FIG. 5; or reference materials and a validity timestamp, as shown on FIG. 6.

Returning to FIG. 2, with respect to organizational framework, product declaration subtab 100 shows the legal name and correspondence address for the manufacture of the selected product group. Product declaration subtab 100 also displays pertinent ownership interest and production sites with respect to components of the selected product group. Further, product declaration subtab 100 displays environmental standards to which the manufacturer adheres. Finally, product declaration subtab 100 describes product group components.

Referring again to FIG. 3, product declaration subtab 100 describes the environmental performance of a product group in terms of renewable and non-renewable resources spent with respect to functional units of a product group. For example, some non-renewable resources may include: oil, natural gas and chemicals used; some renewable resources may include: wood, hydropower, biofuel and water etc.

As shown in FIG. 4, the energy consumption, waste and classification data for emissions attributed to the renewable and non-renewable energy resources also are tallied. Energy consumed may be measured in terms of, for example, electrical energy or heat energy. Waste may be categorized in terms of hazardous waste, fiber sludge, industrial waste and non-toxic chemicals. Emissions may be classified in terms of global warming, acidification, photochemical oxidants and aquatic depletion.

Referring again to FIG. 5, the additional information section of product declaration subtab 100 may provide information not captured by or evident from the renewable/non-renewable resource data, such as the efficacy of recycling and disposal or the impact of same on global warming, for example.

Referring again to FIG. 6 reference materials displayed may include reports, laws and regulations or instructions relevant to various components used in a product group, and in particular, environmental aspects thereof.

Product declaration subtab 100 also provides users with information regarding the currency and trustworthiness of information displayed in the form of a ratified statement by an authorized person which sets forth a date through which the data is reliable.

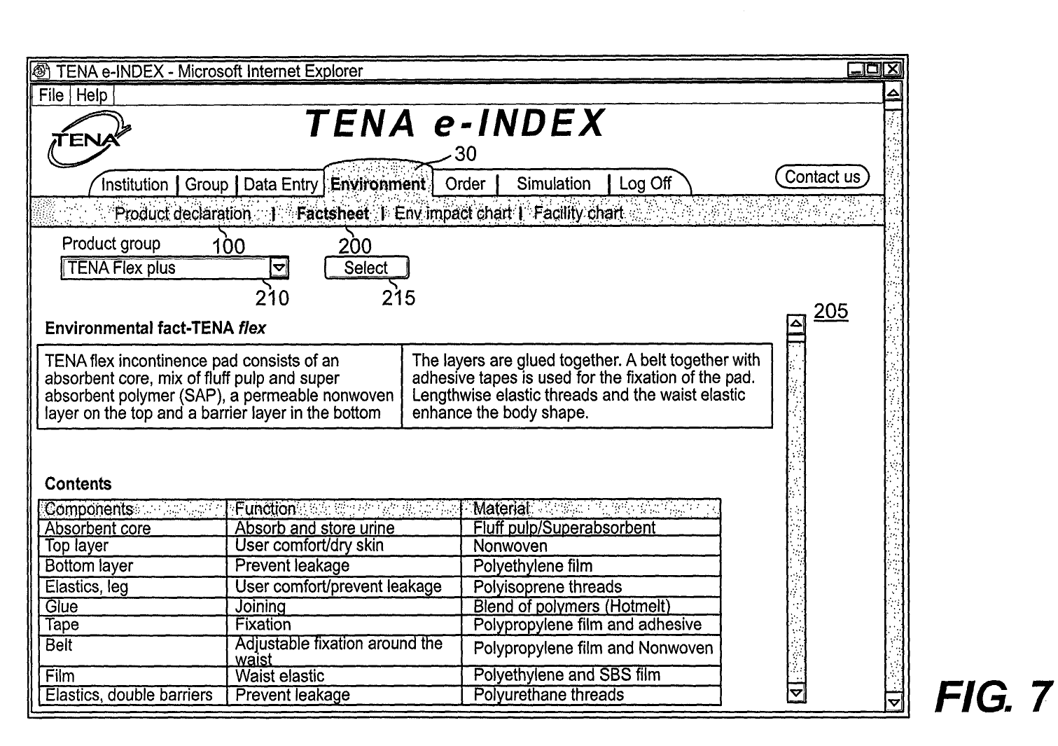

Referring to FIGS. 7-10, similar to product declaration subtab 100, fact sheet subtab 200 provides a view or worksheet 205 that includes a product drop down menu 210. Product drop down menu 210 allows users to select from several products of the product group selected in drop down menu 110 of product declaration subtab 100 shown in FIG. 1. Upon selection of a product from drop down menu 210, the user actuates a select button 215 to prompt the server to display factual information related to the product selected in drop down menu 210.

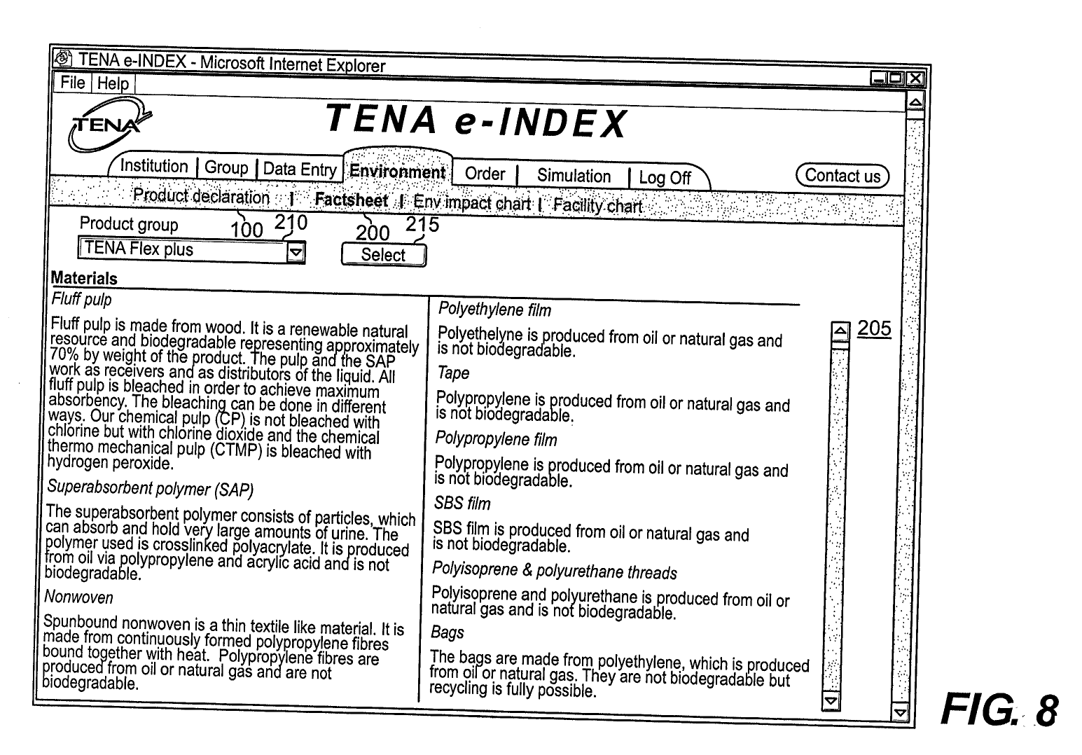

As shown in FIGS. 7-8, fact sheet subtab 200 displays information with respect to a selected product, such as the contents of the product, broken down in terms of components, function and material. Fact sheet subtab 200 also describes each of the materials of each component of the selected product with special attention to features of the material that impact the environment. For example, a material description may make reference to whether the material is produced with oil or natural gas or biodegradable.

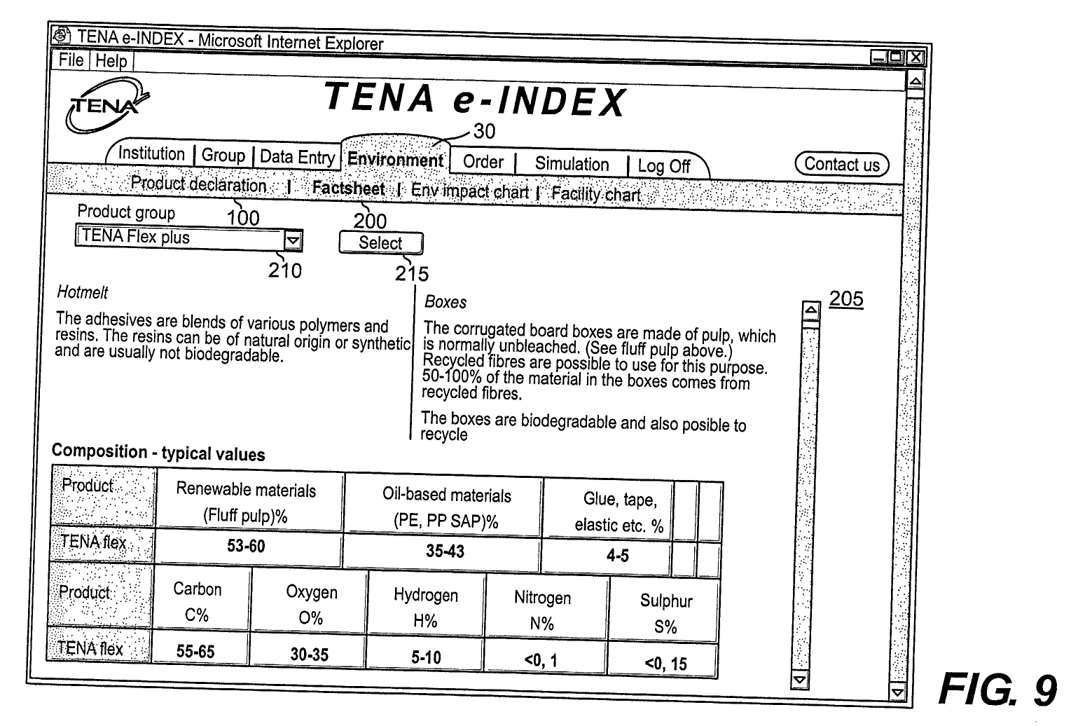

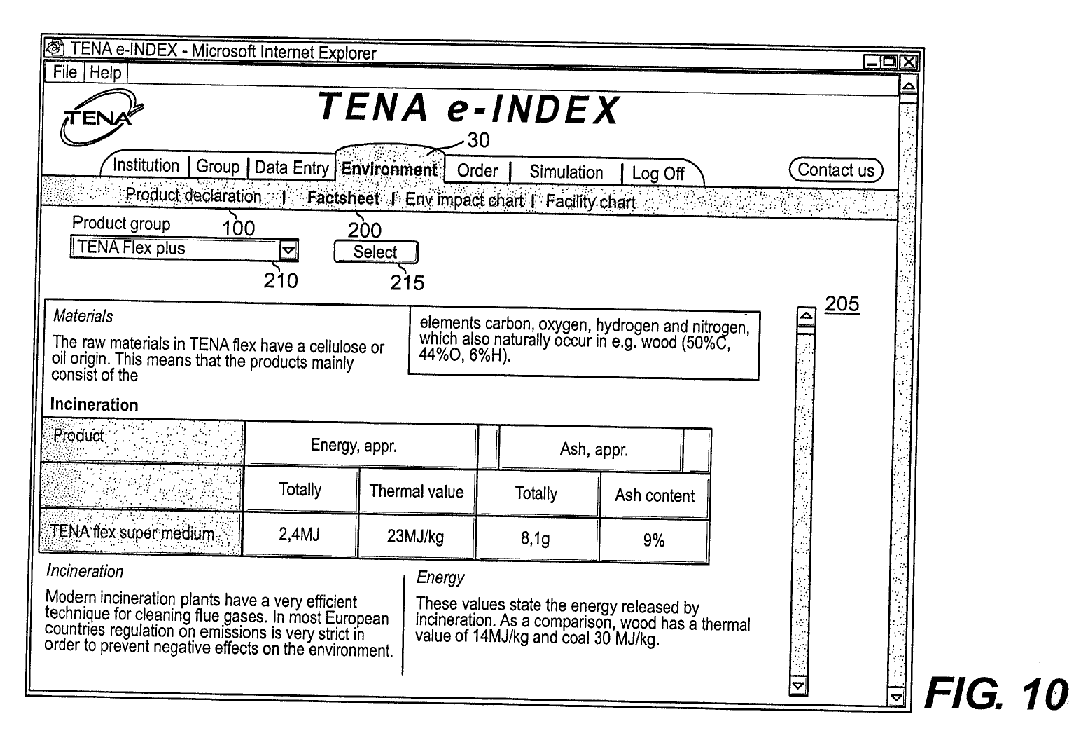

As shown in FIG. 9, fact sheet subtab 200 displays the composition of the product in terms of renewable or non-renewable materials, and in terms of major constituent chemical elements. As shown in FIG. 10, fact sheet subtab 200 displays the total energy required and thermal value thereof, for incineration of a product, and the approximate ash amount and content which would be resultant therefrom.

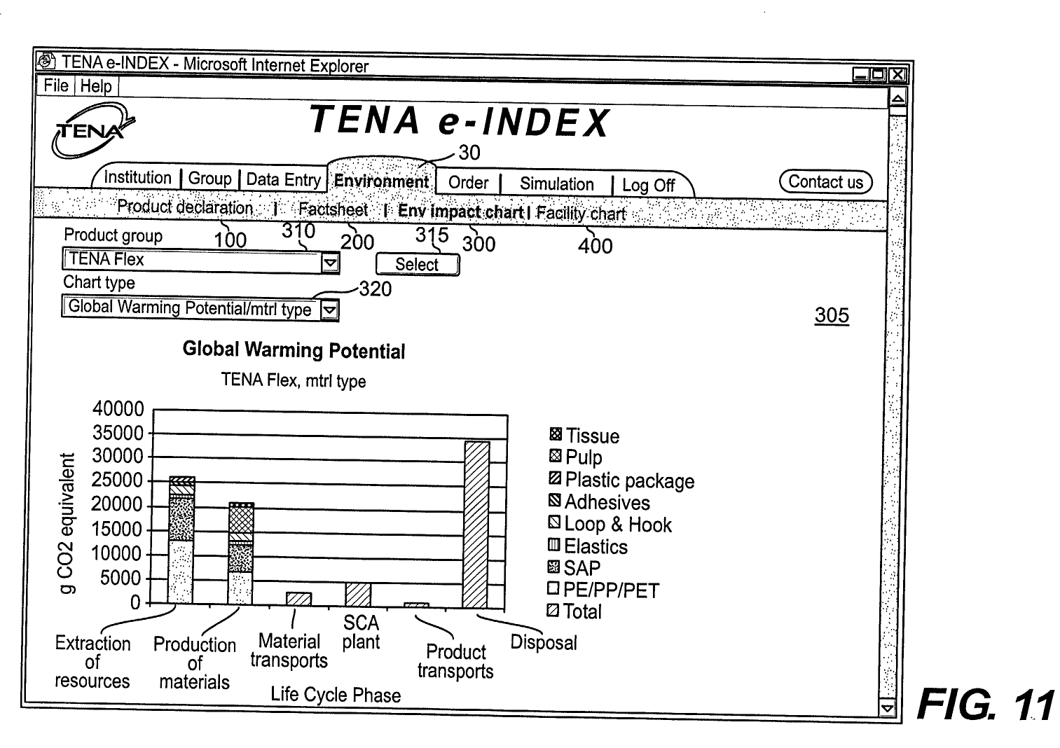

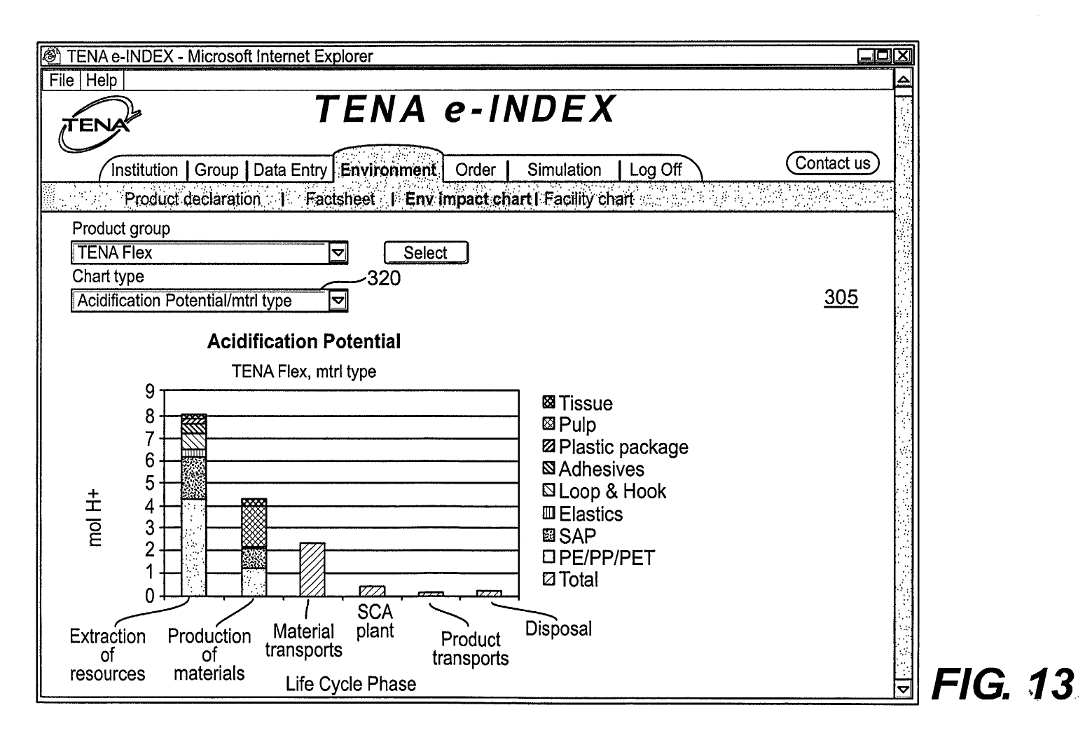

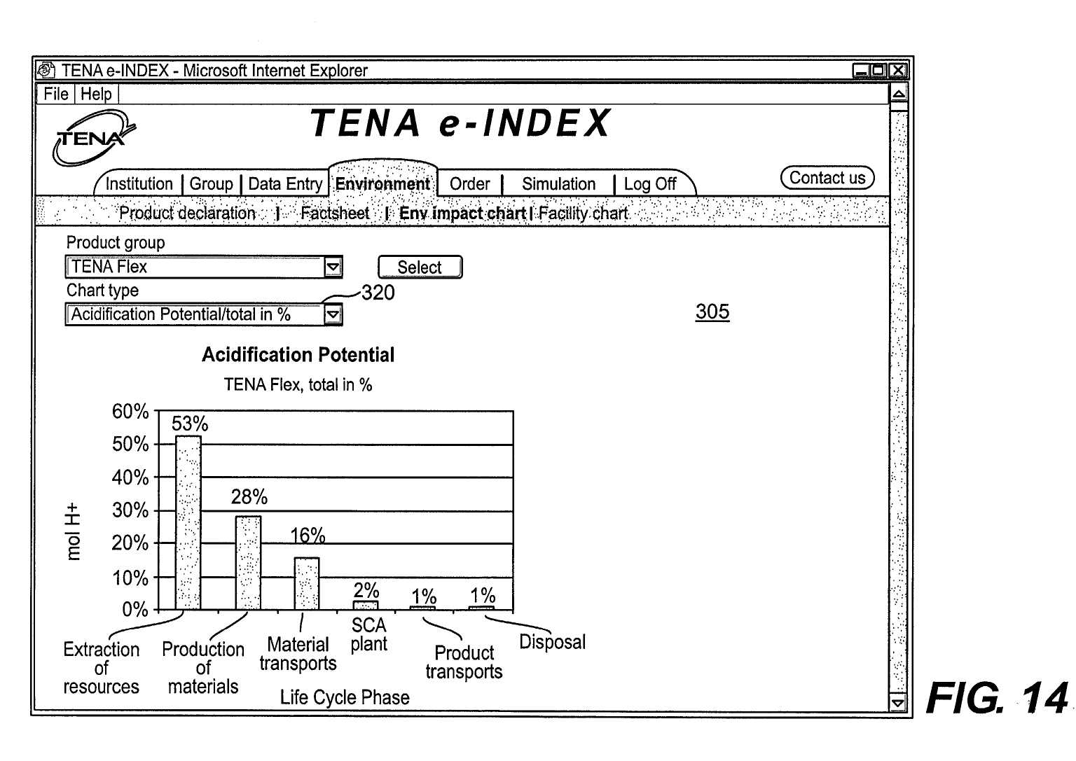

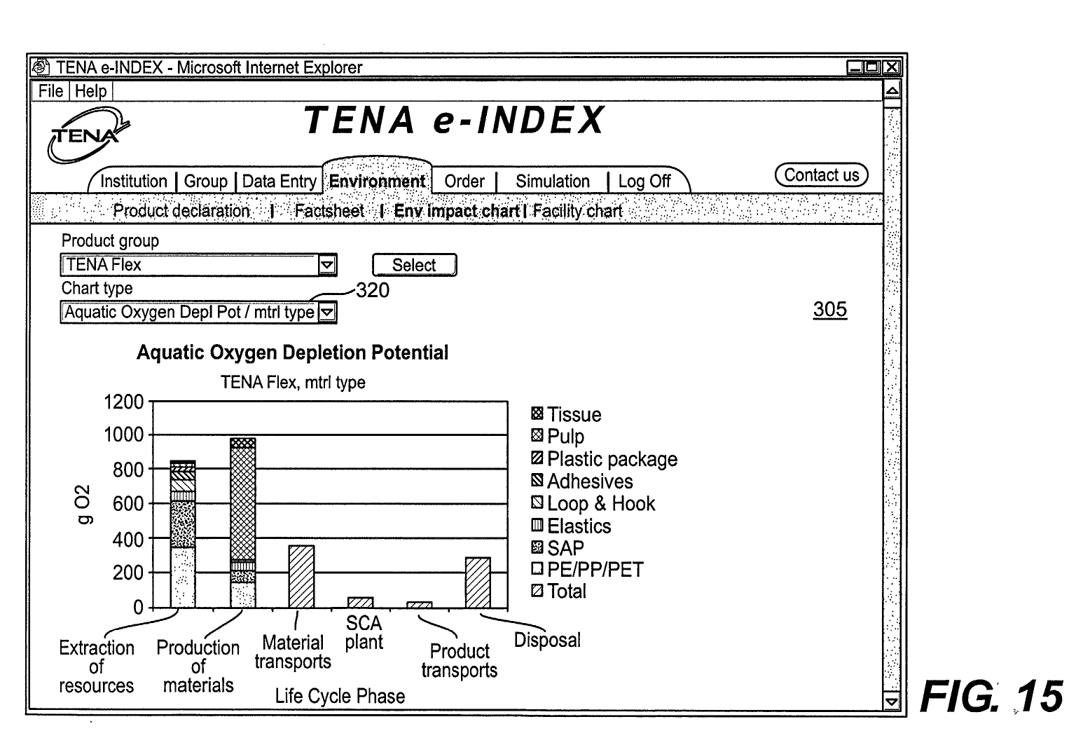

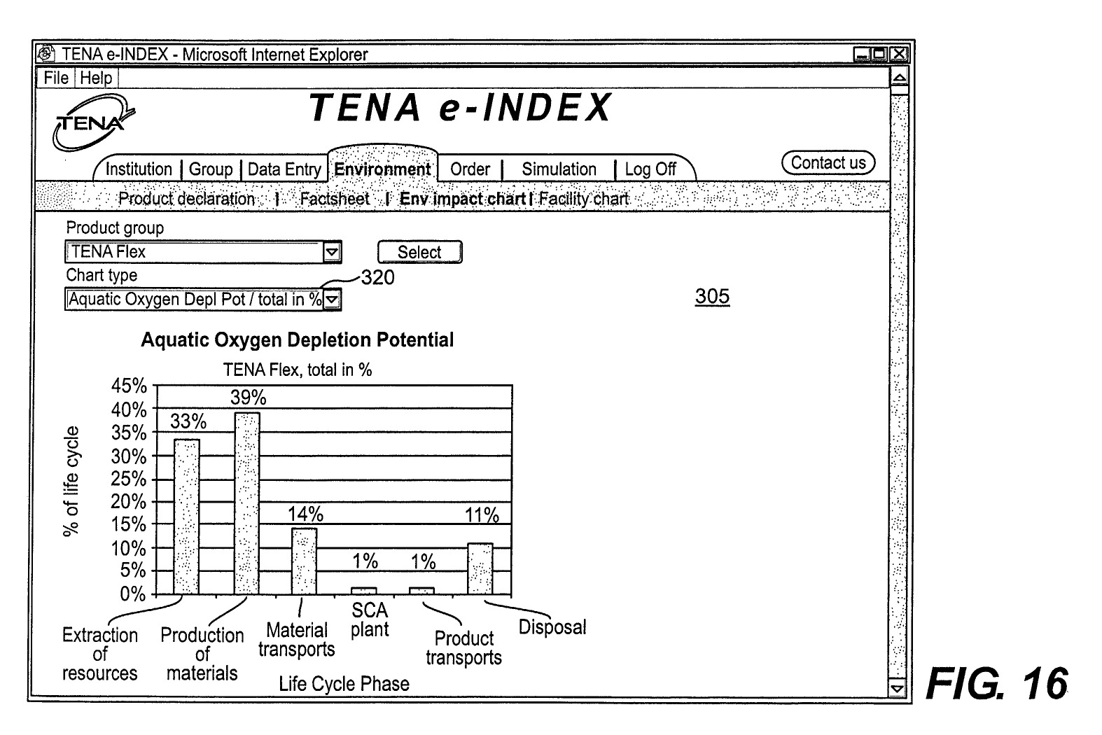

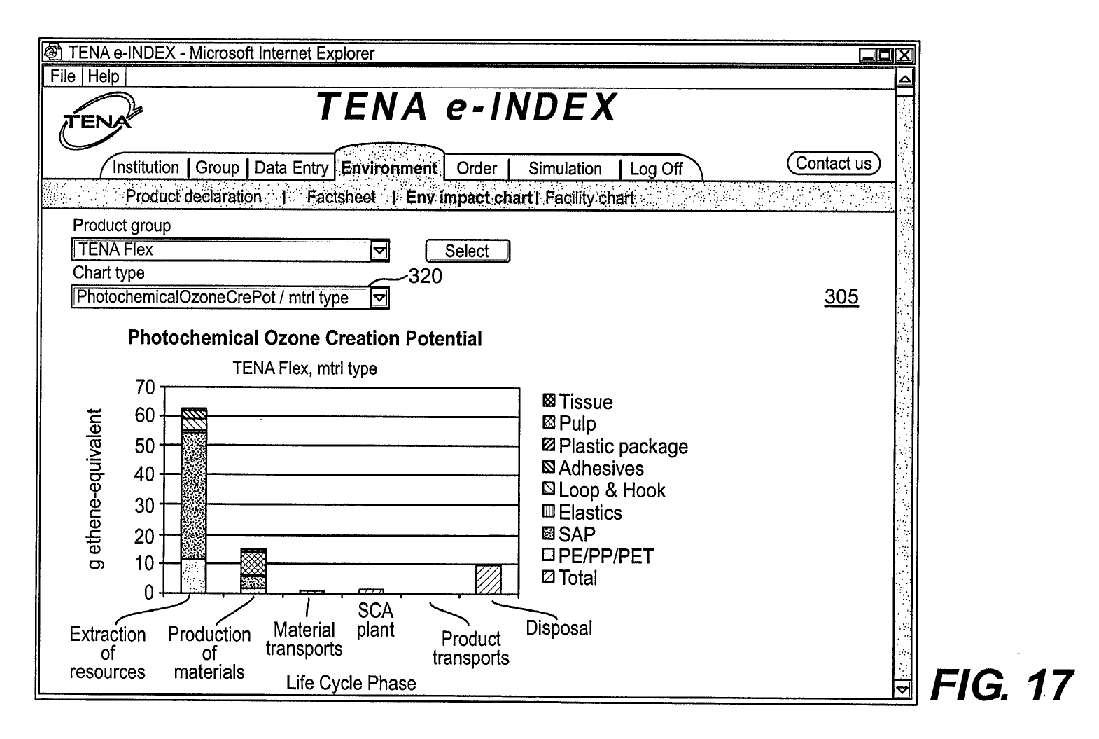

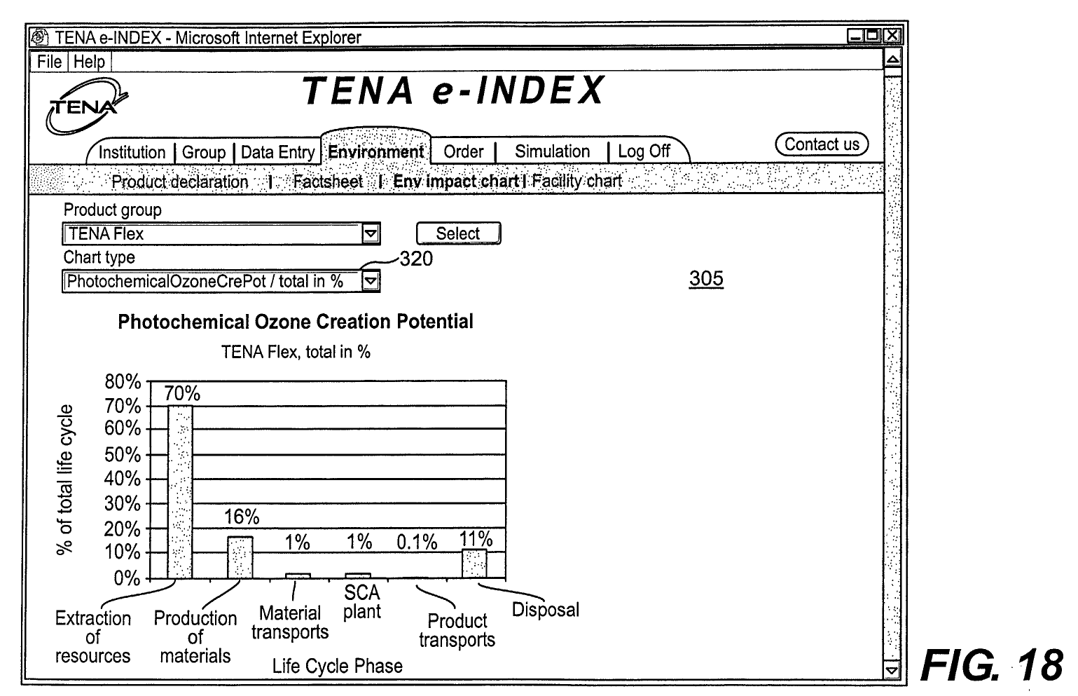

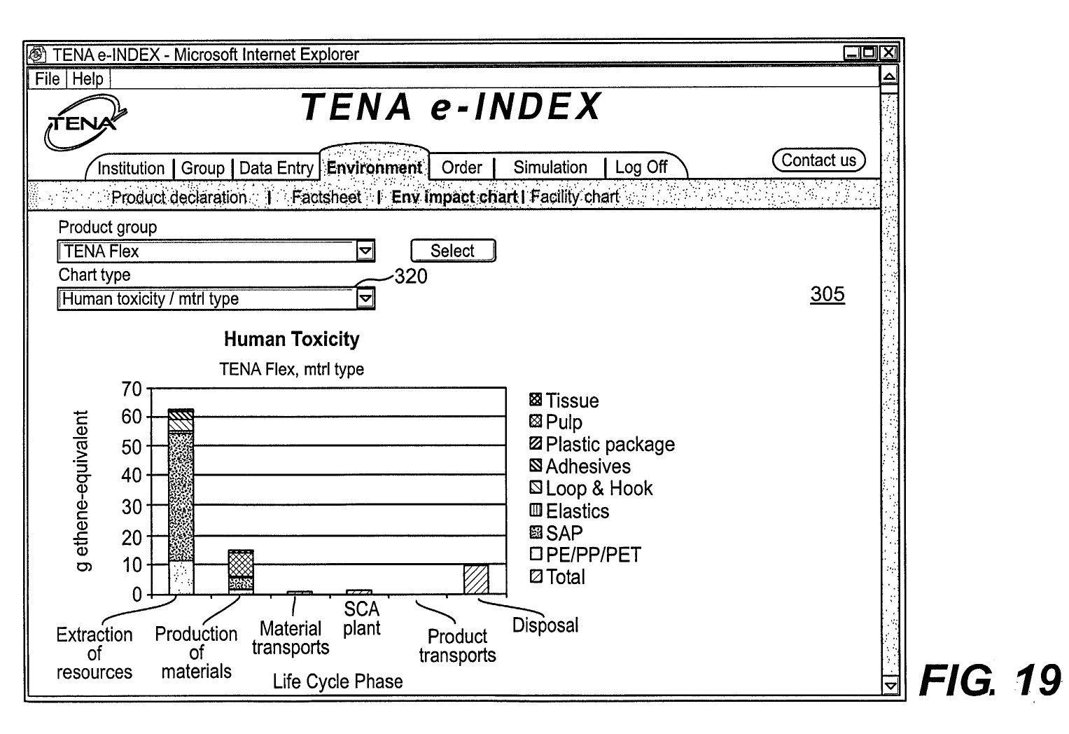

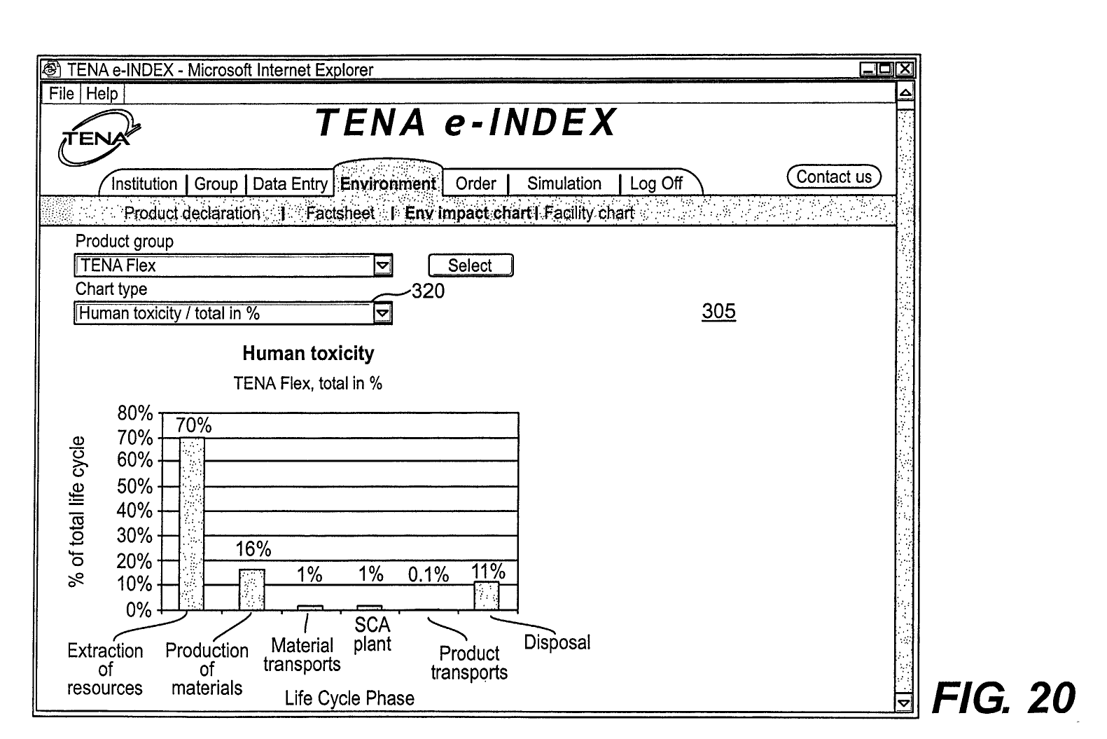

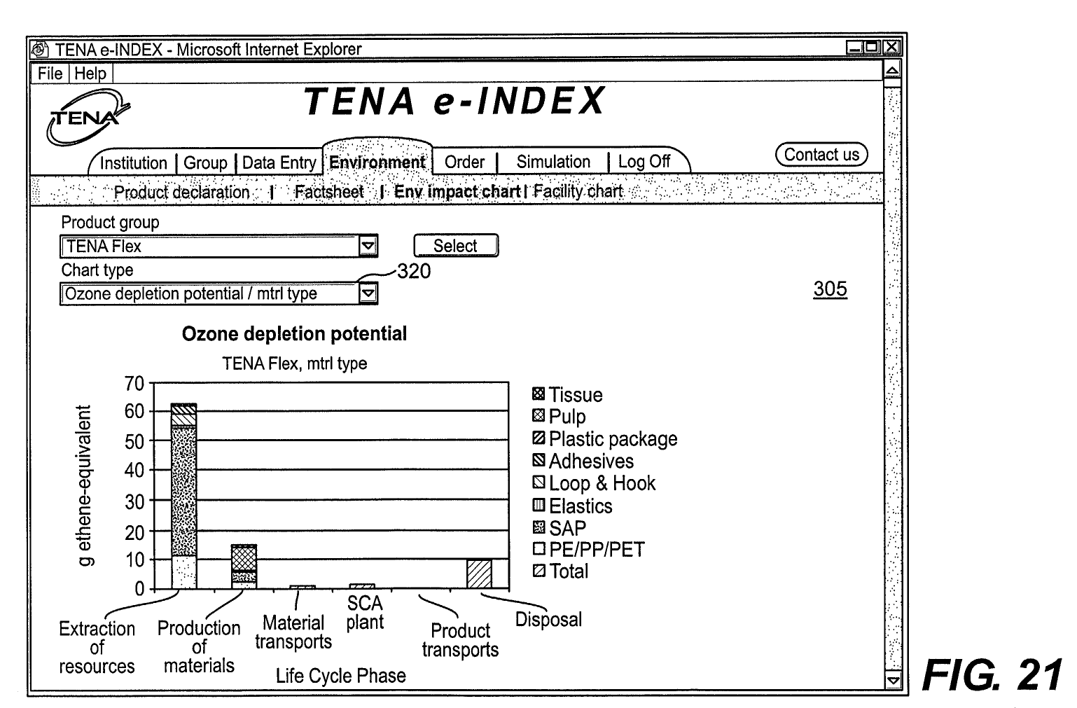

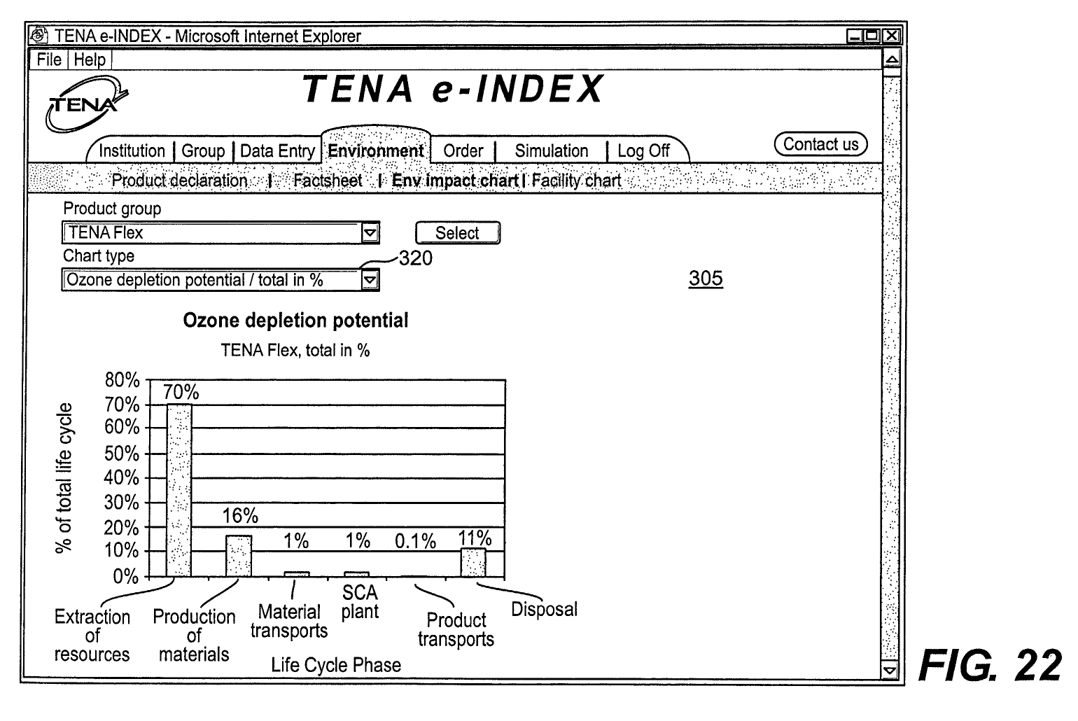

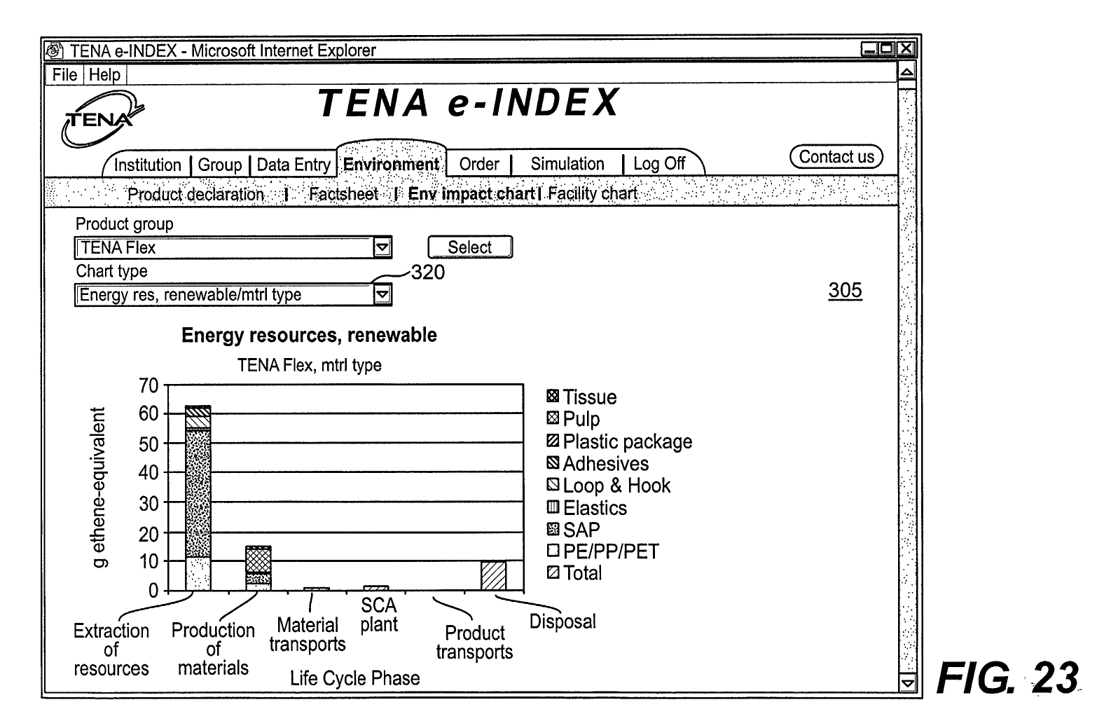

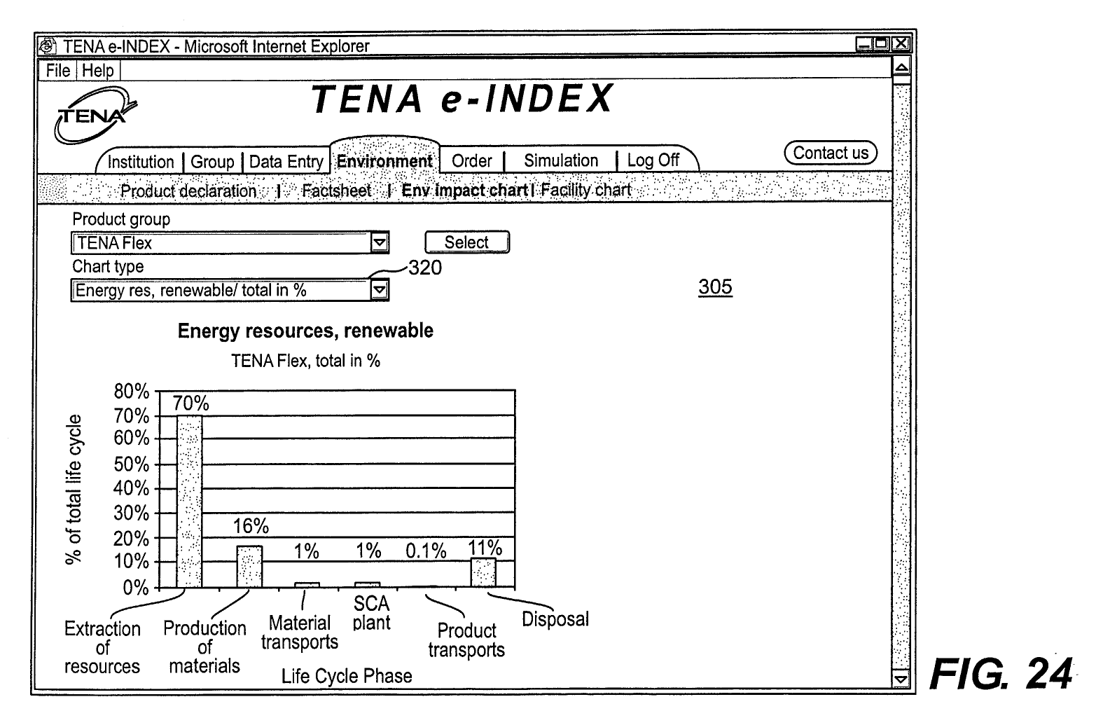

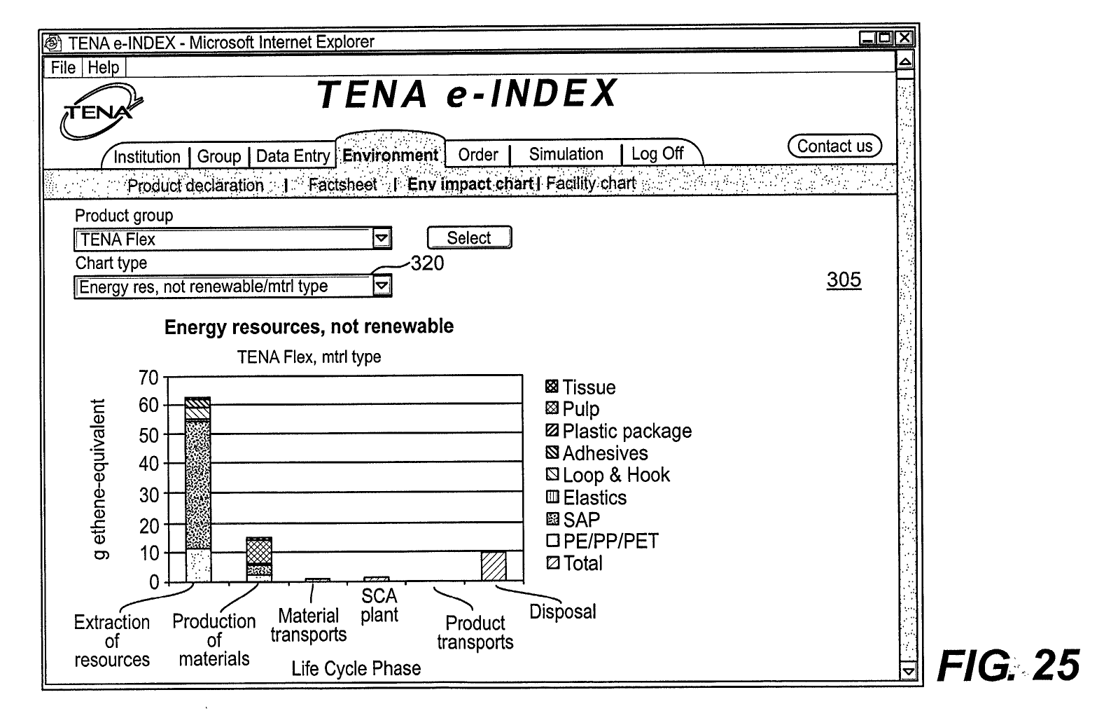

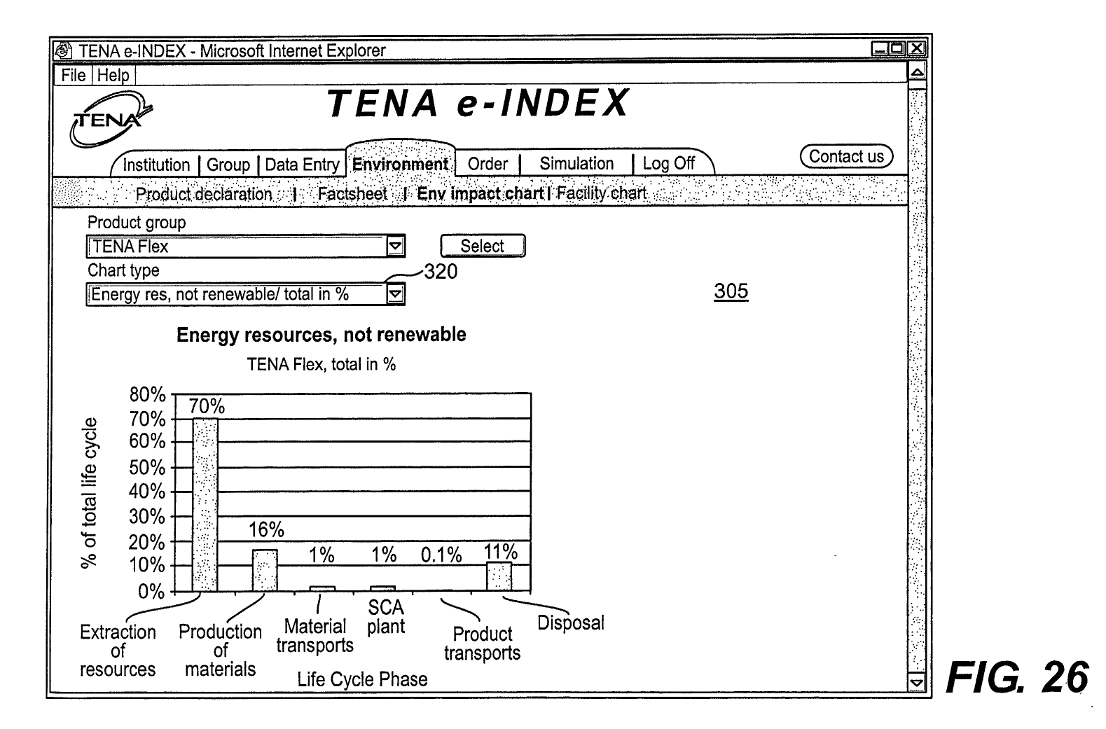

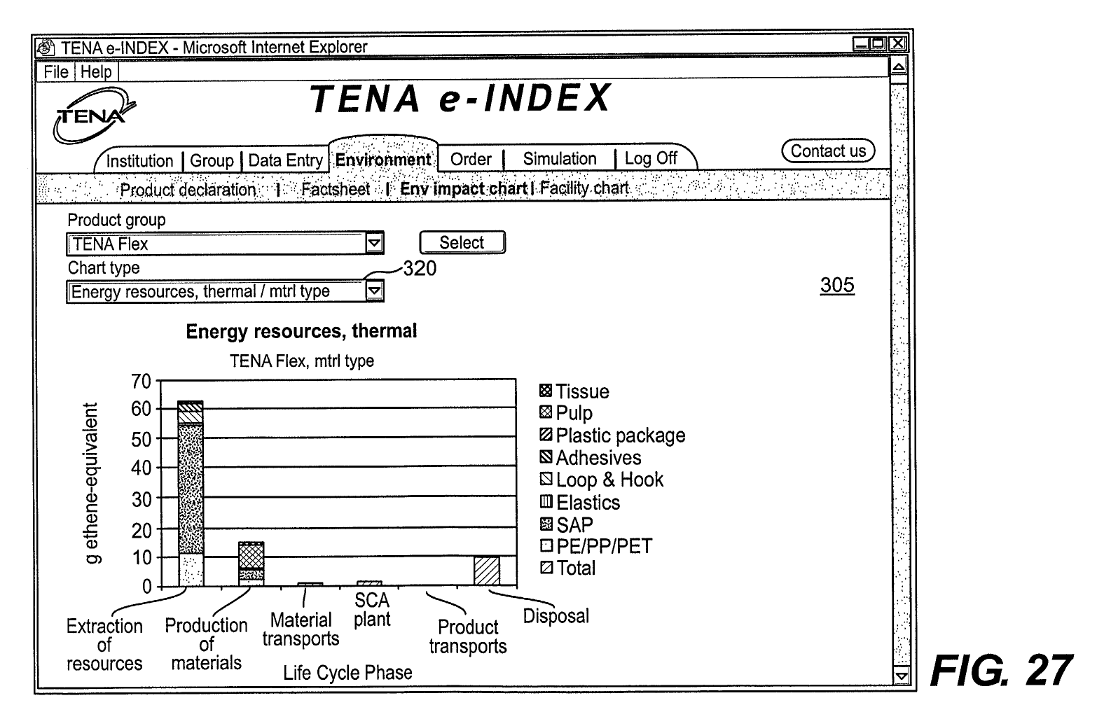

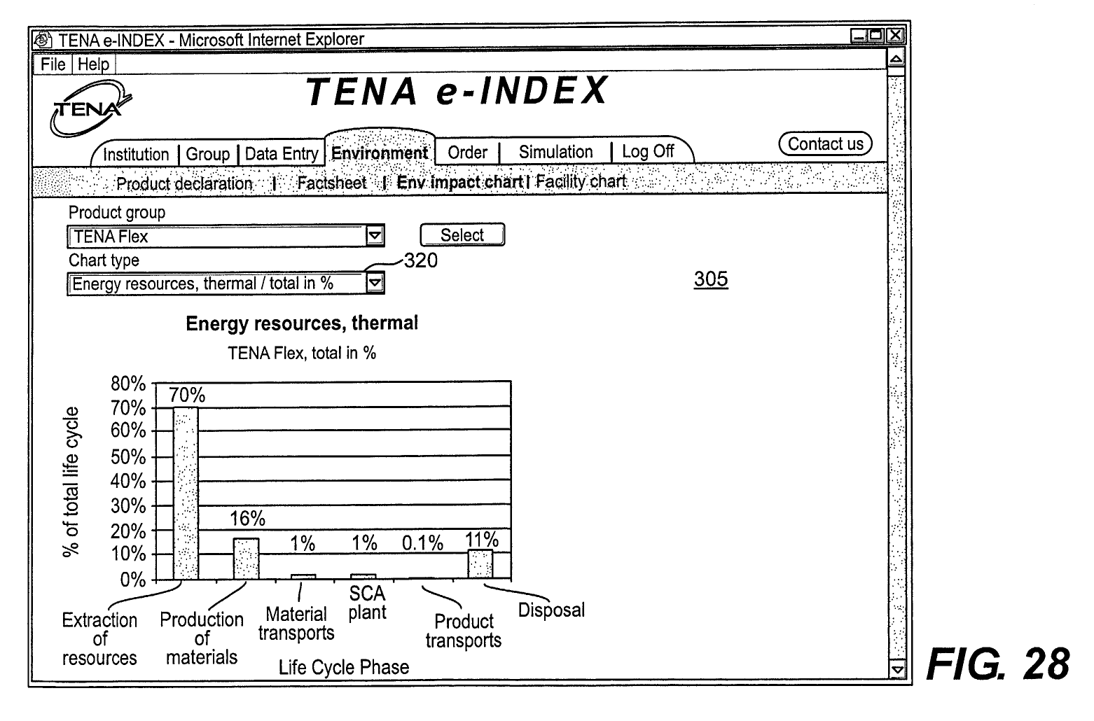

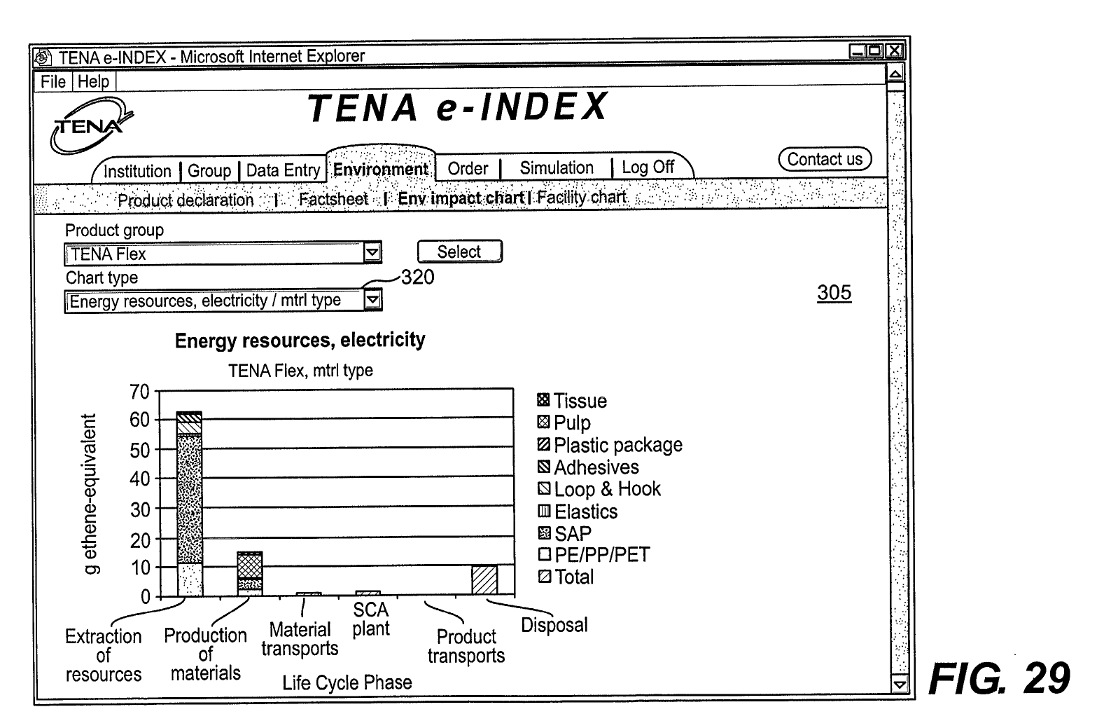

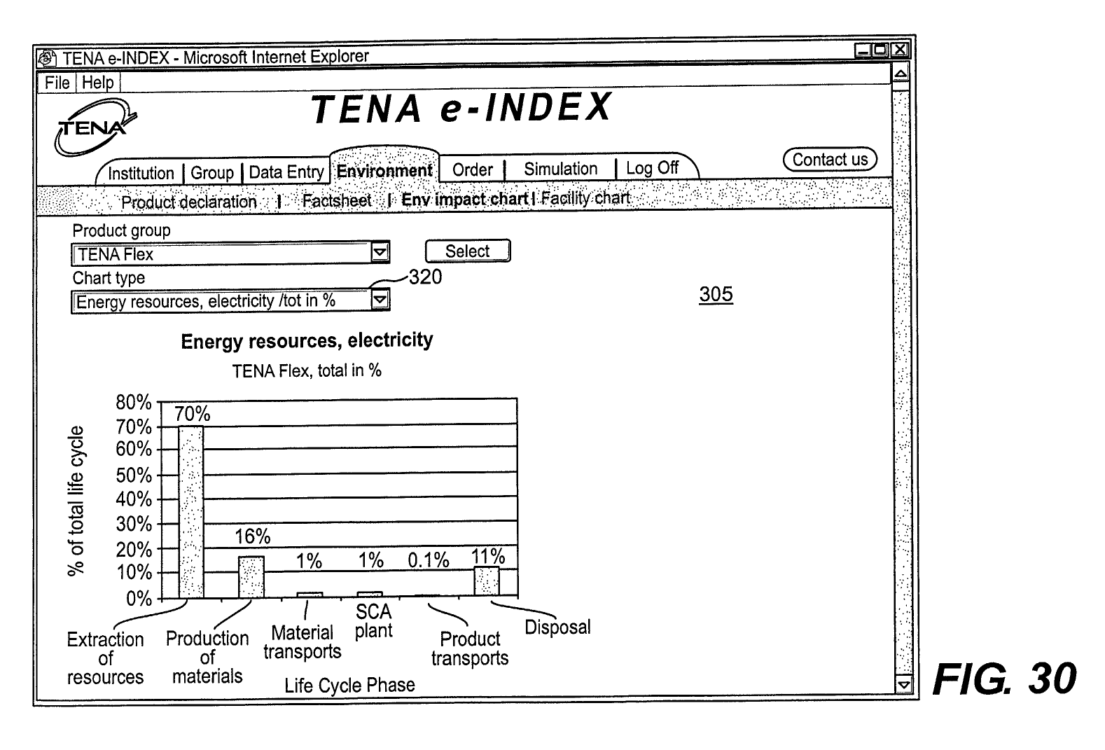

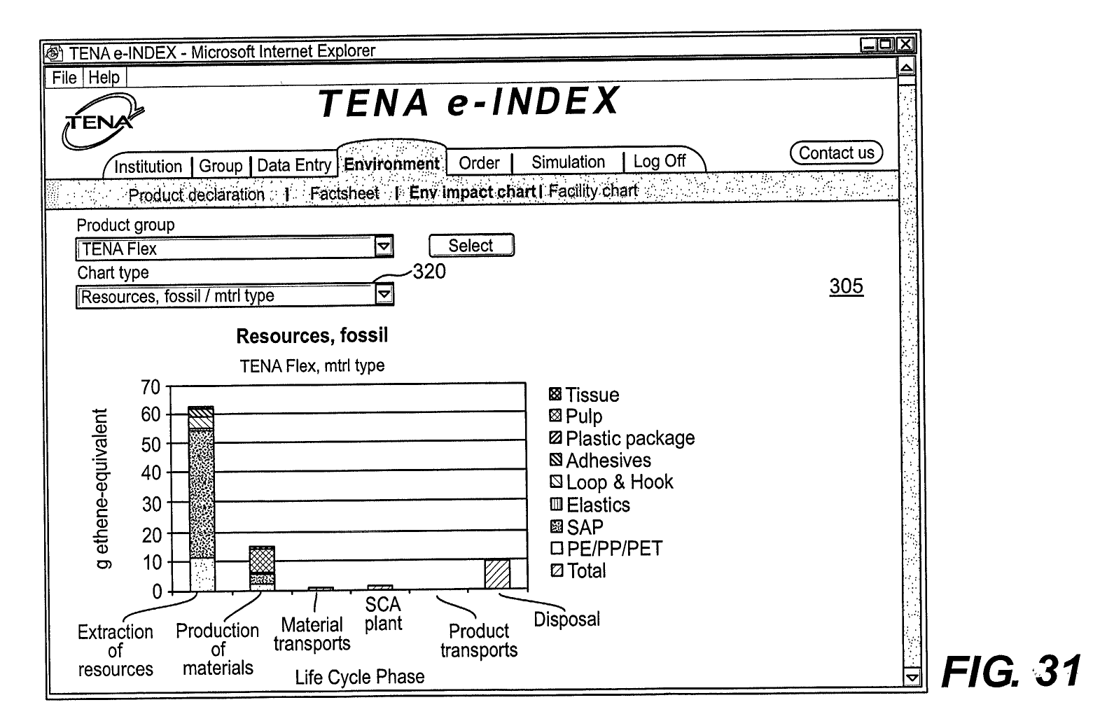

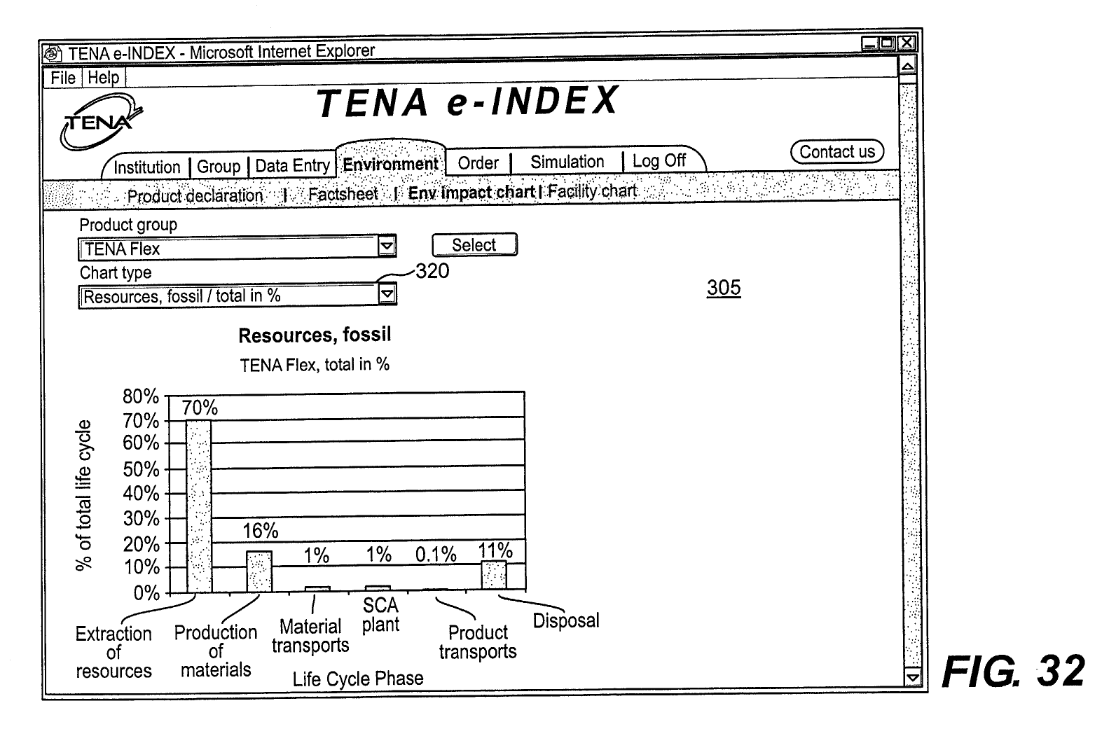

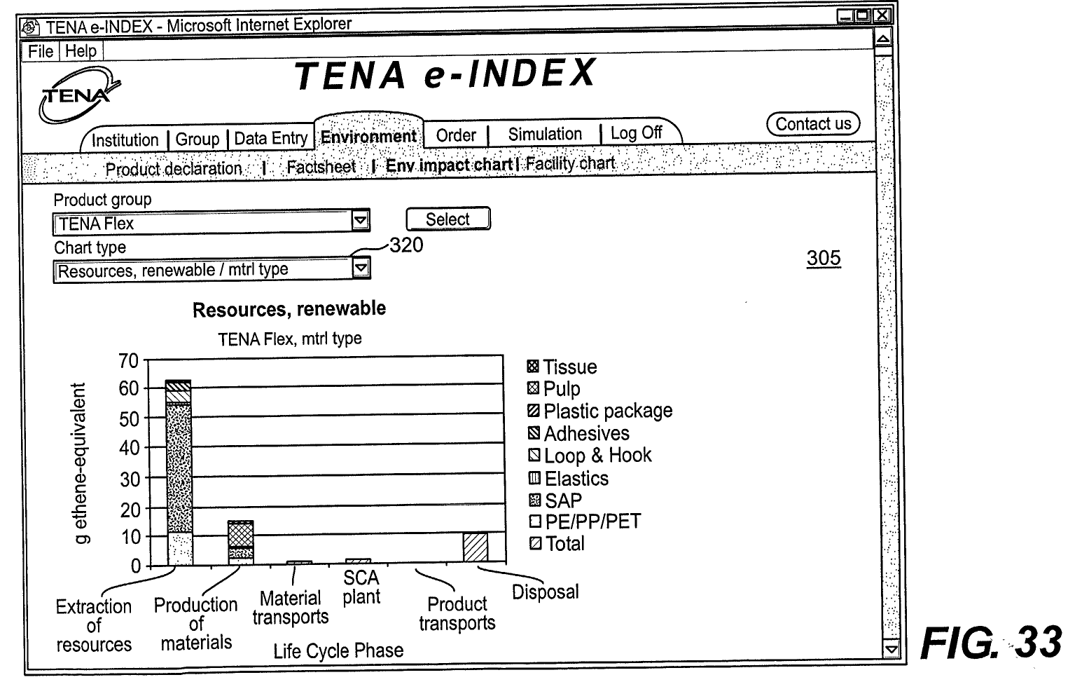

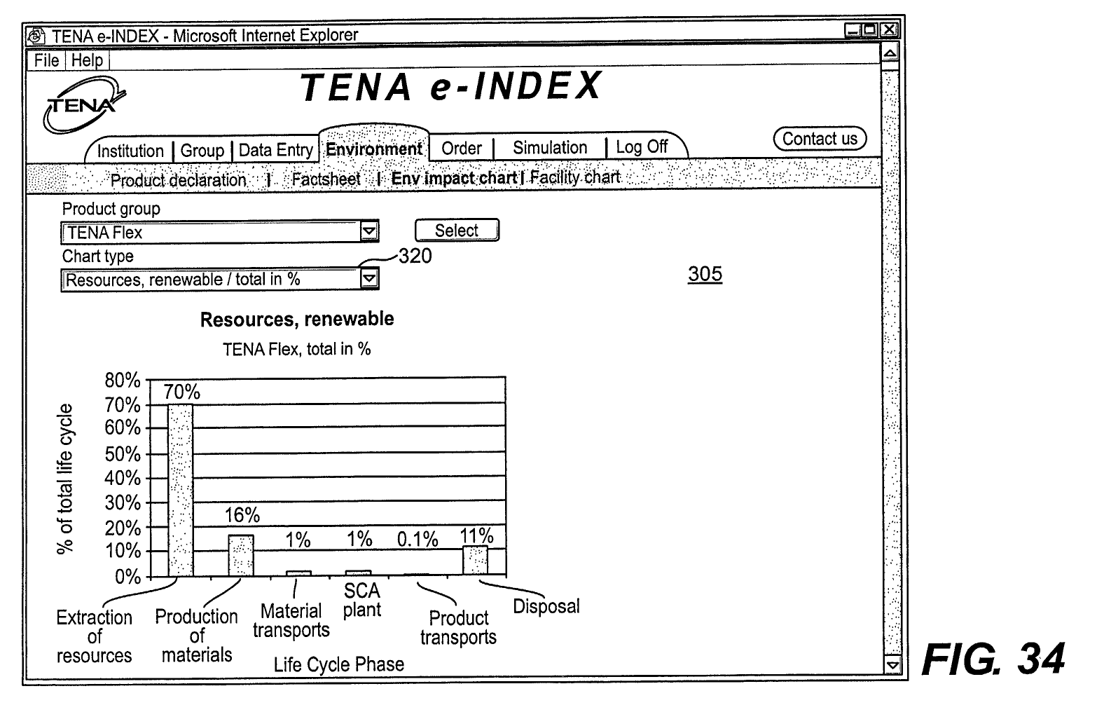

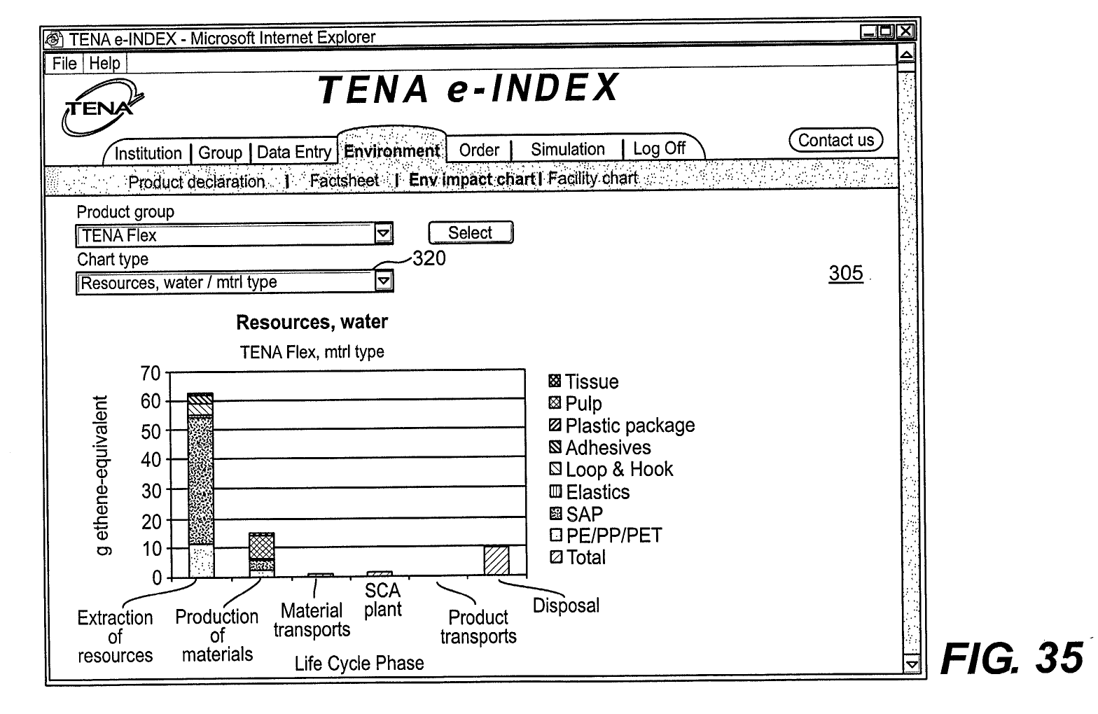

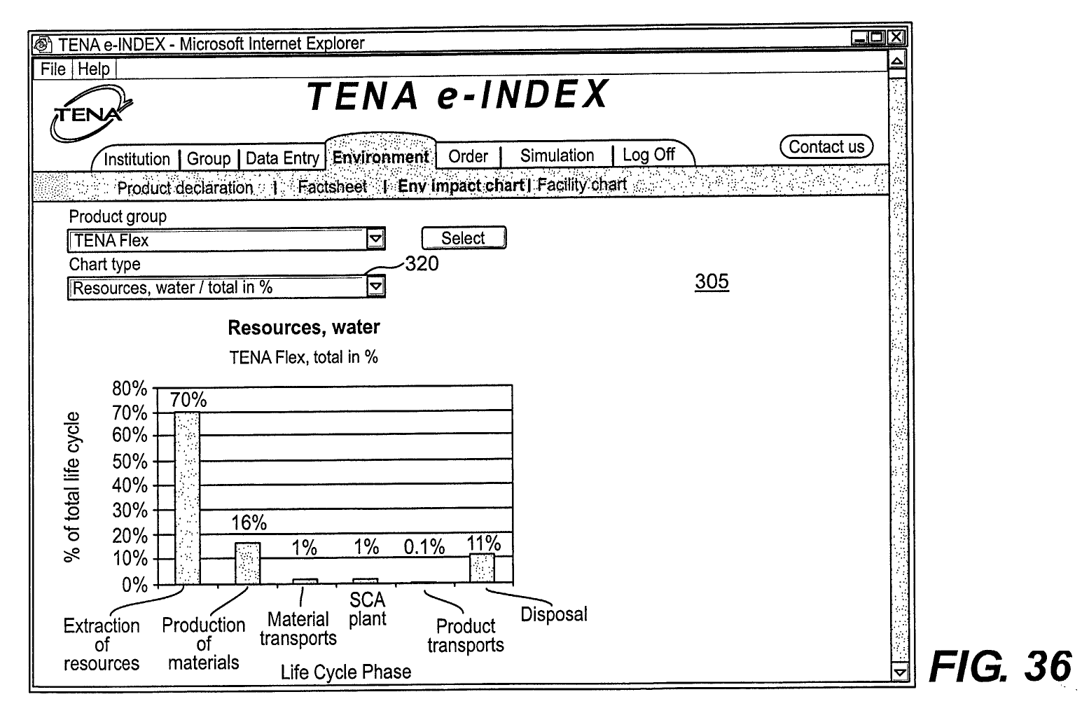

FIGS. 11-36 show views 305 associated with environmental impact chart subtab 300. Environmental impact chart subtab 300 is accessible immediately after selection of the environment tab 30. Included on environmental impact chart subtab 300 are a product group drop down menu 310 and chart type drop down menu 320. Product group drop down menu 310 functions in the same manner as product group drop down menu 110 of product declaration subtab 100, as shown in FIG. 1. In particular, the user may select from a plurality of product groups with product group drop down menu 310.

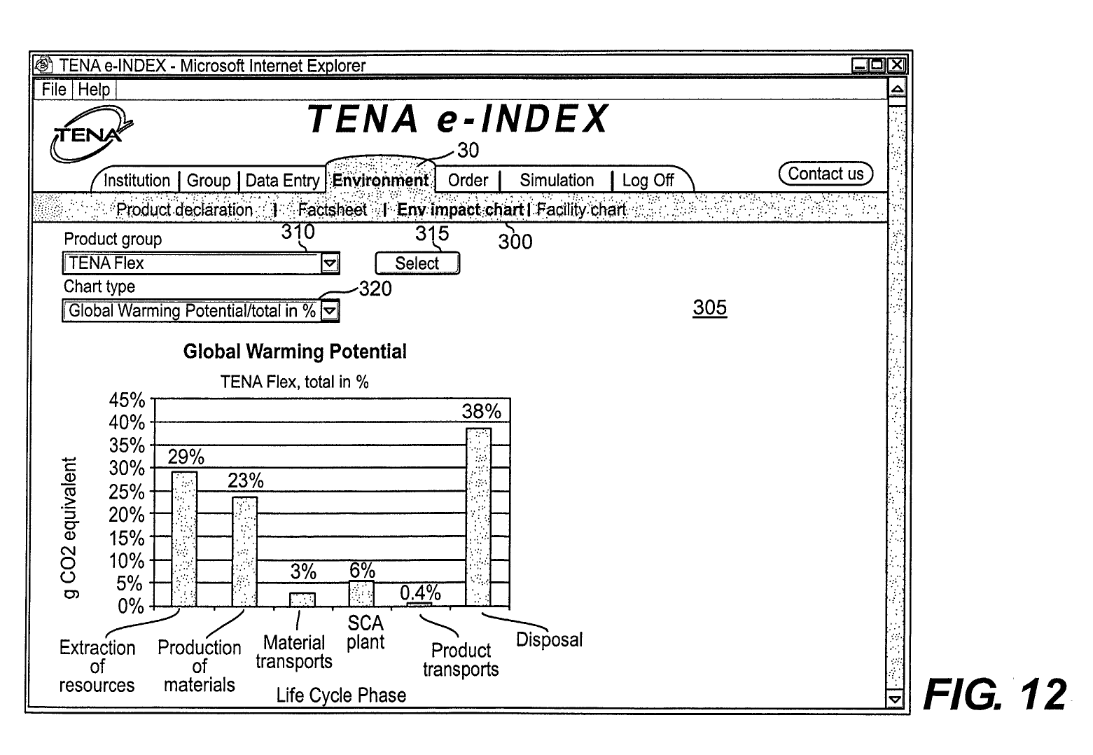

Chart type drop down menu 320 allows the user to select from various environmental charts related to the product group chosen in product group drop down menu 310. The user then selects the select button 315 to instruct the server to display a selected chart. For example, FIG. 11 shows a “Global Warming Potential” environment chart, as selected in drop box 320. FIGS. 12-36 show other environmental charts which may be displayed including respectively: global warming potential/total in percent; acidification potential/material type; acidification potential/total in percent; aquatic oxygen depletion potential/material type; aquatic oxygen depletion potential/total in percent; photochemical ozone creation potential/material type; photochemical ozone creation potential/total in percent; human toxicity/material type; human toxicity/total in percent; ozone depletion potential/material type; ozone depletion potential/total in percent; energy resources, renewable/material type; energy resources, renewable/total in percent; energy resources, not renewable/material type; energy resources, not renewable/total in percent; energy resources, thermal/material type; energy resources, thermal/total in percent; energy resources, electricity/material type; energy resources, electricity/total in percent; resources, fossil/material type; resources, fossil/total in percent; resources, renewable/material type; resources, renewable/total in percent; resources, water/material type; and resources, water/total in percent.

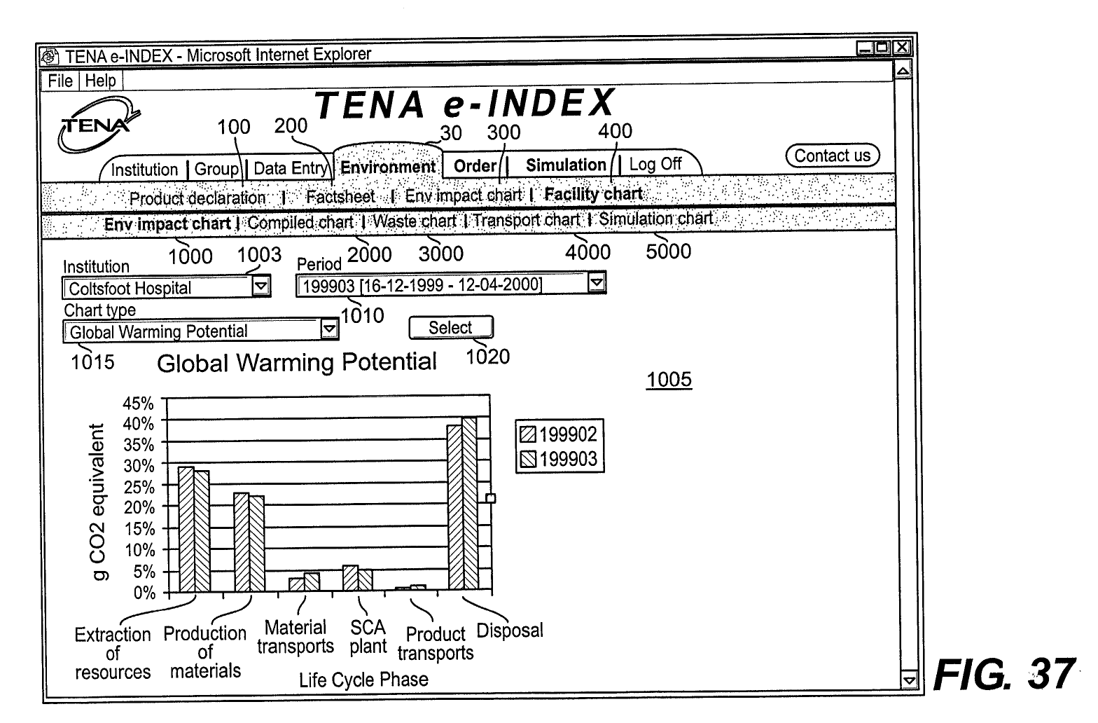

Referring to FIG. 37, facility chart subtab 400 includes a plurality of sub-subtabs for displaying information pertaining to institutional product consumption in various formats with views 1005, 2005, 3005, 4005 and 5005, respectively pertaining to: an environmental impact chart sub-subtab 1000; a compiled chart sub-subtab 2000; a waste chart sub-subtab 3000; a transport chart sub-subtab 4000; and a simulation chart sub-subtab 5000.

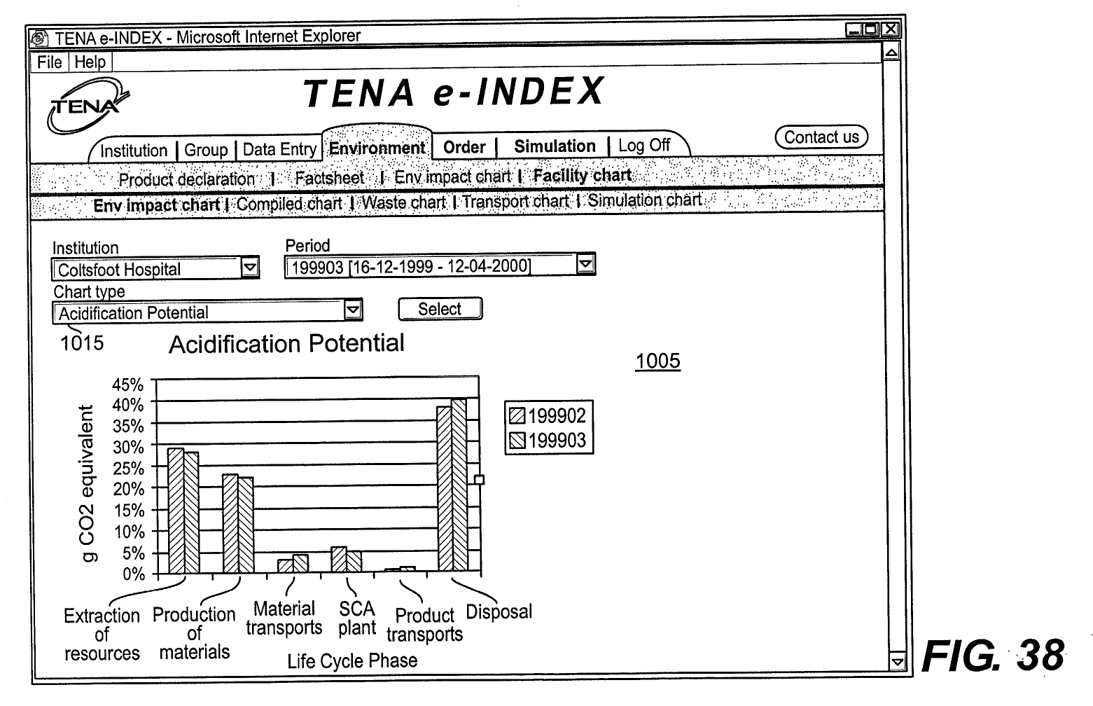

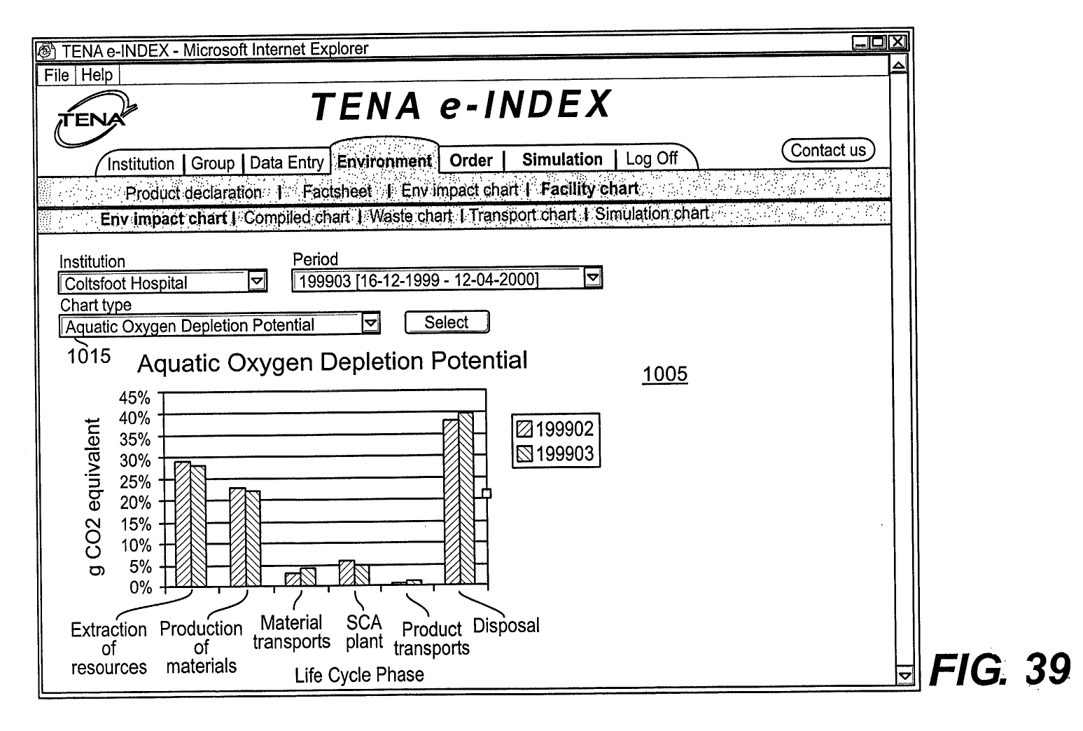

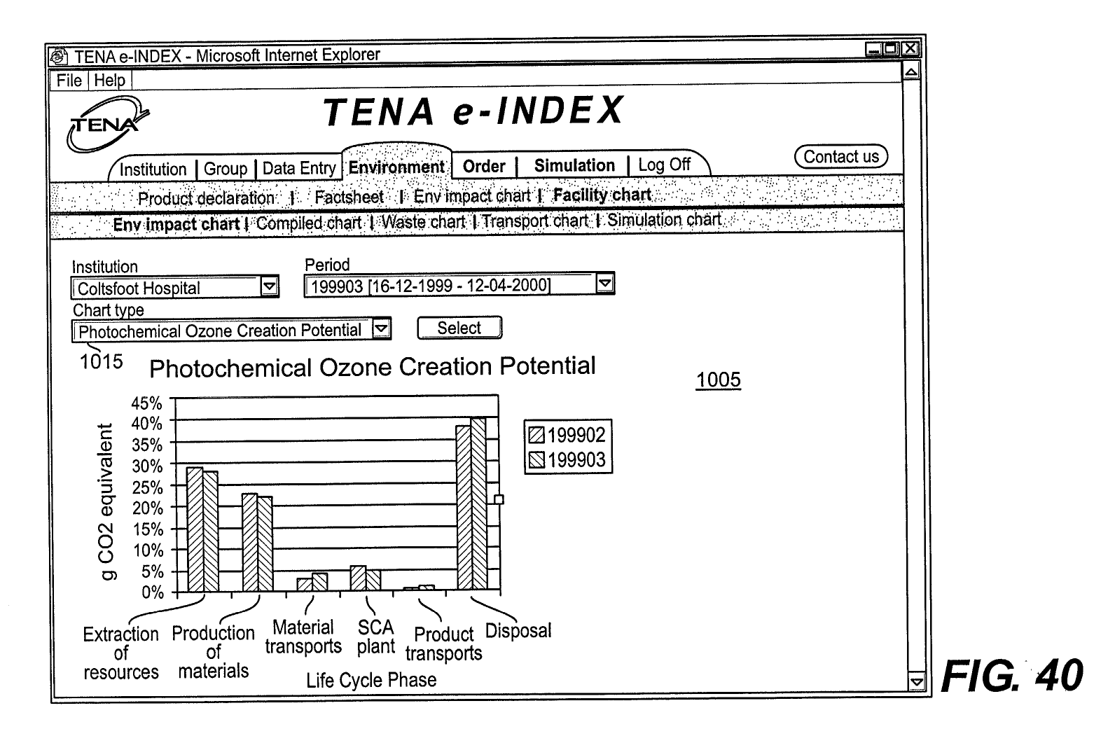

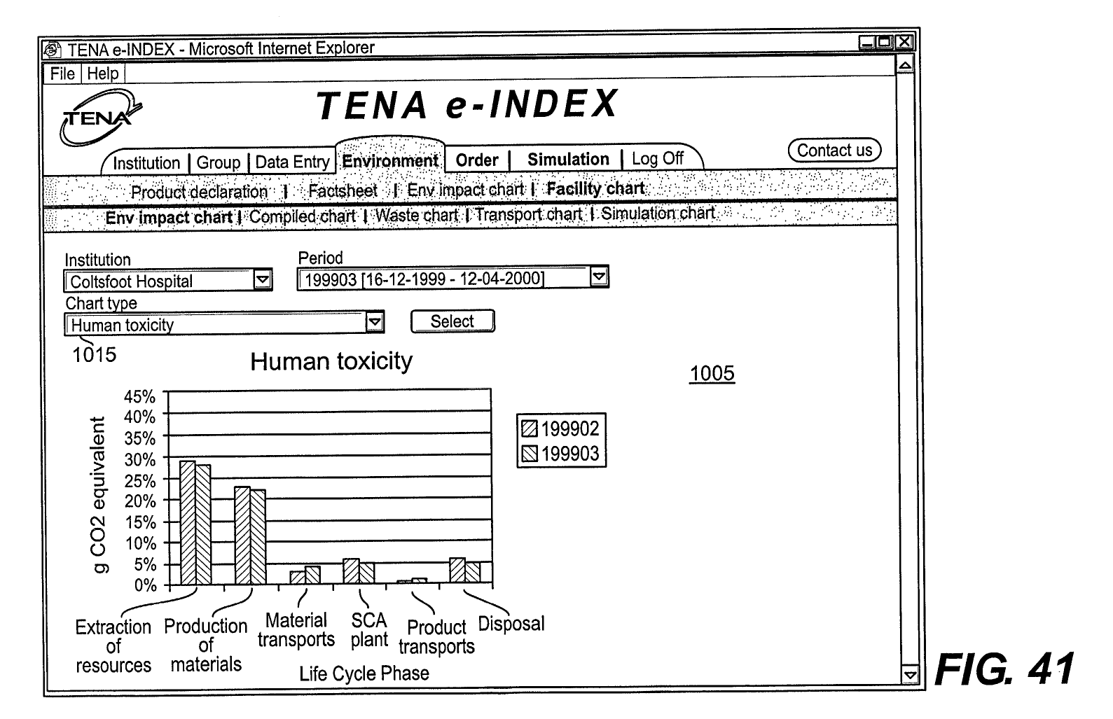

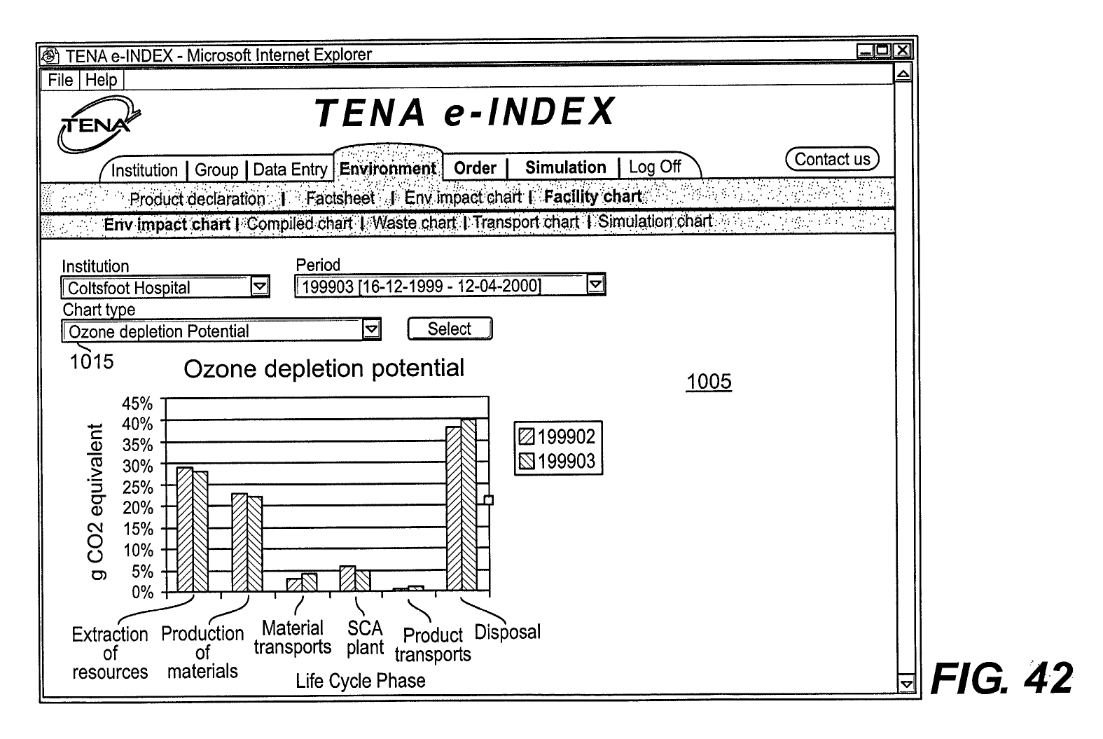

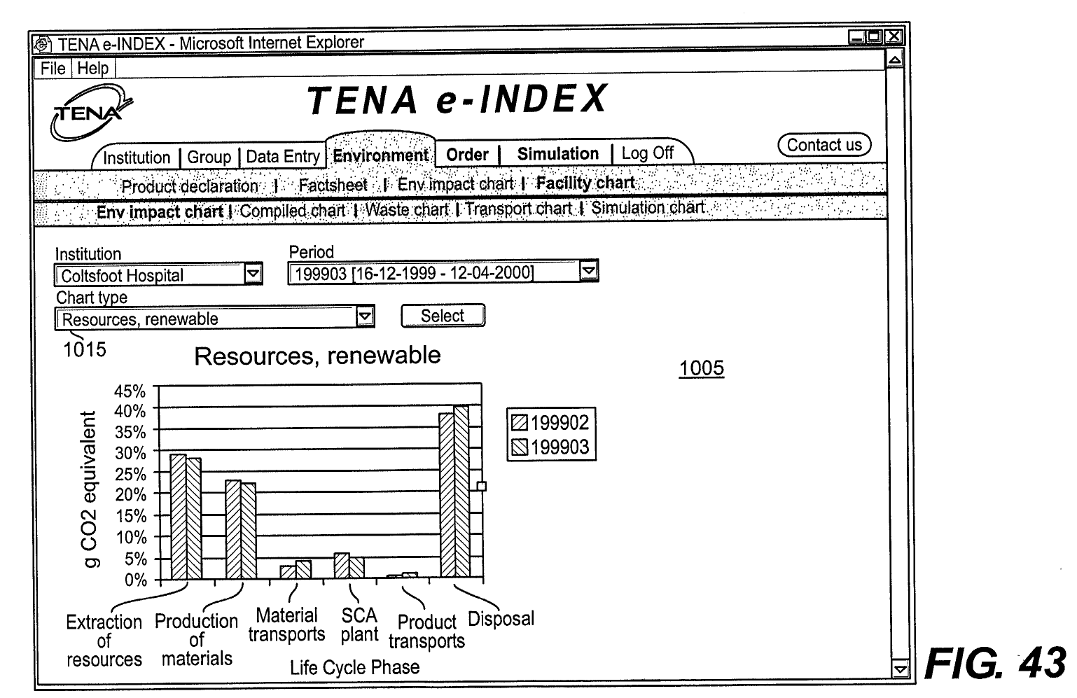

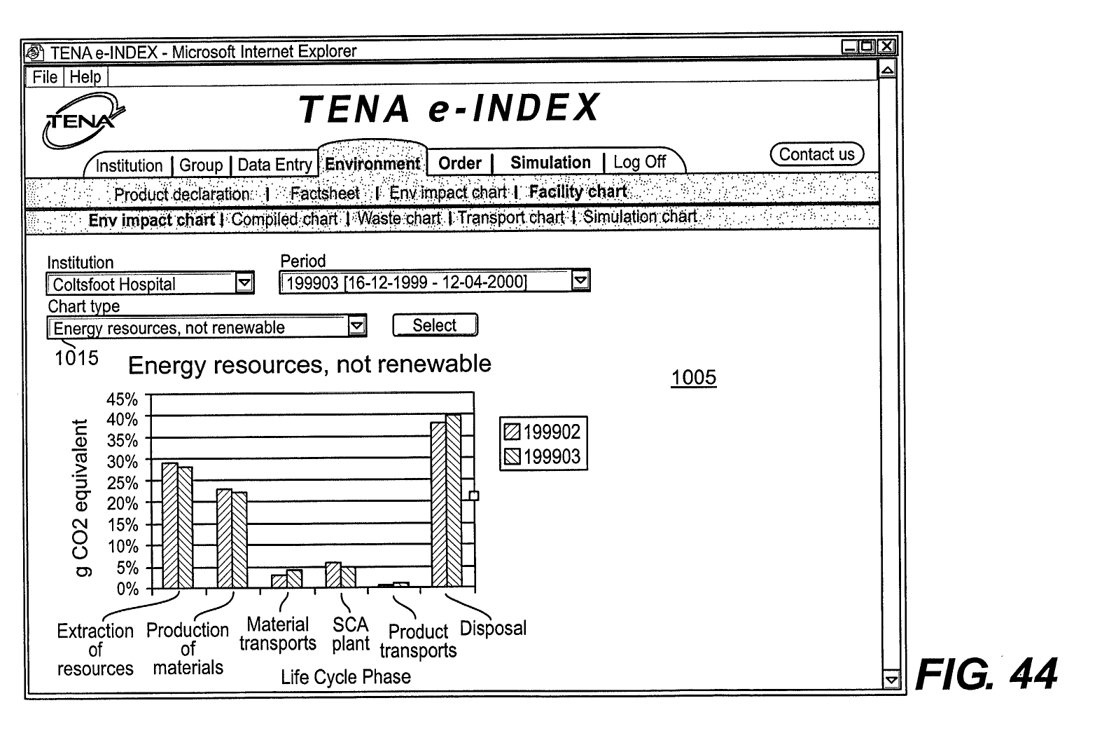

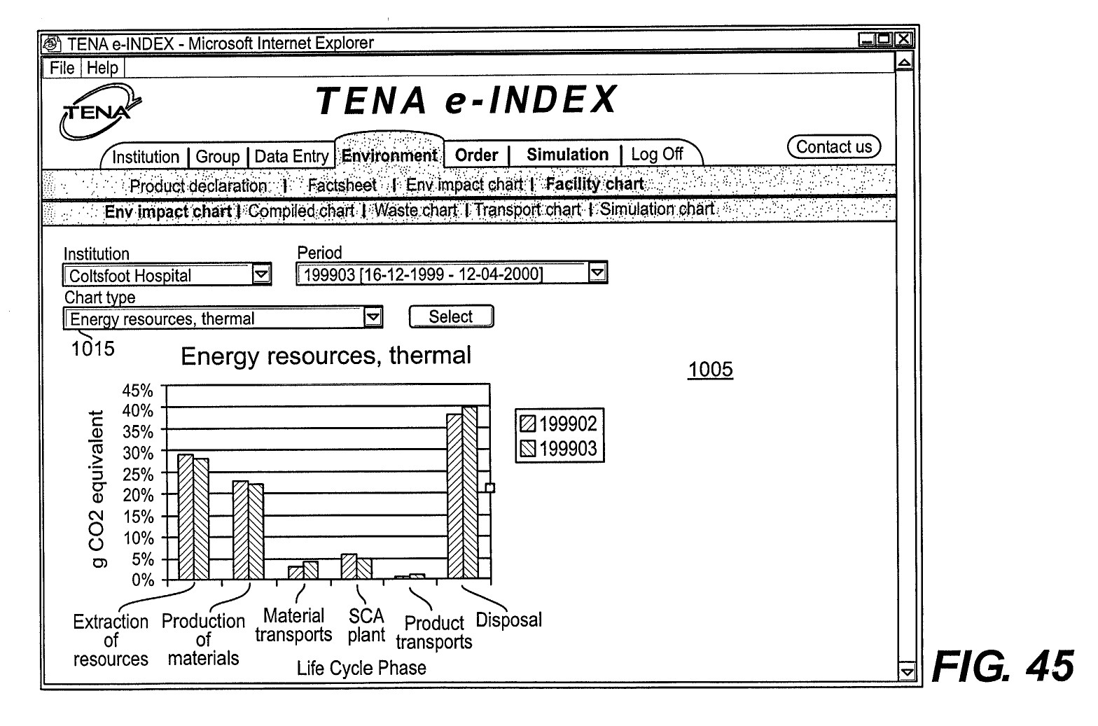

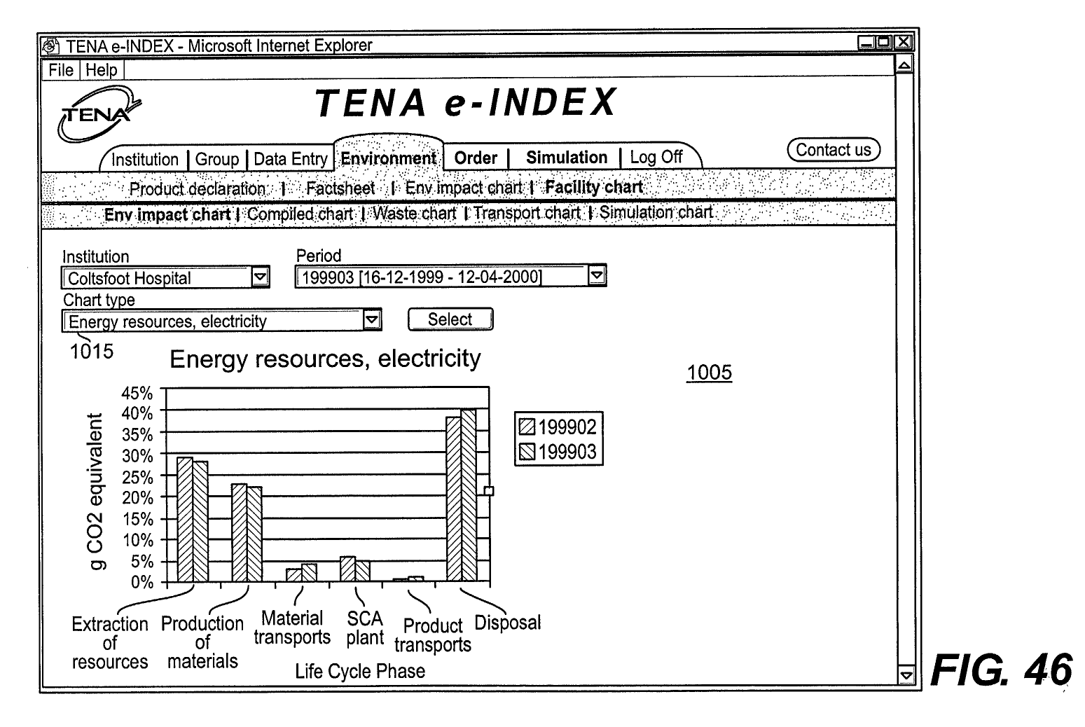

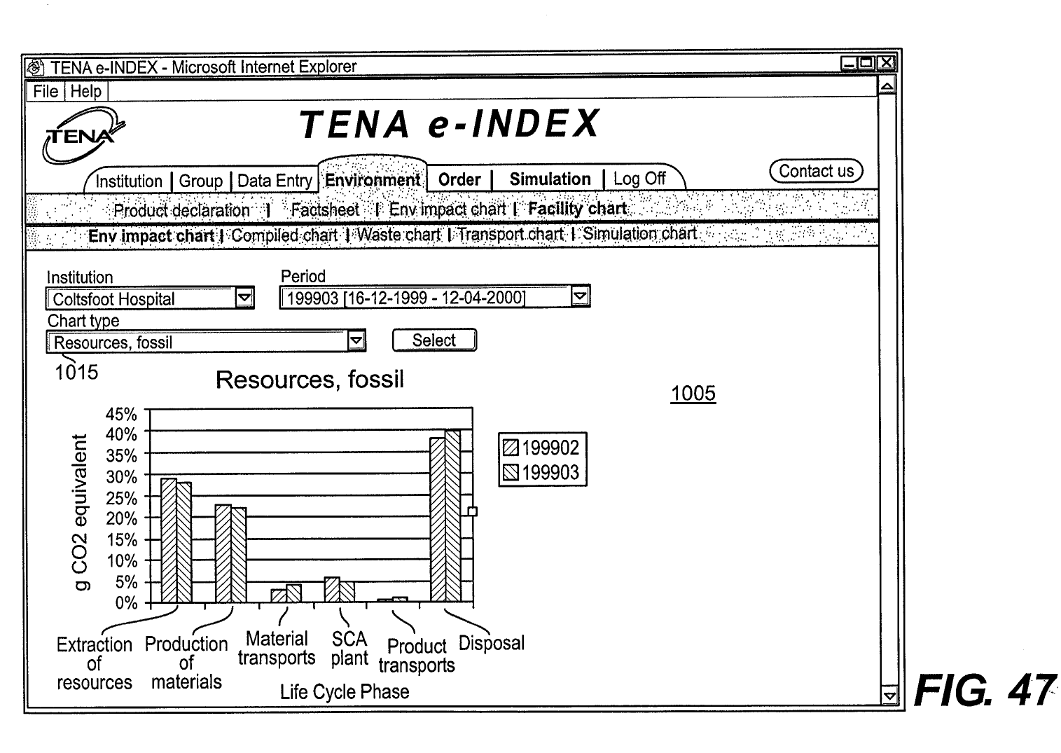

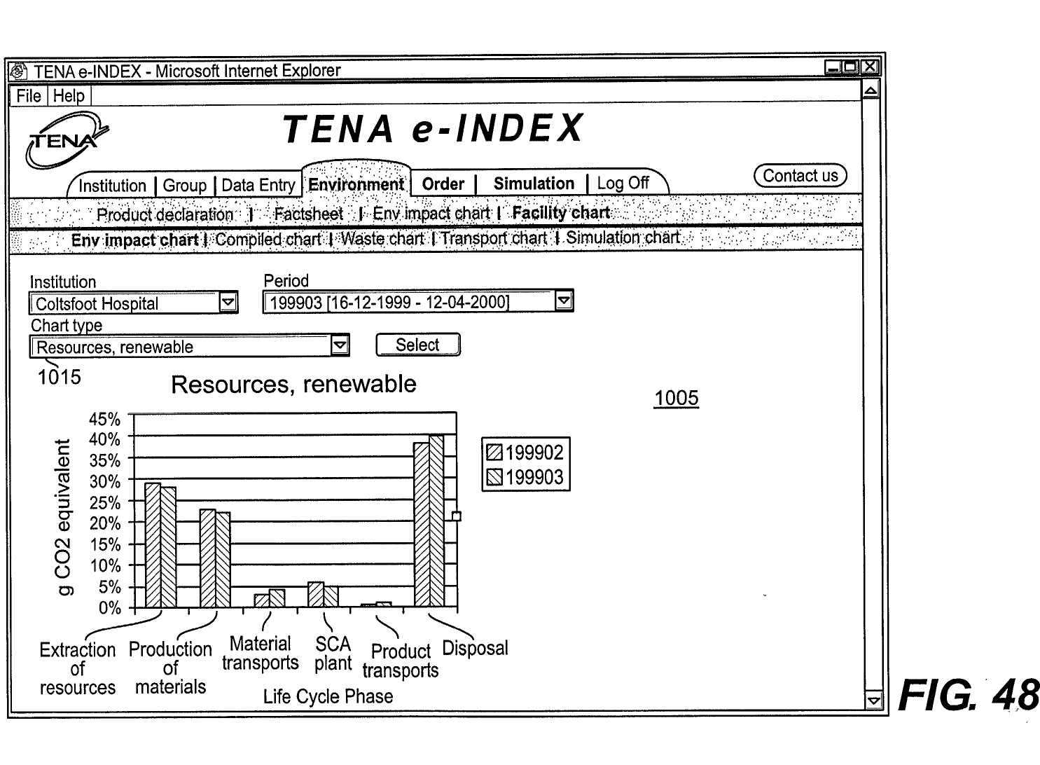

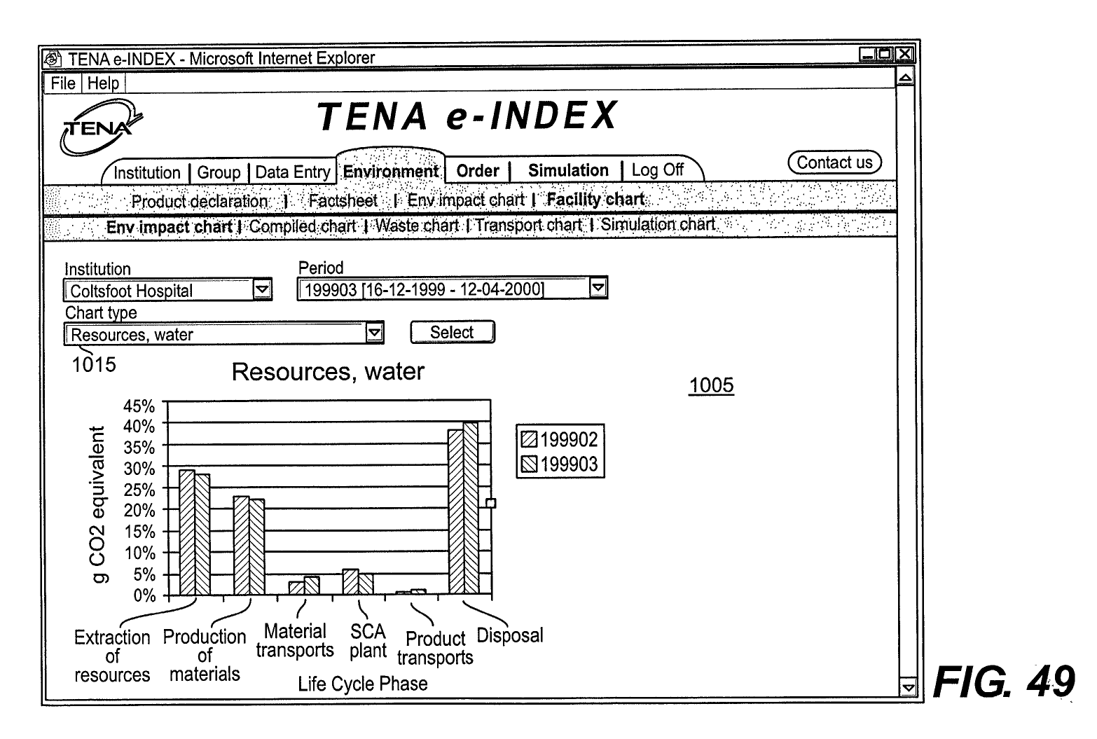

As shown in FIG. 37, view 1005 of environmental impact chart sub-subtab 1000 includes a drop box 1003 with which to select an institution for study. The user also may select a period, or range of dates, for study with drop box 1010. Finally, the user may select a chart type with drop box 1015. Once the user selects an institution and a chart type, the user instructs the server to display a chart appropriate thereto by selecting select button 1020. For example, FIG. 37 displays a global warming potential chart associated with the Coltsfoot Hospital during the period between Dec. 16, 1999 and Apr. 12, 2000 compared with the period between Aug. 16, 1999 to Dec. 15, 1999. Views 1005 of FIGS. 38-49 respectively show charts including: acidification potential; aquatic oxygen depletion potential; photochemical ozone creation potential; human toxicity; ozone depletion potential; energy resources, renewable; energy resources, not renewable; energy resources, thermal; energy resources, electricity; resources, fossil; resources, renewable; and resources, water.

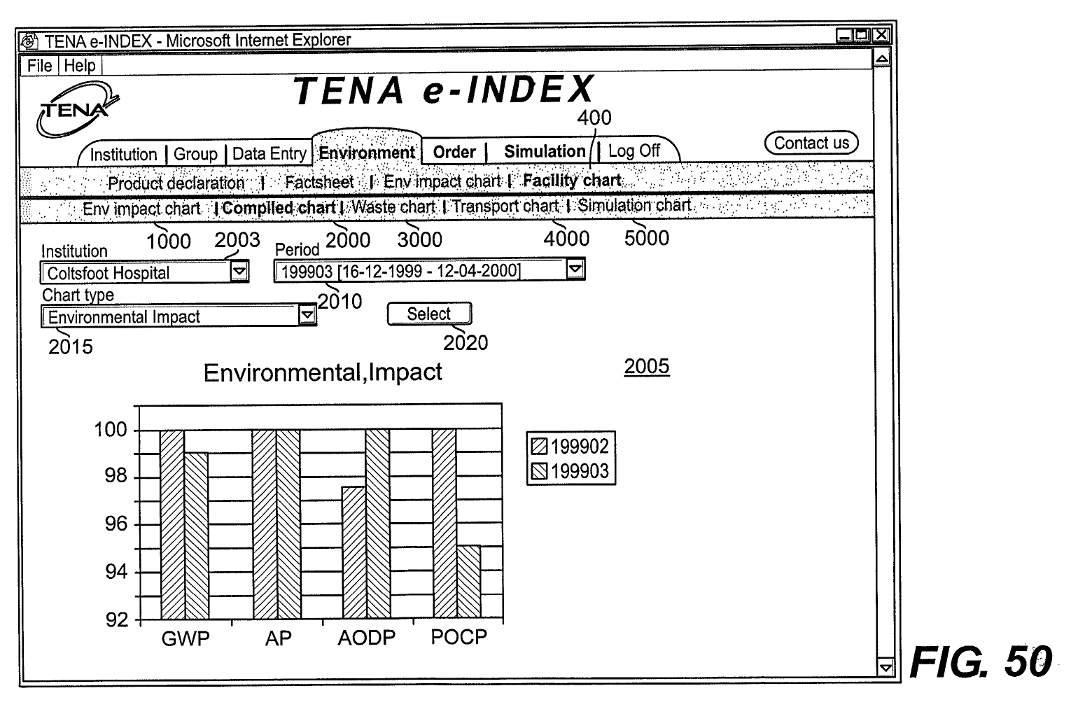

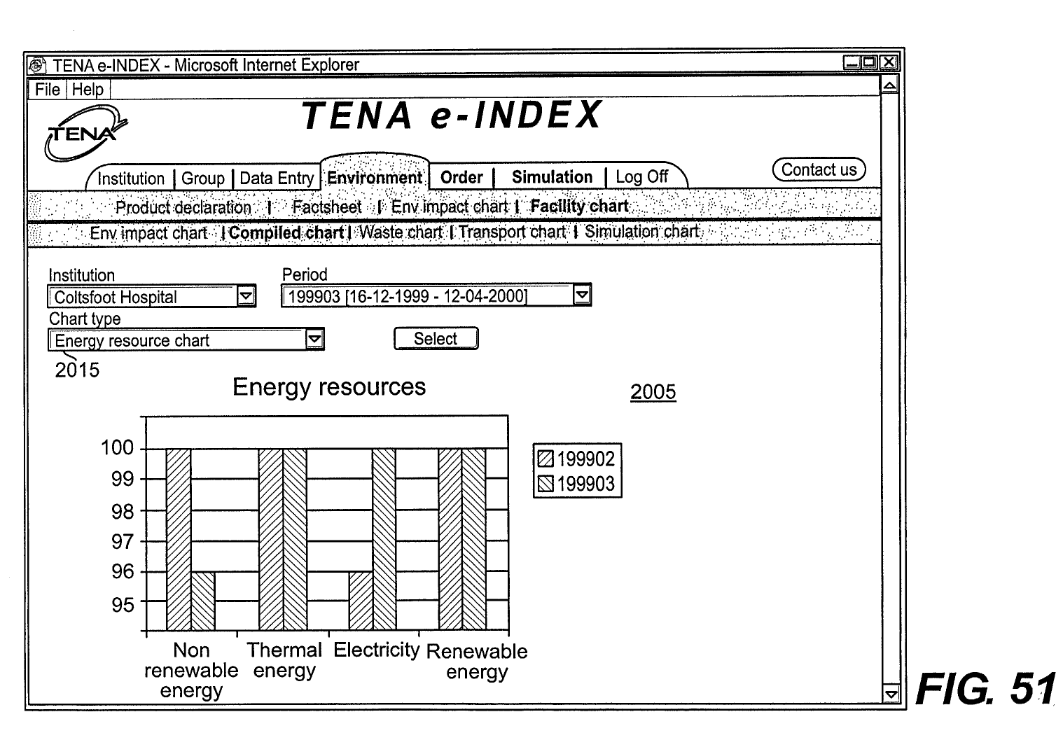

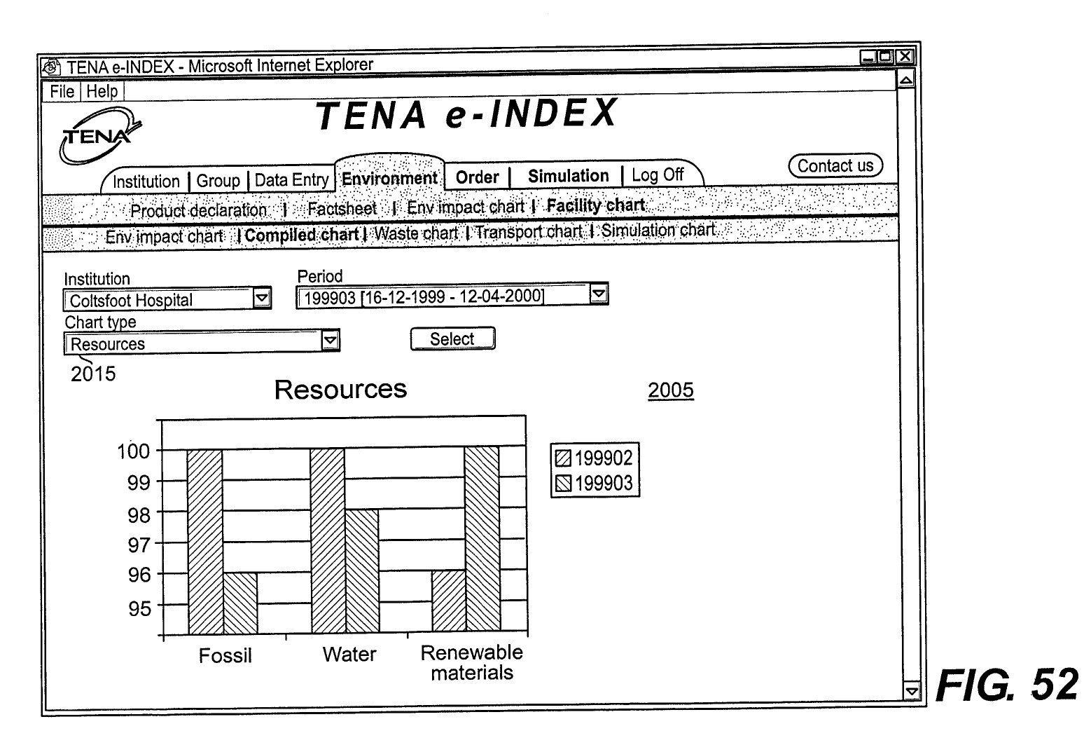

Referring to FIG. 50, compiled chart sub-subtab 2000 is similar to environmental impact chart sub-subtab 1000 in that it has a view or worksheet 2005 that provides an institution drop box 2003, a period drop box 2010, a chart type drop box 2015 and a select button 2020. As shown respectively in FIGS. 50-52, compiled chart sub-subtab 2000 may display charts pertaining to: environmental impact, energy resources, and resources. The selected period is compared to a previous period as a reference.

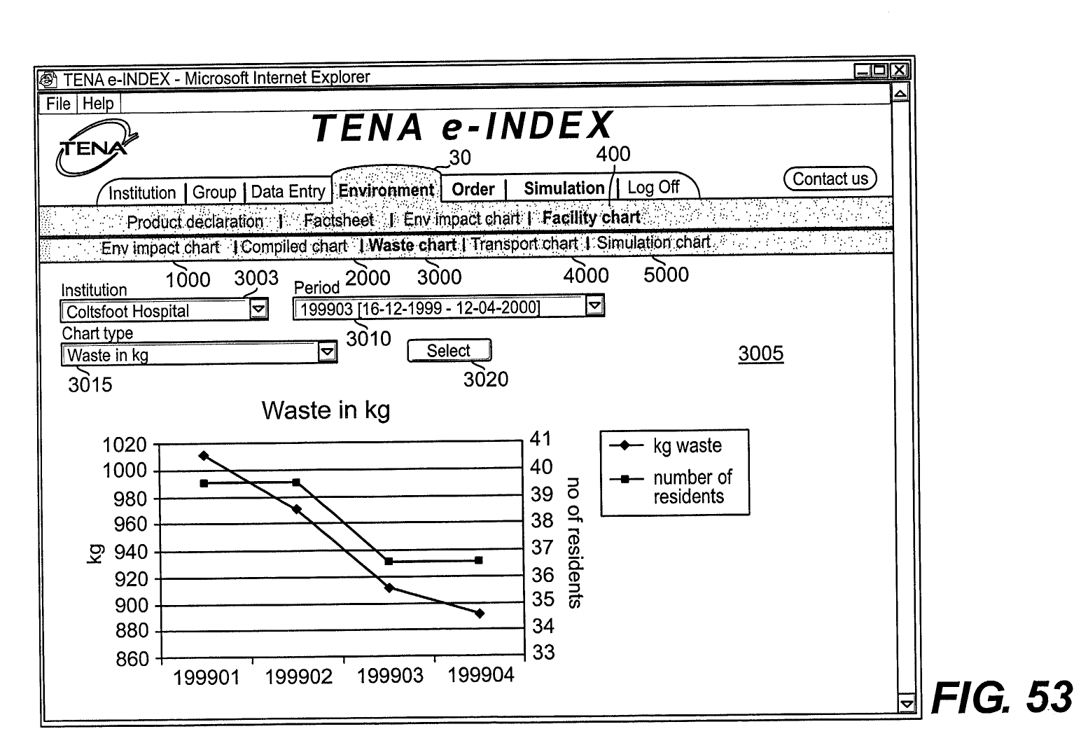

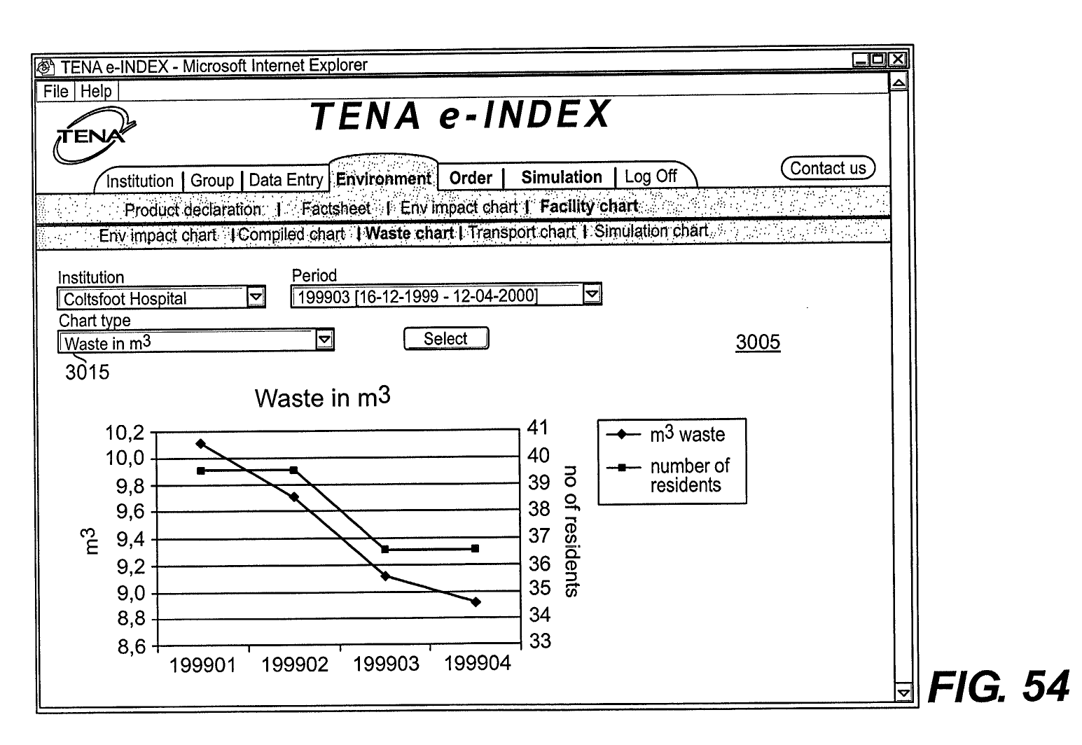

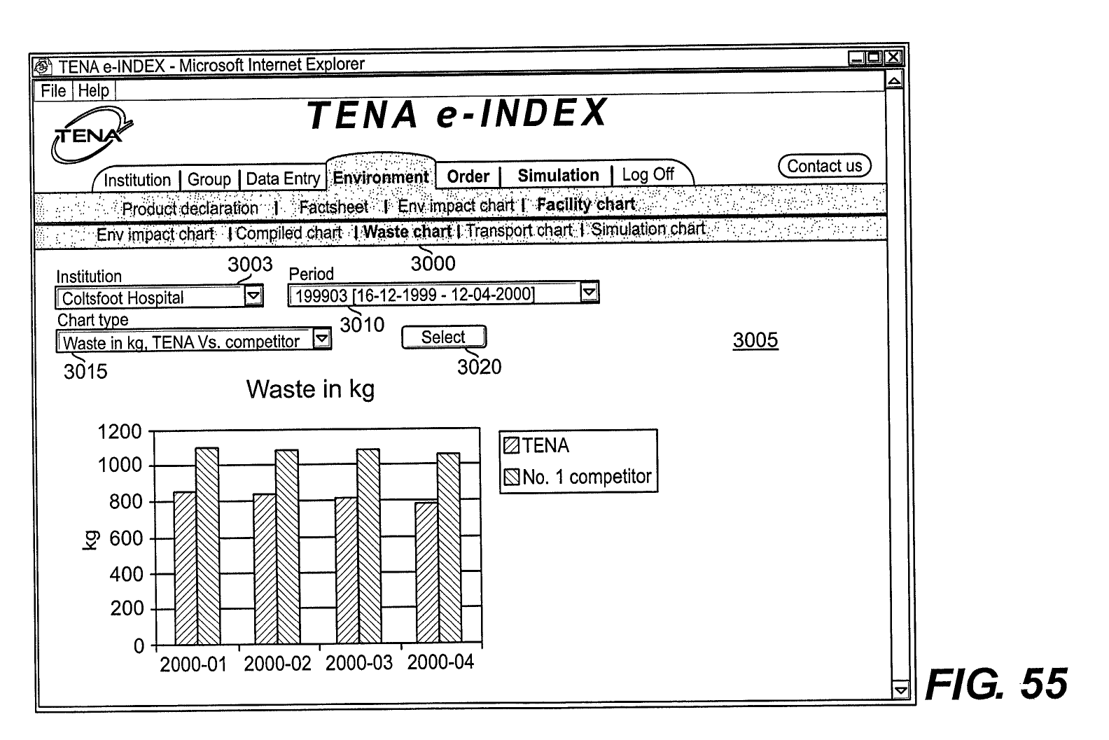

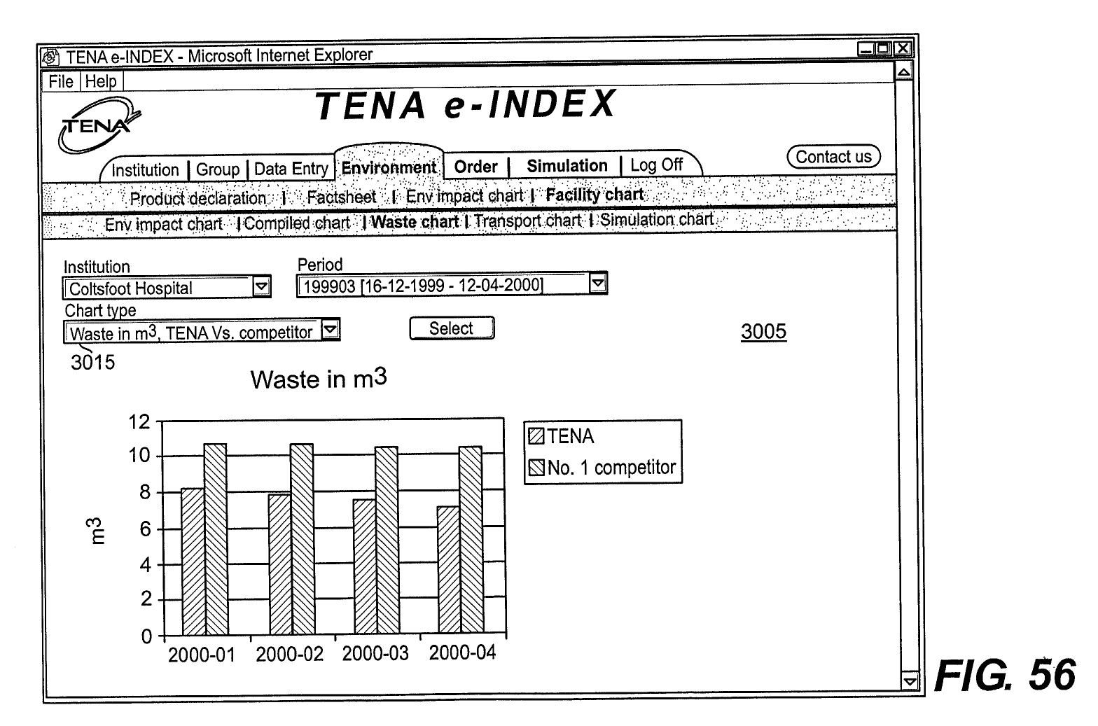

FIG. 53 shows waste chart sub-subtab 3000. As with the foregoing sub-subtabs, waste chart sub-subtab 3000 has a view 3005 that includes an institution drop box 3003, a period drop box 3010, a chart type drop box 3015 and a select button 3020. As shown in FIGS. 53 and 54, waste chart sub-subtab 3000 may display trends in waste formation, measured in terms of weight or volume. As shown in FIGS. 55 and 56, waste chart sub-subtab 3000 also may display compared waste production with respect to a competitor in weight or volume.

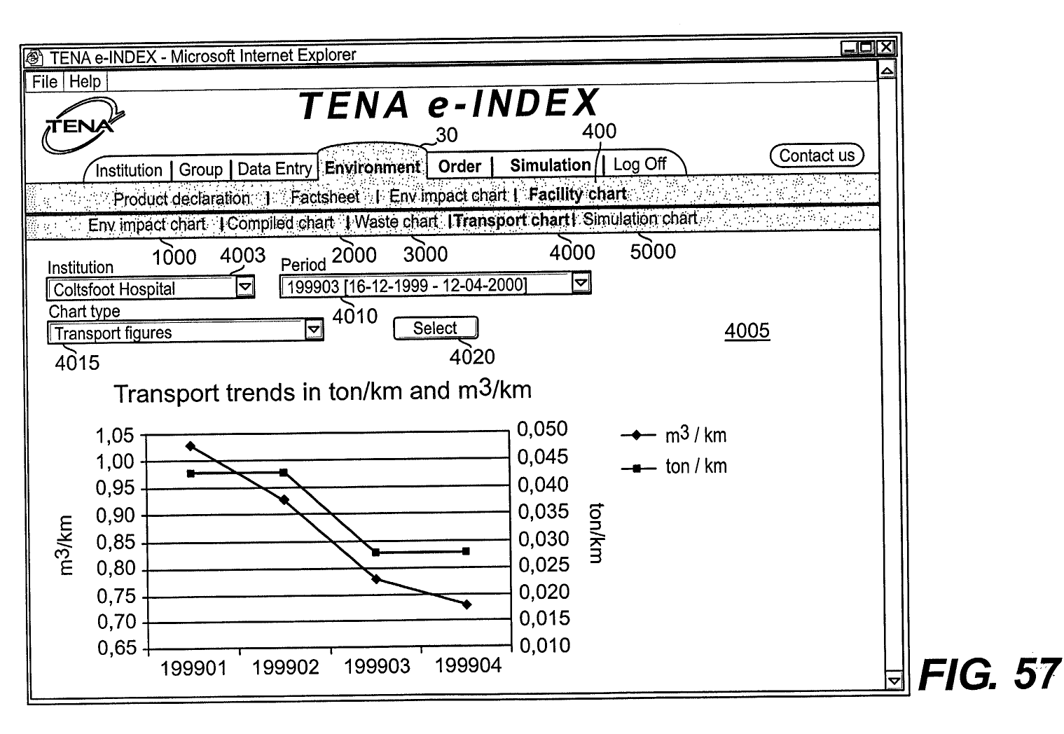

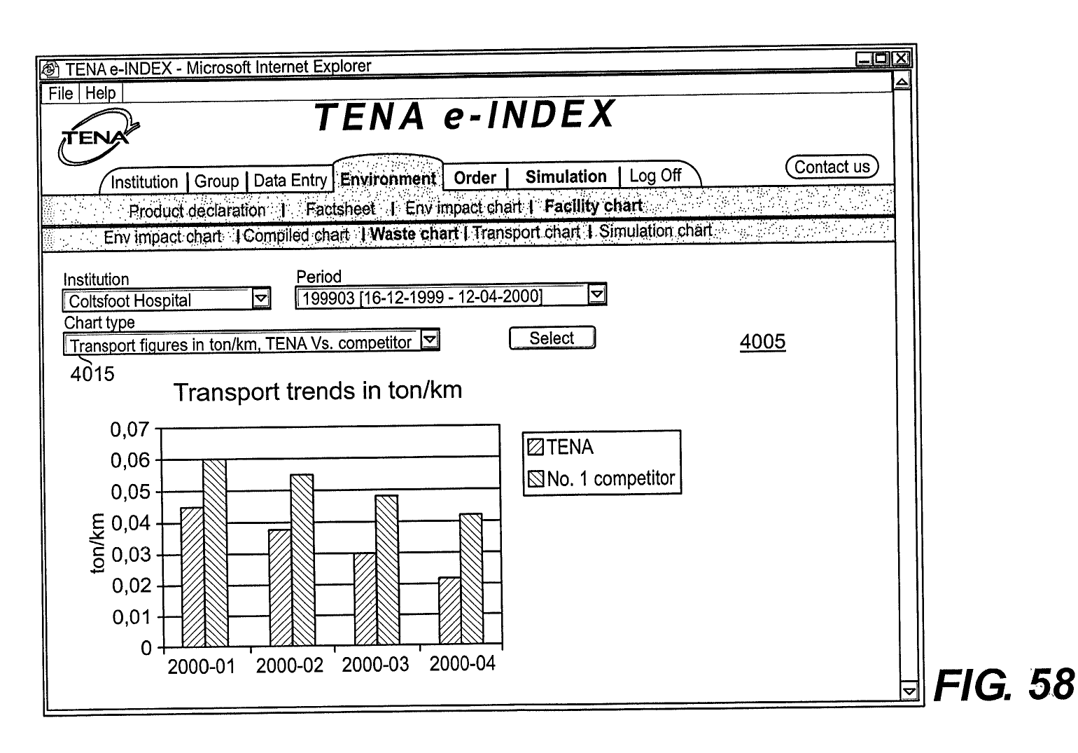

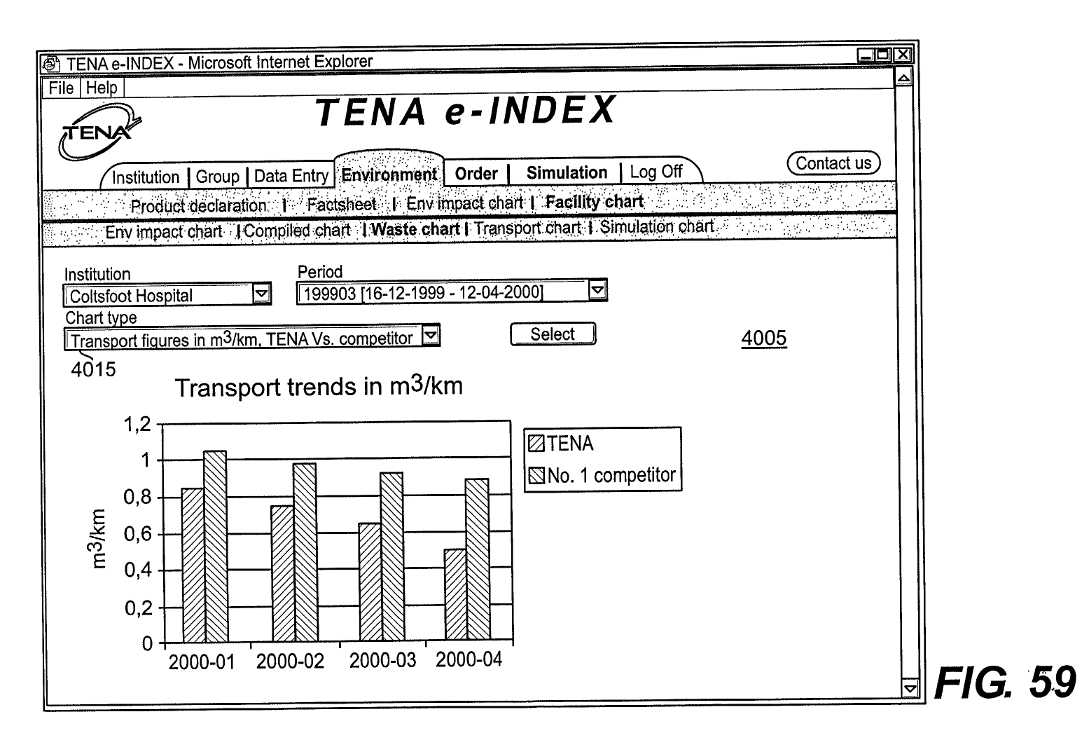

Referring to FIG. 57, transport chart sub-subtab 4000 is constructed similarly to the other sub-subtabs 1000, 2000, 3000 in that it has a view 4005 that provides an institution drop box 4003, a period drop box 4010, a chart type drop box 4015 and a select button 4020. As shown respectively in FIGS. 57-59, transport chart sub-subtab 4000 may display product transportation trends in terms of weight or volume, and comparative trends with respect to a competitor in terms of weight or volume.

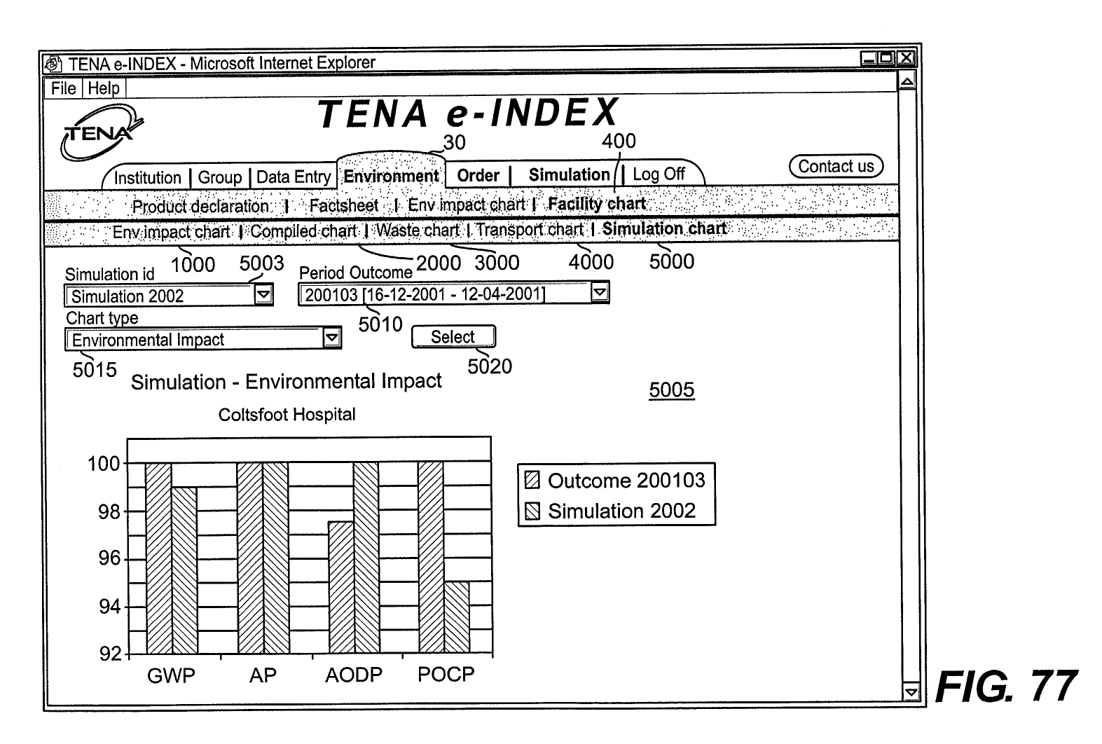

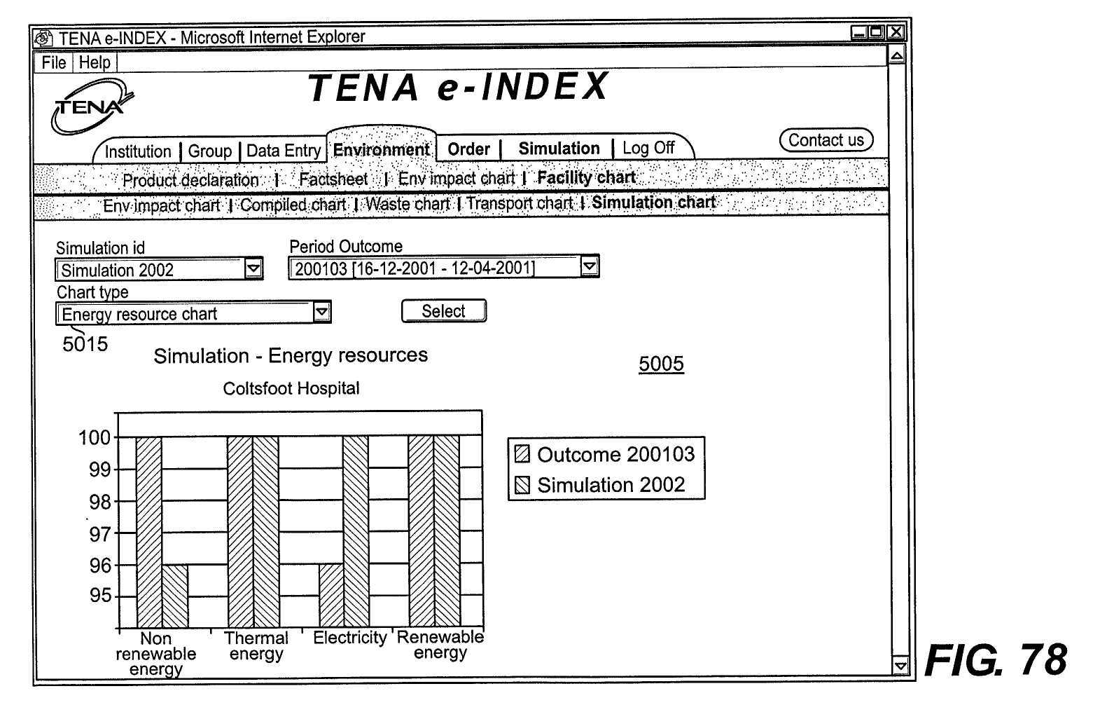

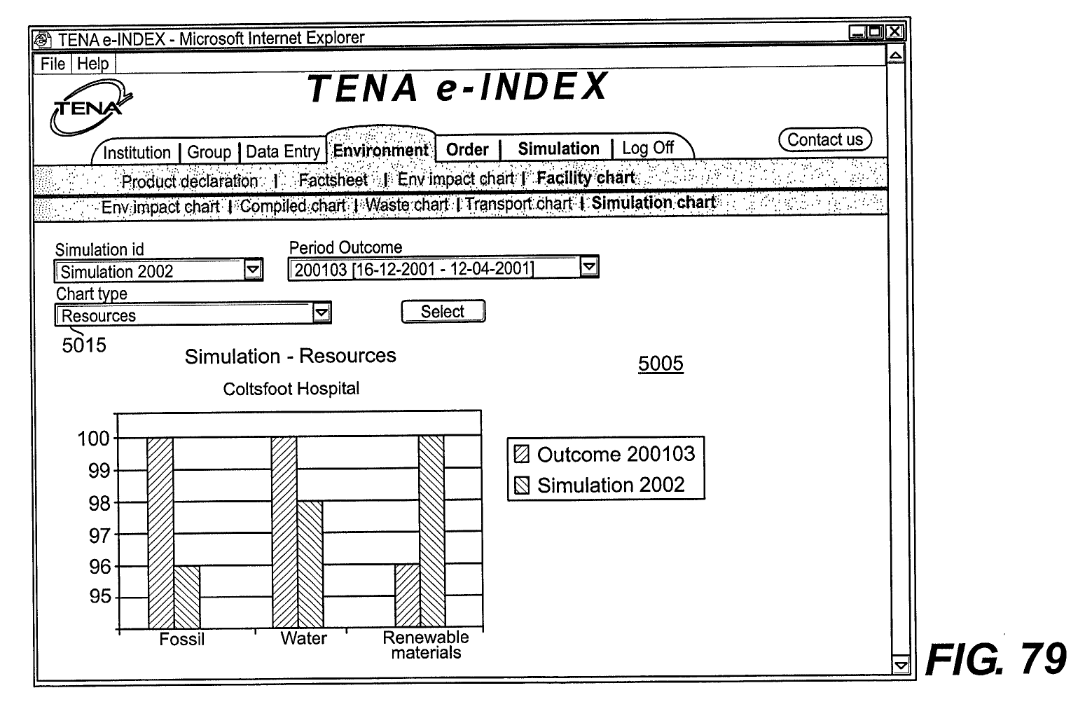

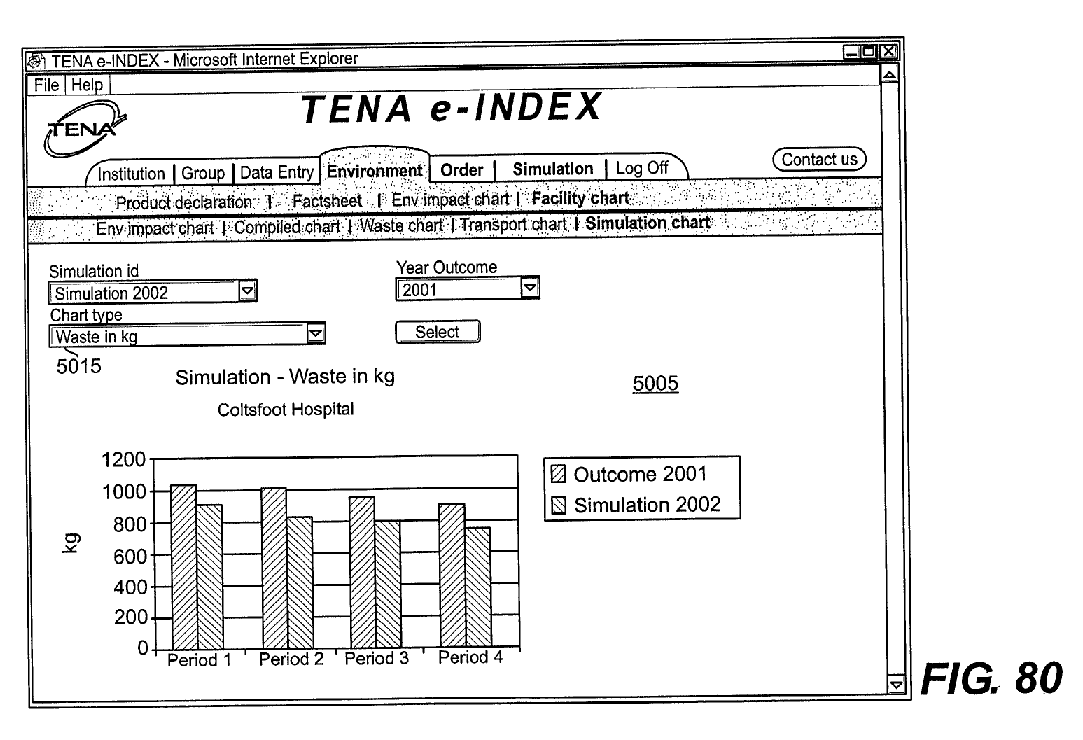

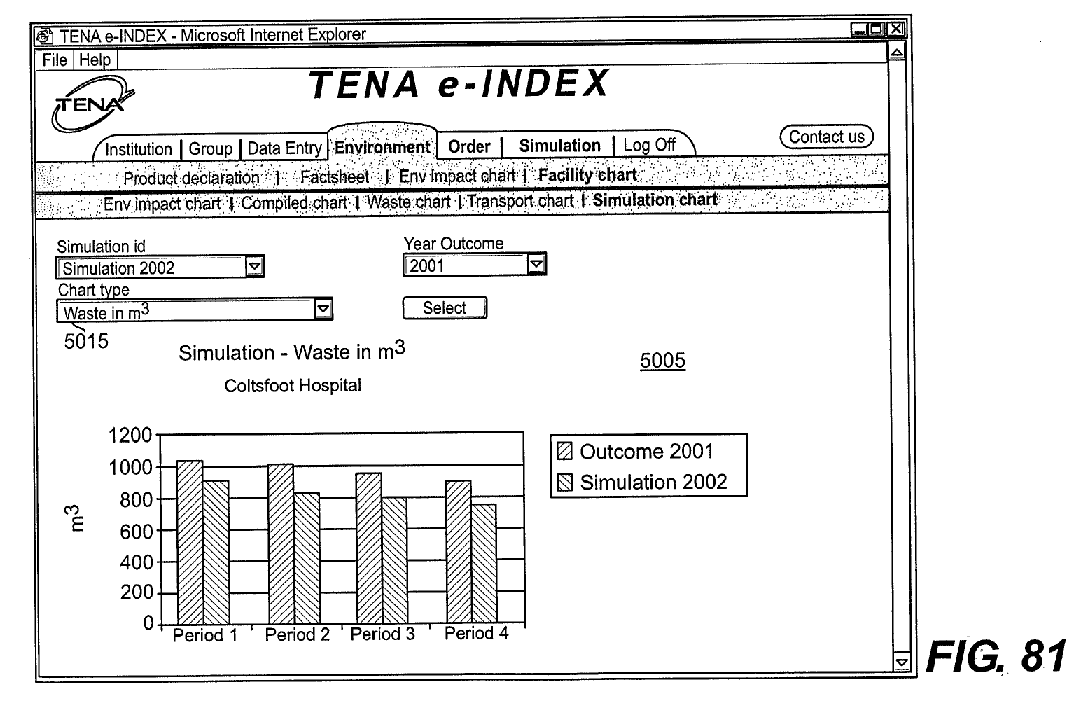

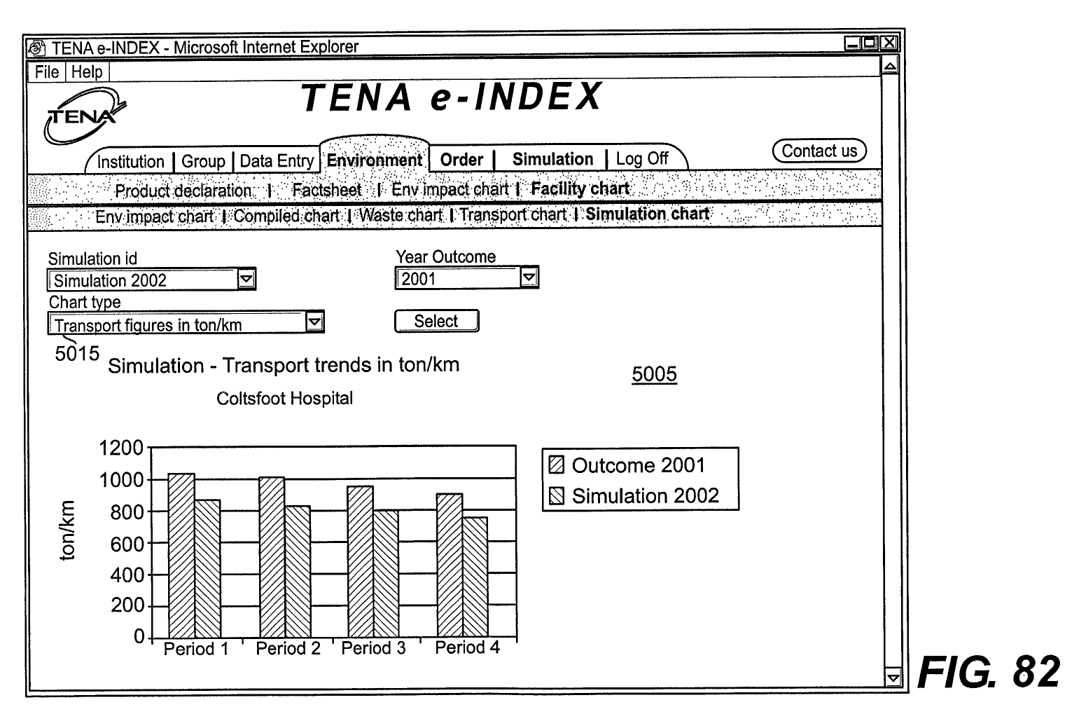

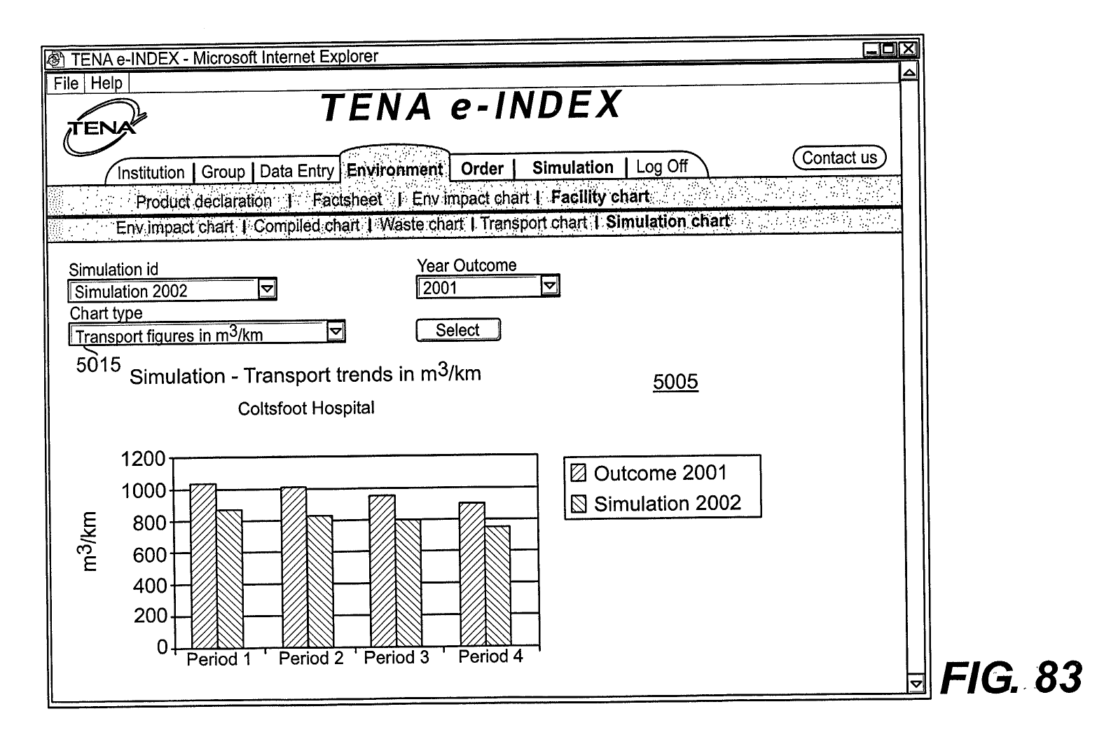

Referring to FIG. 77, simulation chart sub-subtab 5000 provides a view 5005 having a drop box 5003 with which to select data associated with a simulation performed under simulation tab 40, described in the 0104P Application. Simulation chart sub-subtab 5000 also provides a period outcome drop box 5010 with which to select a discrete period for which the simulation was performed and against which actual performance during the selected period may be compared. Simulation chart sub-subtab 5000 further provides a chart type drop box 5015 and a select button 5020, similar to such features described with respect to other sub-subtabs 1000, 2000, 3000, 4000. Some of the chart types available include environmental impact, as shown on FIG. 77. Labels appearing on the abscissa of the chart shown on FIG. 77 correspond to terminology associated with characteristics measured as follows: GWP refers to global warming potential; AP refers to acidification potential; AODP refers to aquatic oxygen depletion potential; and POCP refers to photochemical ozone creation potential. Other chart types show simulation results as compared with actual data in terms of: energy resources, as shown on FIG. 78; resources, as shown on FIG. 79; waste in kg, as shown on FIG. 80; waste in cubic meters, as shown on FIG. 81; transport trends in tons per kilometer, as shown on FIG. 82; and transport trends in cubic meters per kilometer, as shown on FIG. 83. The chart types of FIGS. 77-83 generally correspond to the chart types of FIGS. 50-59.

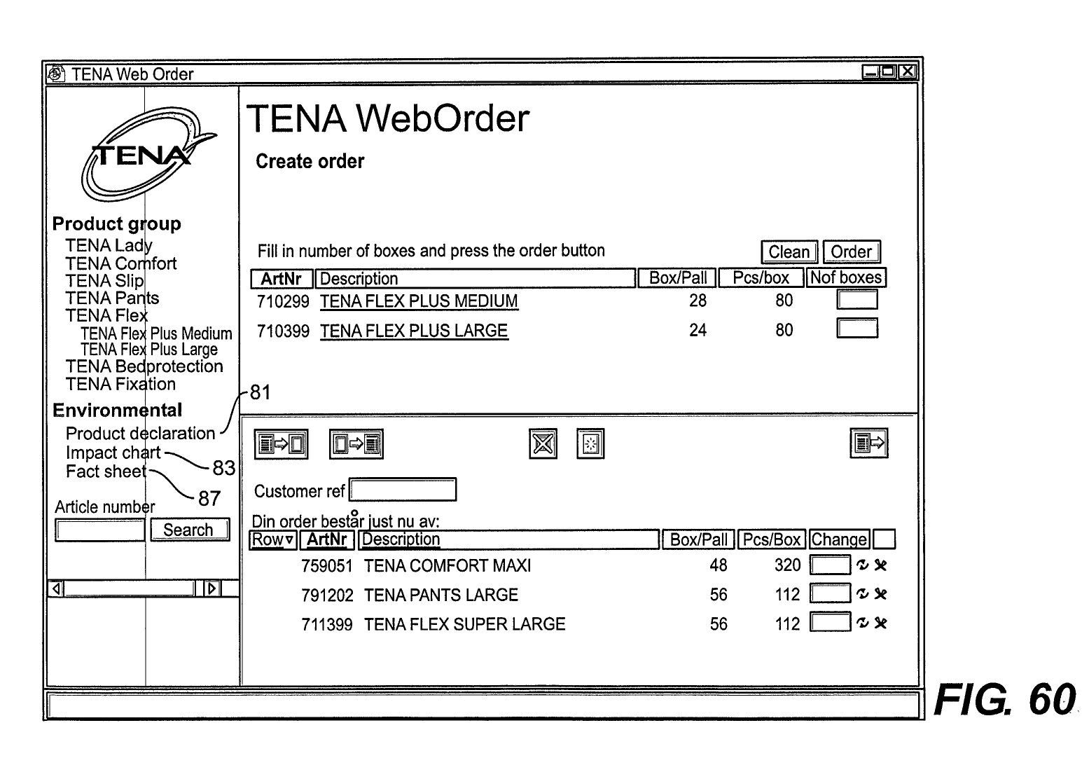

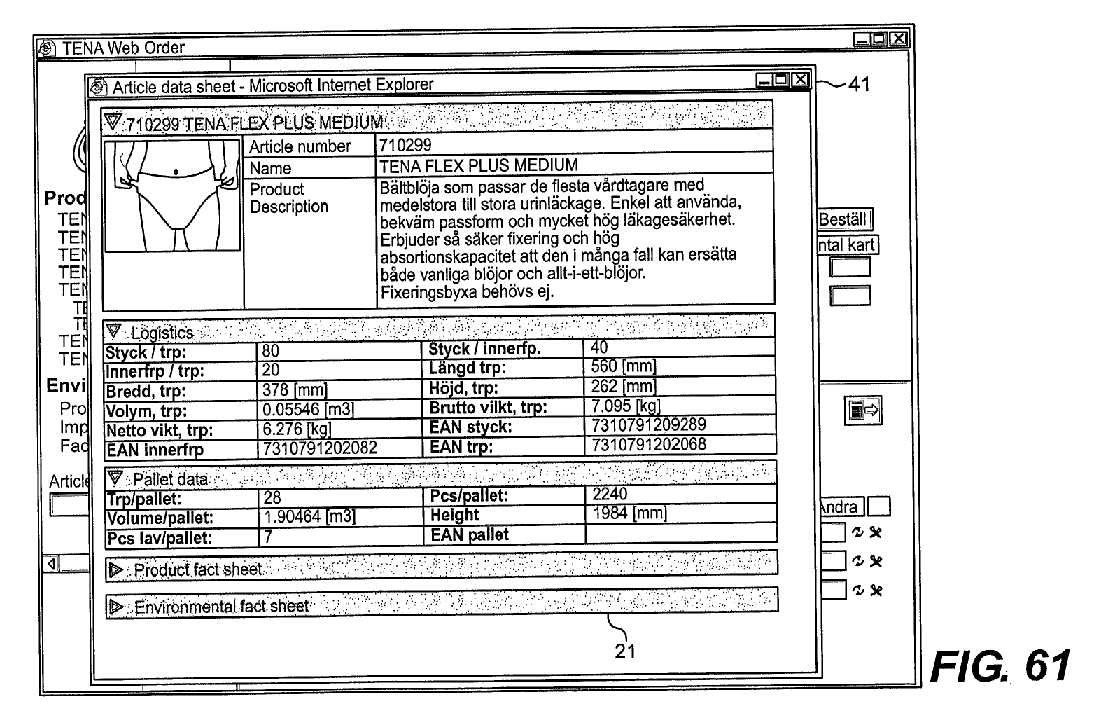

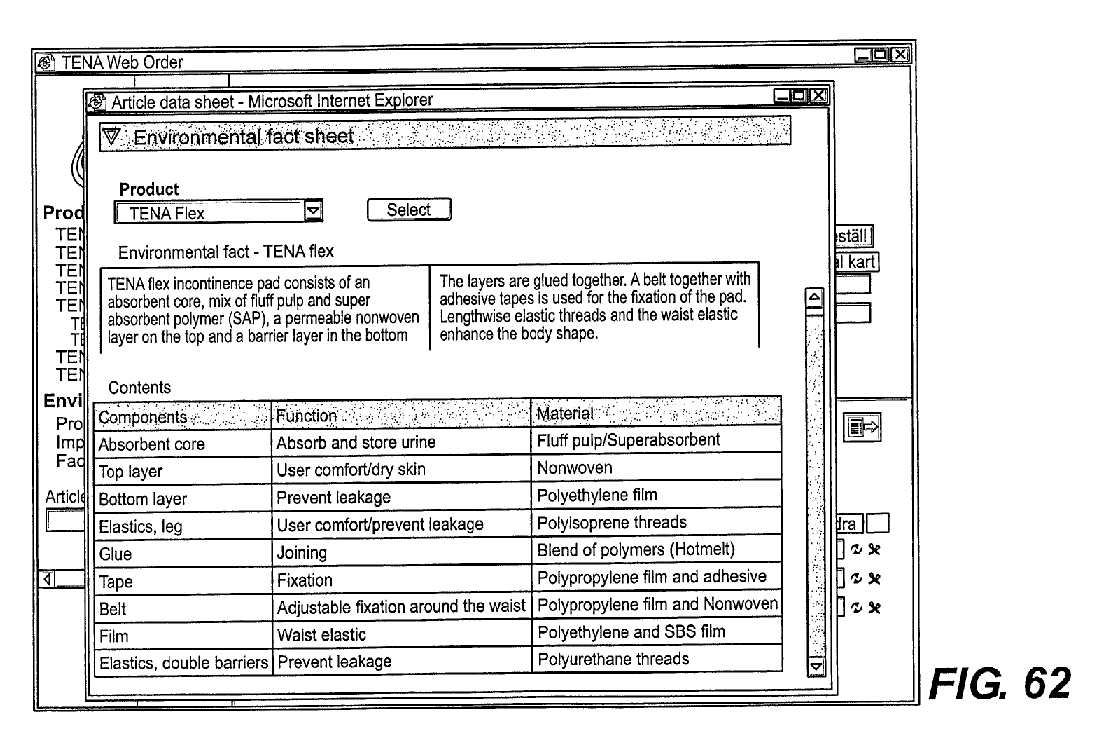

Referring to FIG. 60, the invention provides for supplying product information to the public through a public GUI. Once a user has navigated to a web order page 7, as shown, web order page 7 provides a user with a plurality of links to various product groups in which the user may be interested. Selecting any of the links prompts the server to present a separate window 41, as shown in FIG. 61, that displays information about the selected product groups such as the TENA FLEX PLUS MEDIUM product group displayed. When the user selects the environmental fact sheet link 21, the server presents in window 41 an environmental fact sheet, as shown in FIG. 62, comparable to that shown and described in FIGS. 7-10.

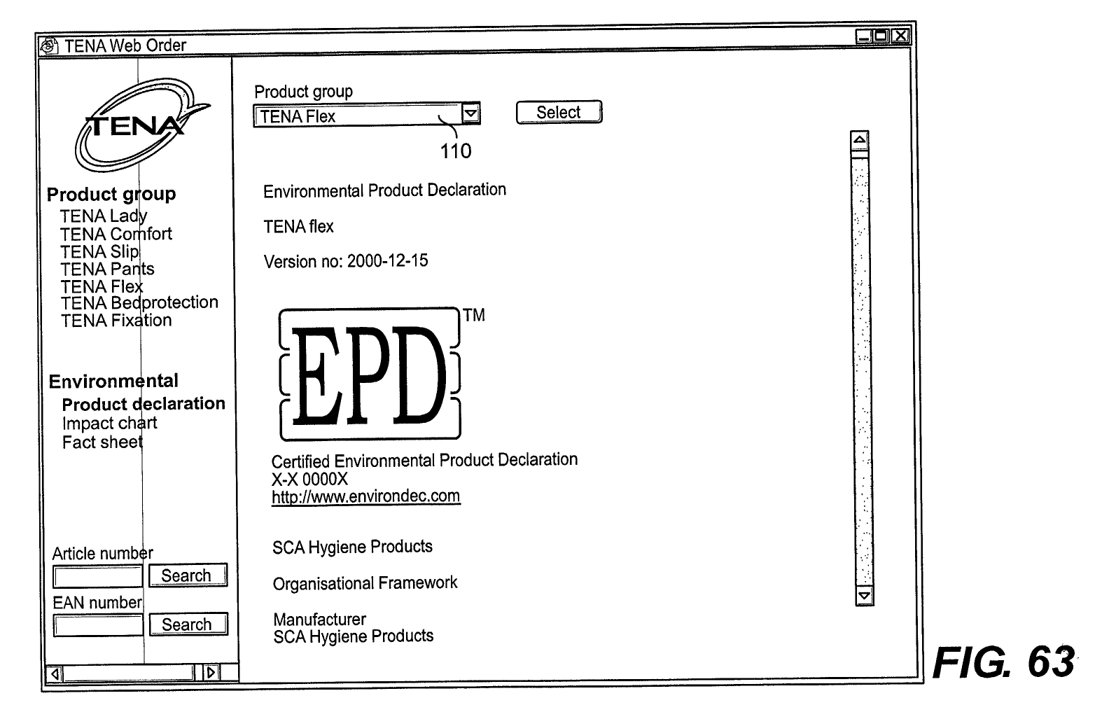

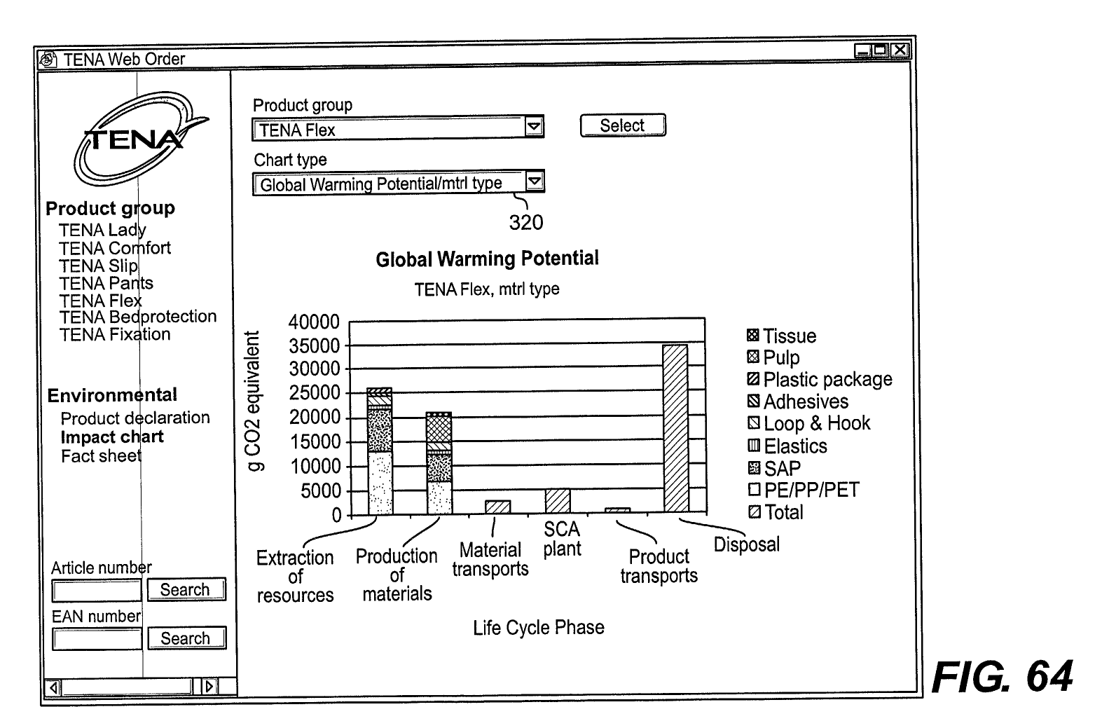

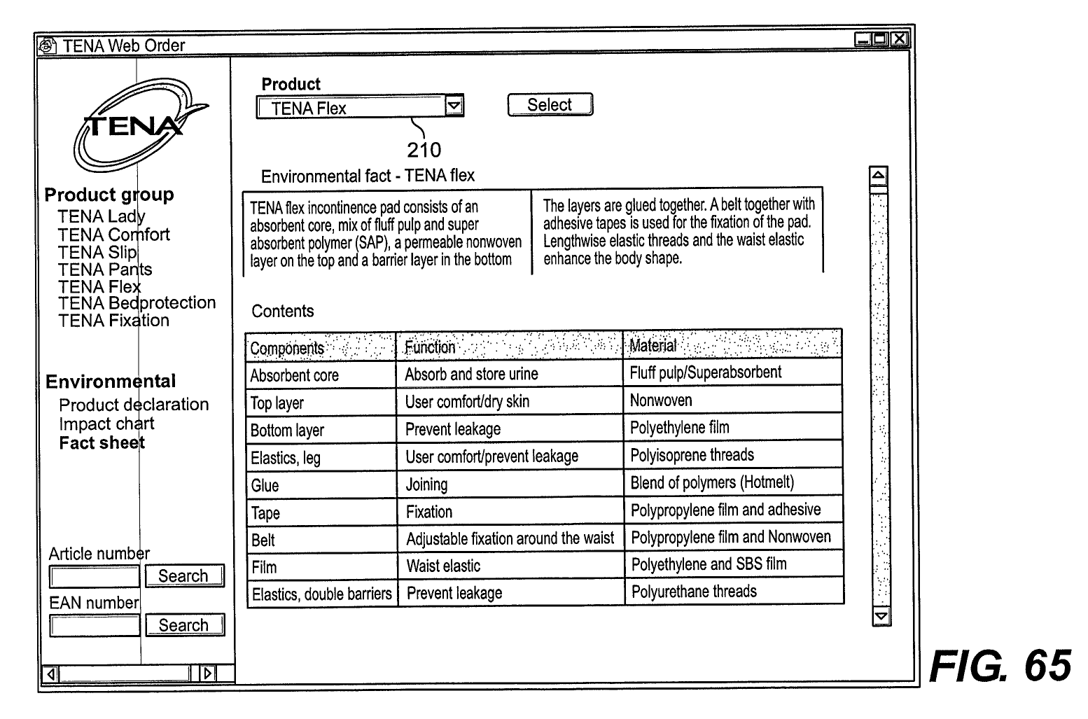

Referring again to FIG. 60, when the user selects a product declaration link 81, impact chart link 83 or fact sheet link 87, the server displays corresponding views respectively shown on FIGS. 63-65, which correspond respectively to FIGS. 1-6, 11-36 and 7-10.

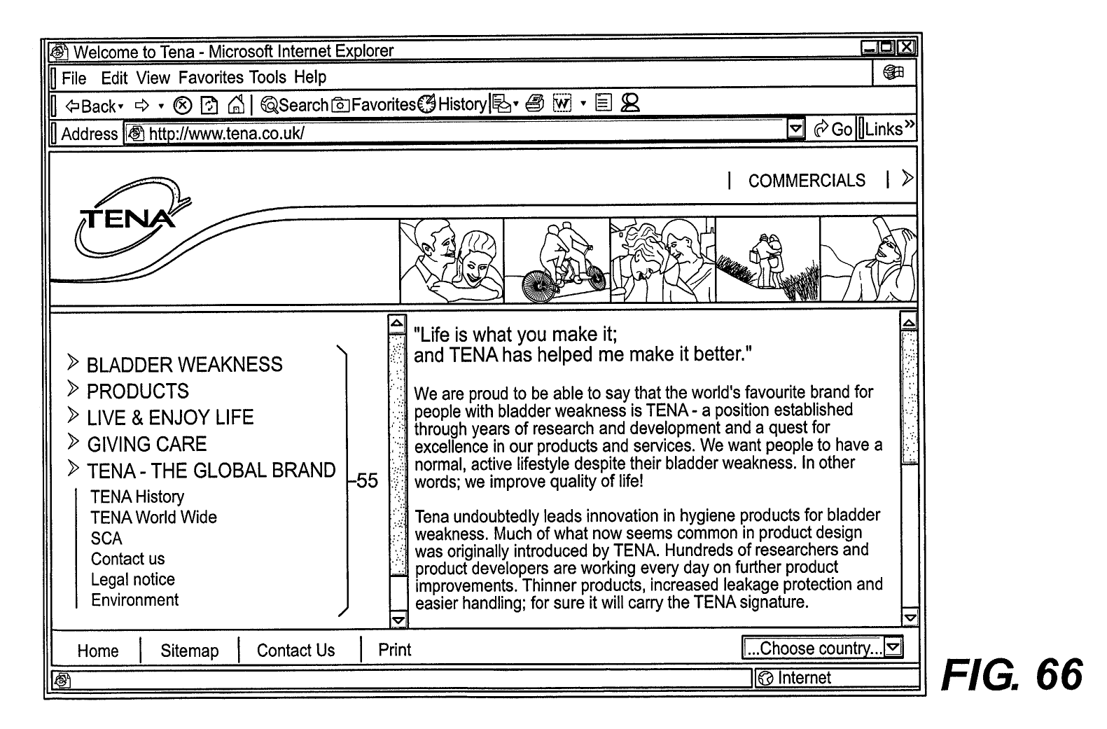

Referring to FIGS. 66-76, the invention provides for maximizing the utility of data received and compiled with respect to actual product manufacturing and data consumption by making same available to potential customers. Based on the analysis of information displayed, a consumer then may make environmentally prudent decisions as to which products to purchase. To that end, as shown in FIG. 66, a public GUI, such as the displayed TENA Brand site, may offer a plurality of links 55 from which a user may select information of a general nature or pertaining more specifically to products, corporate information or the environmental impact thereof.

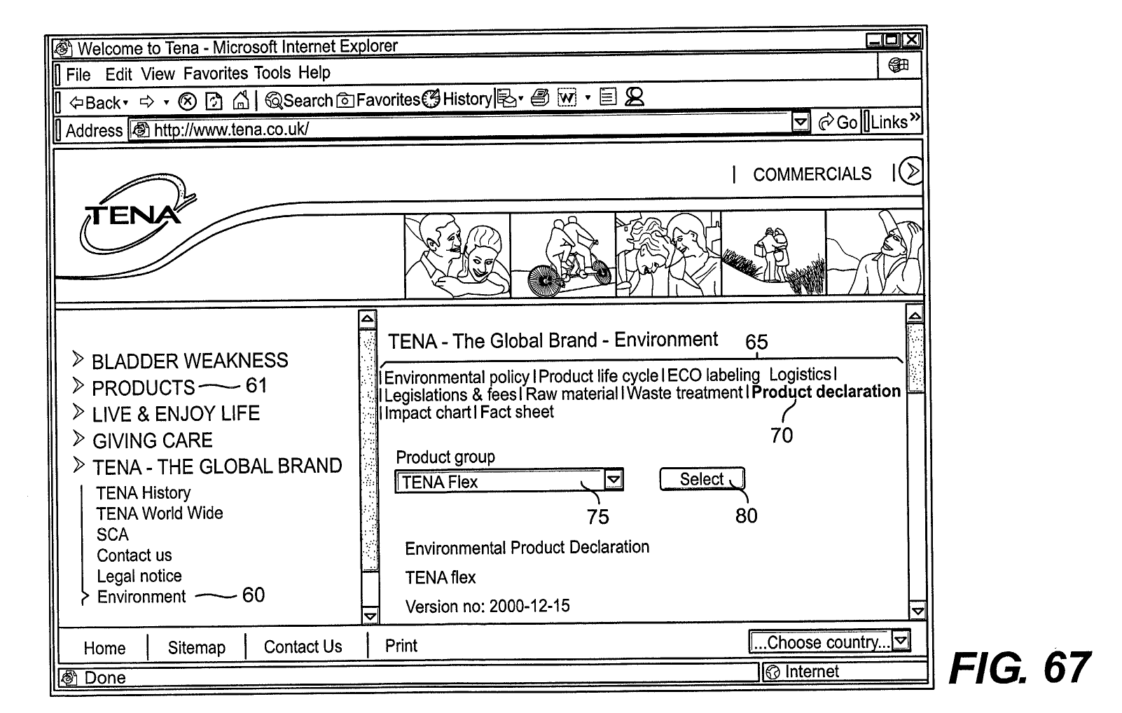

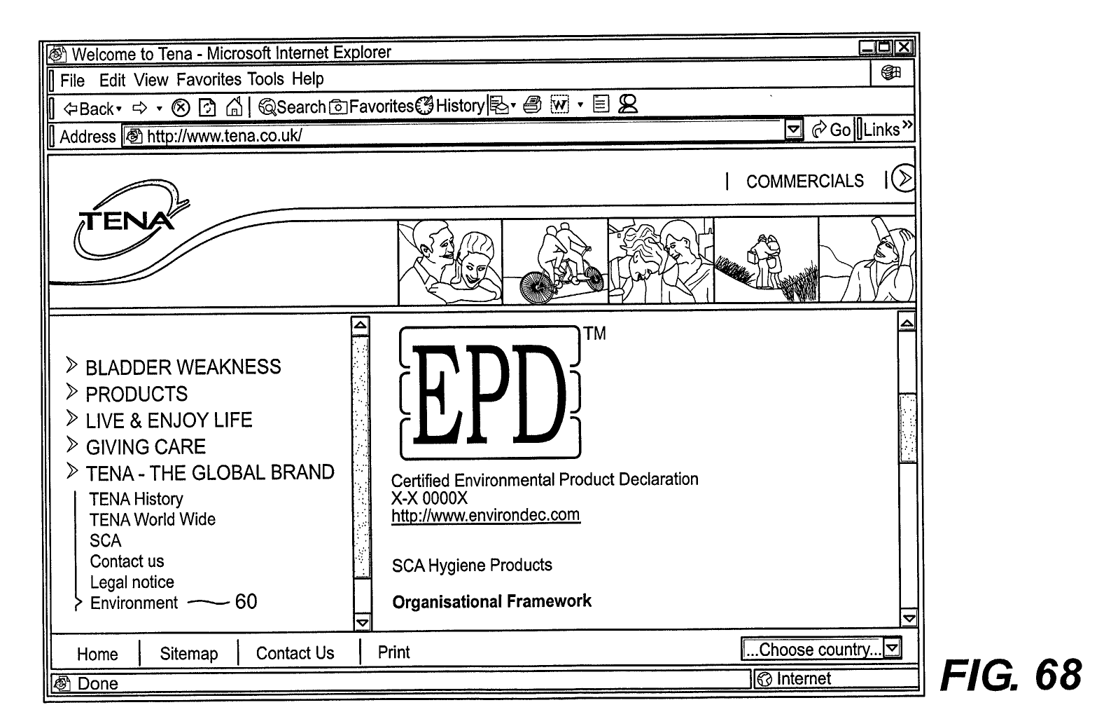

Turning to FIG. 67, when a user selects the environment link 60, the server may display a plurality of tabs 65 pertaining to available environmental data. Upon selecting, for example, the product declaration tab 70, the server presents a product group drop box 75 with which the user may select a product group. By selecting the select button 80, the user may view product declaration information, as shown in FIG. 68 and described above. FIG. 67 corresponds to FIGS. 1-6, described above.

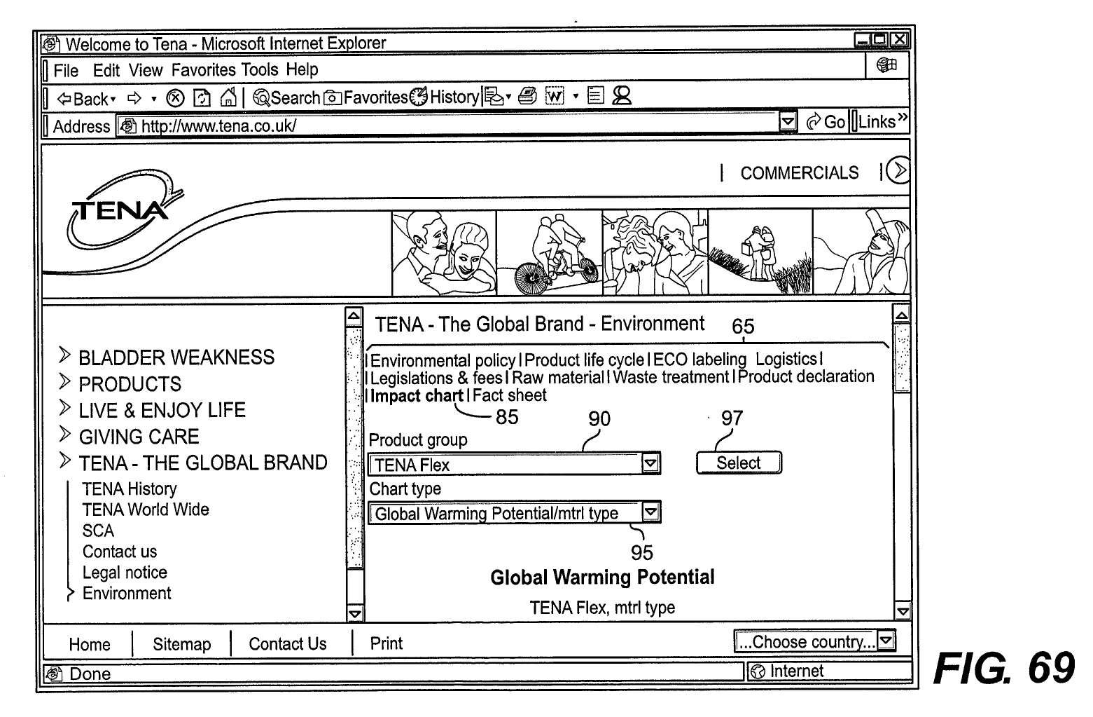

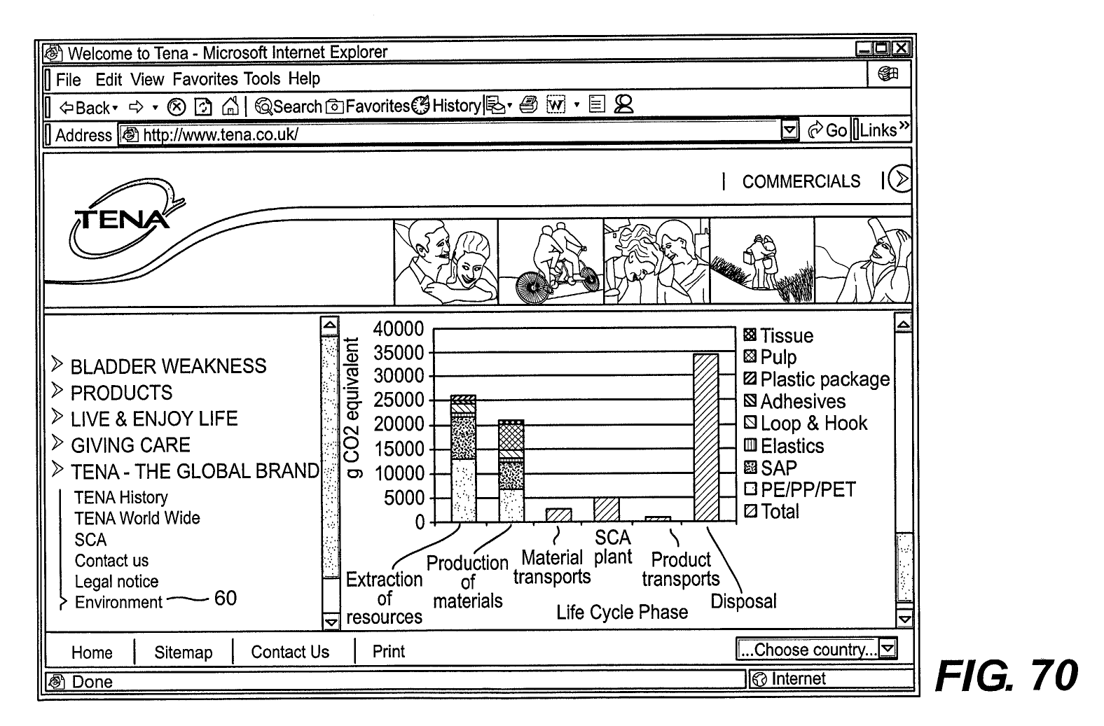

Referring to FIG. 69, when the user selects the impact chart tab 85, the server presents a product group drop box 90, a chart type drop box 95 and a select button 97 so that the user may view, for example, a graphical representation of the global warming potential of a product group with respect to material type, as shown in FIG. 70. FIGS. 69 and 70 correspond to FIGS. 11-36, described above.

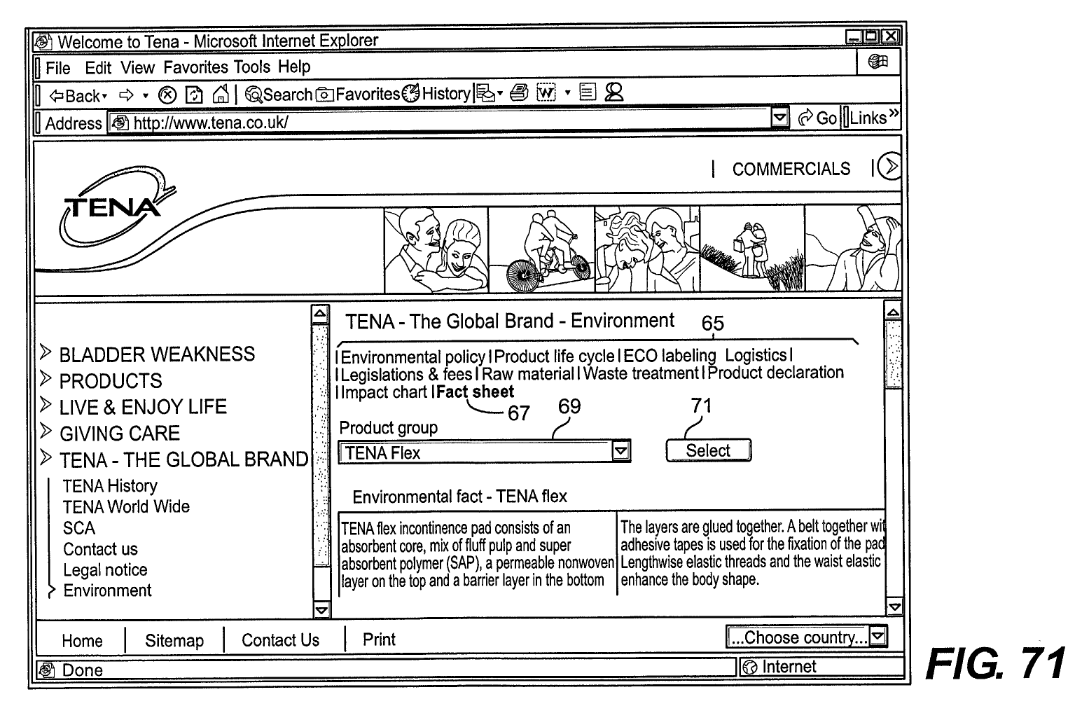

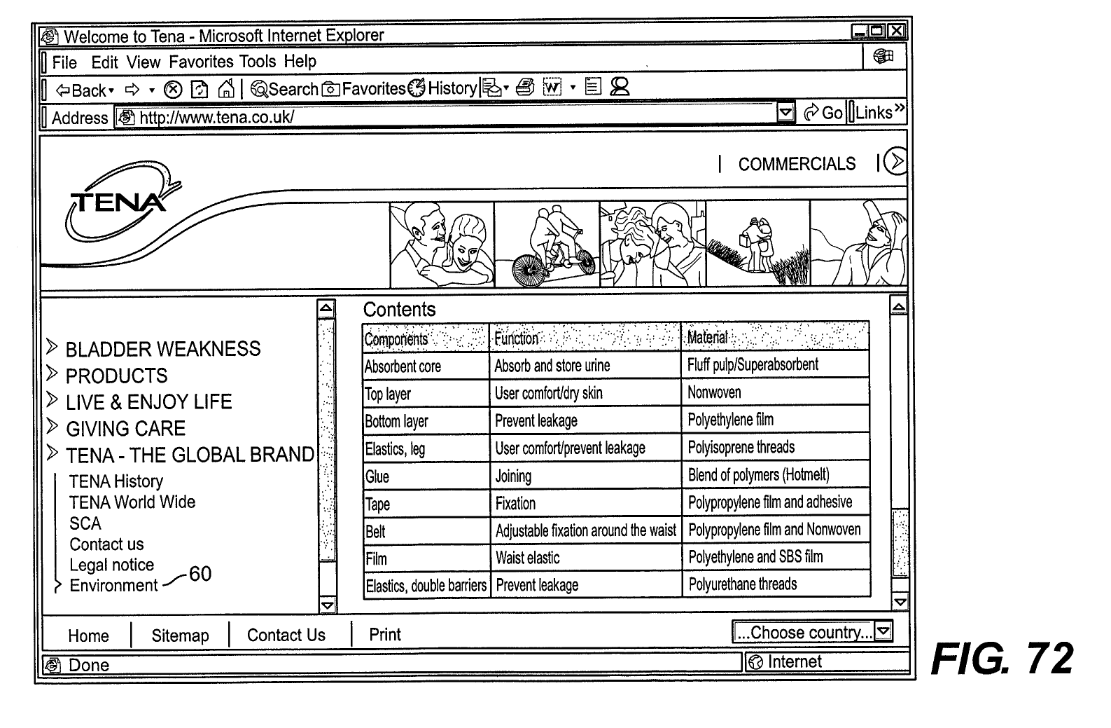

Referring to FIG. 71, when the user selects the fact sheet tab 67, the server presents a product drop box 69 and a select button 71 which the user may use to view environmental facts pertaining to a particular product, as shown in FIG. 72. FIG. 72 corresponds to FIGS. 7-10.

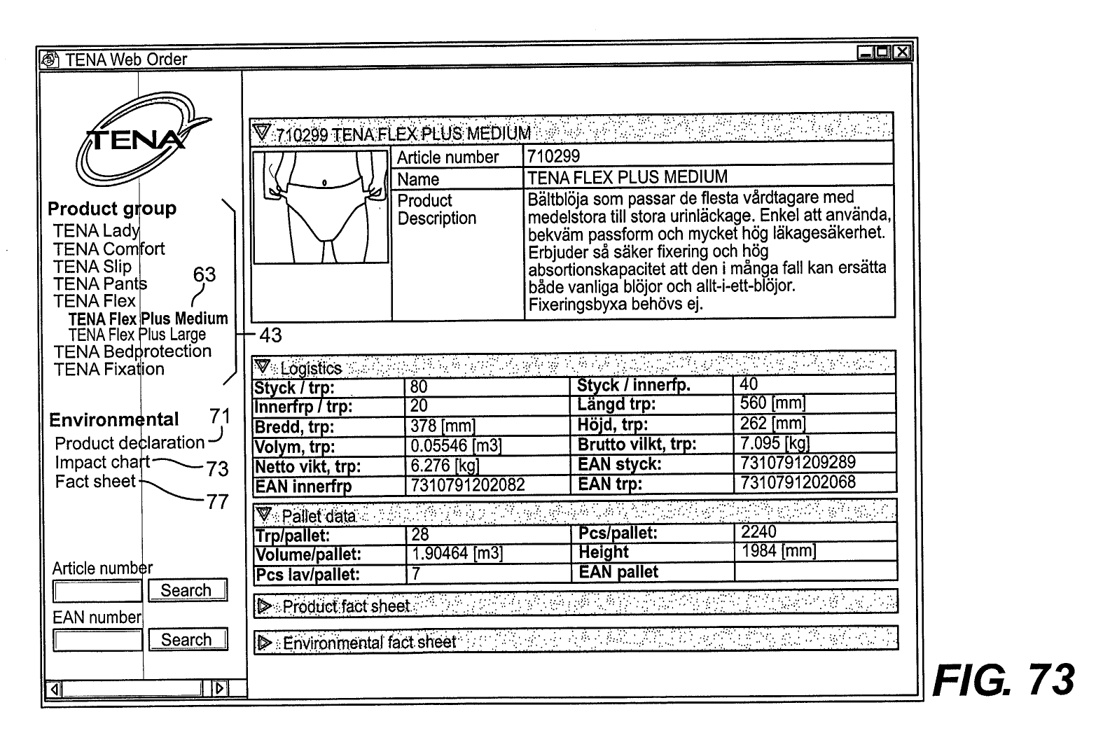

Referring again to FIG. 67 and also to FIG. 73, if the user initially selects the products link 61, on FIG. 67, the server displays on the web page 50 a product catalogue page, as shown in FIG. 73. The product catalogue page provide links 43 to any of a number of product groups, similar to that in FIG. 60, in which a user may be interested. Selecting any one of the links 43 prompts the server to present information regarding a selected product group, such as the TENA FLEX PLUS MEDIUM product group displayed in FIG. 73.

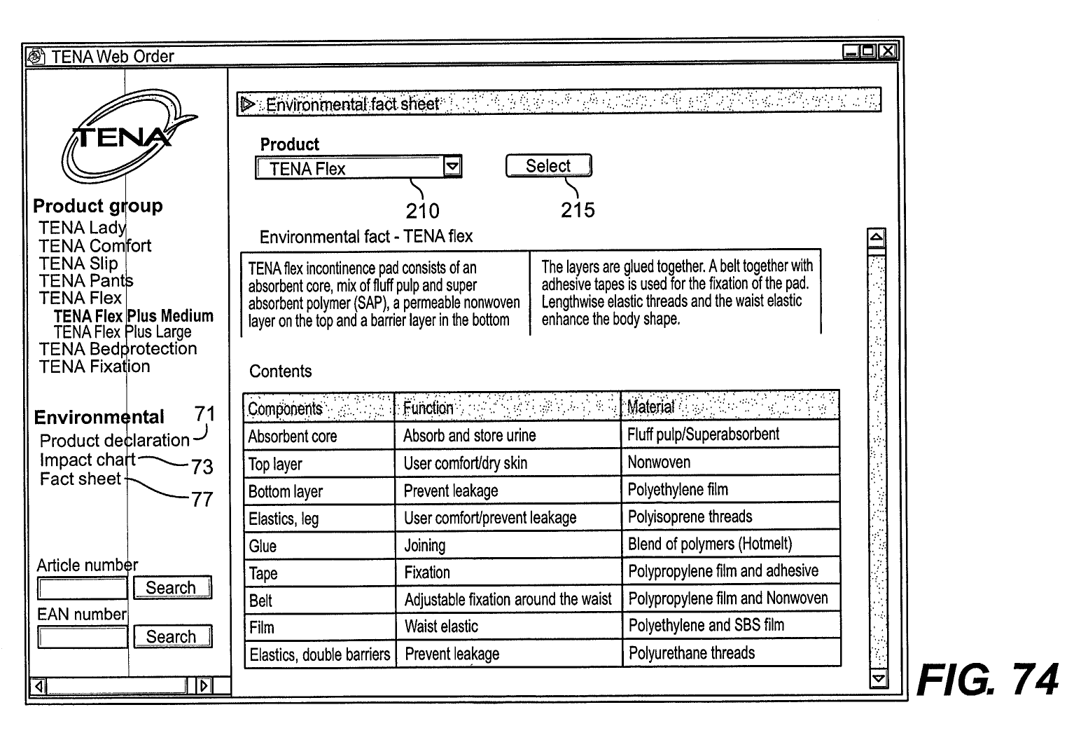

Referring to FIG. 74, the user also may select, for example, the fact sheet link 77, which would prompt the server to display the page as shown. The environmental fact sheet of FIG. 74 is much like the environmental fact sheet of FIGS. 7-10 described above. The environmental fact sheet also provides a drop box 210 and a select button 215 with which the user may view various products and facts pertinent to same.

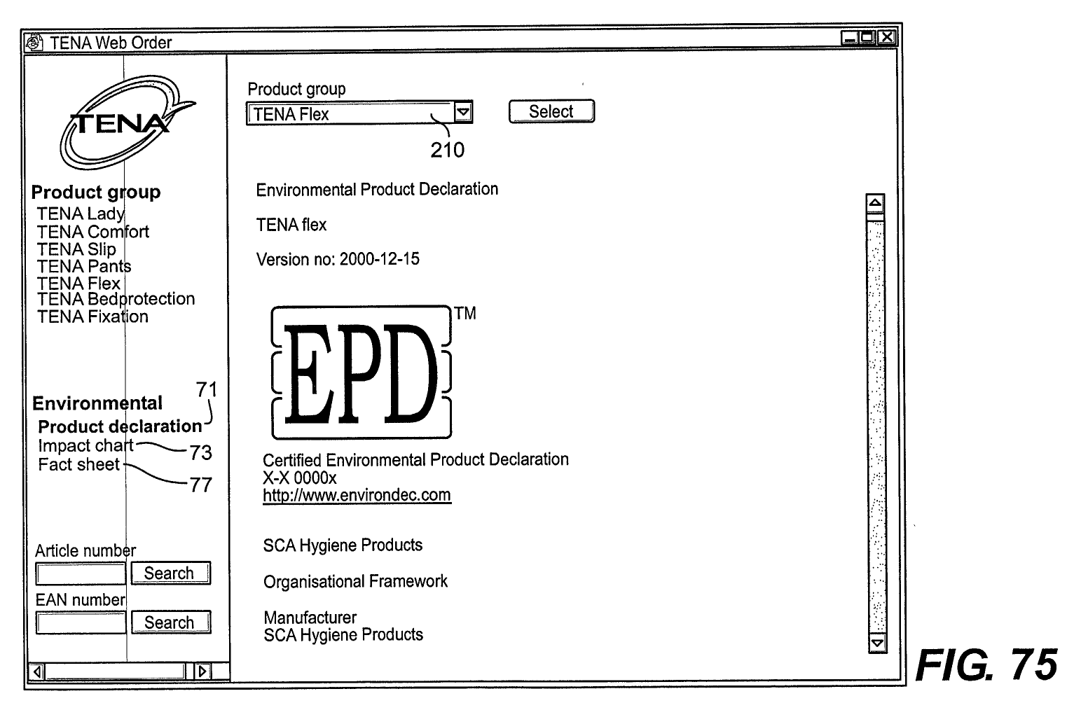

Referring to FIG. 75, product declaration link 71 also displays a certificate comparable to that of FIG. 1 and described above.

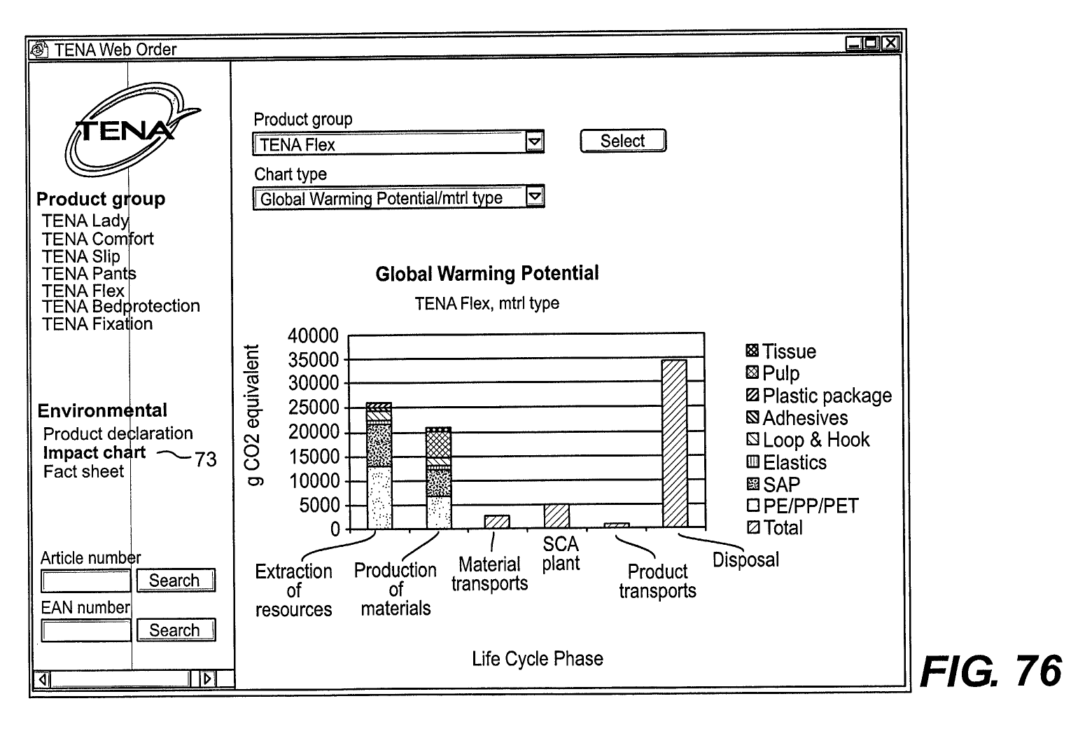

Referring again to FIG. 74 and also to FIG. 76, if the user selects the impact chart link 73, the server presents a view as shown in FIG. 76, which corresponds to FIGS. 11-36.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. Method of providing information pertaining to product or product group attributes comprising:
receiving a product or product group identifier; and
transmitting information pertaining to one or more attributes of the product or product group in response to said receiving;
wherein one of the attributes relates to environmental impact.

2. The method of claim 1, wherein the environmental impact attribute transmitted during the step of transmitting includes information of at least one of non-renewable resources and renewable resources.

3. The method of claim 1, wherein the environmental impact attribute transmitted during the step of transmitting includes information of at least one of energy consumption and waste production.

4. The method of claim 1, wherein the environmental impact attribute transmitted during the step of transmitting includes emissions information relating to at least one of global warming, acidification, photochemical oxidants and aquatic oxygen depletion.

5. The method of claim 1, wherein the environmental impact attribute transmitted during the step of transmitting includes at least one of recycling information and disposal information.

6. The method of claim 1, wherein the environmental impact attribute transmitted during the step of transmitting includes information of at least one of reports, laws, regulations and instructions relevant to various components used in the product group including environmental aspects thereof.

7. The method of claim 1, further comprising the step of transmitting information regarding currency and trustworthiness of information transmitted including a date of authentication and information about the authenticator.

8. The method of claim 1, wherein the environmental impact attribute transmitted during the step of transmitting includes at least one of biodegradable information about a product, major constituent chemical elements of a product and information about incineration of a product.

9. The method of claim 1, wherein the environmental impact attribute transmitted during the step of transmitting includes waste production information including at least one of weight and volume of waste associated with use of a product or order.

10. The method of claim 1, wherein the environmental impact attribute transmitted during the step of transmitting includes transportation trends in terms of at least one of weight and volume of a product or order.

11. The method of claim 1, wherein the environmental impact attribute transmitted during the step of transmitting includes information about human toxicity.

12. The method of claim 1, wherein the environmental impact attribute transmitted during the step of transmitting includes information about ozone depletion potential.

13. Method of providing and receiving information pertaining to environmental aspects of a product or product group comprising:
transmitting a product or product group identifier from a user interface to a server;
receiving the product or product group identifier with the server; and
transmitting information pertaining to one or more attributes of the product or product group by the server to the user interface in response to said receiving;
wherein one of the attributes relates to environmental impact.

14. The method of claim 13, wherein the environmental impact attribute transmitted during the step of transmitting includes information of at least one of nonrenewable resources and renewable resources.

15. The method of claim 13, wherein the environmental impact attribute transmitted during the step of transmitting includes information of at least one of energy consumption and waste production.

16. The method of claim 13, wherein the environmental impact attribute transmitted during the step of transmitting includes emissions information relating to at least one of global warming, acidification, photochemical oxidants and aquatic oxygen depletion.

17. The method of claim 13, wherein the environmental impact attribute transmitted during the step of transmitting includes at least one of recycling information and disposal information.

18. The method of claim 13, wherein the environmental impact attribute transmitted during the step of transmitting includes information of at least one of reports, laws, regulations and instructions relevant to various components used in the product group including environmental aspects thereof.

19. The method of claim 13, further comprising the step of transmitting information regarding currency and trustworthiness of information transmitted including a date of authentication and information about the authenticator.

20. The method of claim 13, wherein the environmental impact attribute transmitted during the step of transmitting includes at least one of biodegradable information about a product, major constituent chemical elements of a product and information about incineration of a product.

21. The method of claim 13, wherein the environmental impact attribute transmitted during the step of transmitting includes waste production information including at least one of weight and volume of waste associated with use of a product or order.

22. The method of claim 13, wherein the environmental impact attribute transmitted during the step of transmitting includes transportation trends in terms of at least one of weight and volume of a product or order.

23. The method of claim 13, wherein the environmental impact attribute transmitted during the step of transmitting includes information about human toxicity.

24. The method of claim 13, wherein the environmental impact attribute transmitted during the step of transmitting includes information about ozone depletion potential.

25. Method of receiving information pertaining to product or product group attributes comprising:
transmitting a product or product group identifier to a server; and
receiving information pertaining to one or more attributes of the product or product group responsive to said transmitting;
wherein one of the attributes relates to environmental impact.

26. Method of claim 25, wherein said transmitting comprises selecting the product or product group data from a list of products or product groups displayed on a web page.

27. Method of claim 25, wherein information pertaining to environmental impact is selected from organizational framework, environmental performance, energy consumption, waste and classification data for emissions, reference materials and combinations thereof.

28. Method of claim 27, wherein information pertaining to organizational framework is selected from legal name and correspondence address for a manufacture of the product or product group, pertinent ownership interest and production sites with respect to components of the selected product group, environmental standards to which the manufacturer adheres and combinations thereof.

29. Method of claim 27, wherein information pertaining to environmental performance is in terms of renewal and non-renewable resources with respect to a functional unit of the product or product group.

30. The method of claim 25, wherein the environmental impact attribute includes information of at least one of non-renewable resources, renewable resources, energy consumption, waste production recycling and disposal information.

31. The method of claim 25, wherein the environmental impact attribute includes emissions information relating to at least one of global warming, acidification, photochemical oxidants and aquatic oxygen depletion.

32. The method of claim 25, wherein the environmental impact attribute includes at least one of biodegradable information about a product, major constituent chemical elements of a product, information about incineration of a product, information about weight of a product or order, and information about volume of a product or order.

33. A data displaying interface, the interface comprising a page including an environment tab which upon actuation displays information related to environmental impact of a product or product group, the environmental impact being selected from at least one of organizational framework, environmental performance, energy consumption, waste and classification data for emissions, reference materials and combinations thereof.

34. The data displaying interface of claim 33, wherein the environmental impact includes information of at least one of non-renewable resources, renewable resources, energy consumption, waste production recycling and disposal information.

35. The data displaying interface of claim 33, wherein the environmental impact includes emissions information relating to at least one of global warming, acidification, photochemical oxidants and aquatic oxygen depletion.

36. The data displaying interface of claim 33, wherein the environmental impact includes at least one of biodegradable information about a product, major constituent chemical elements of a product, information about incineration of a product, information about weight of a product or order, and information about volume of a product or order.
